(19) United States
(12) Patent Application Publication
(10) Pub. No.: US 2004/0224844 A1
(43) Pub. Date: Nov. 11, 2004

(54) Use of hydroxyaromatic compounds as safeners

(75) Inventors: Udo Bickers, Wietmarschen (DE); Lothar Willms, Hofheim (DE); Erwin Hacker, Hochheim (DE); Christopher Rosinger, Hofheim (DE)

Correspondence Address: CONNOLLY BOVE LODGE & HUTZ, LLP, P O BOX 2207, WILMINGTON, DE, 19899, US

(73) Assignee: Bayer CropScience GmbH, Frankfurt am Main (DE)

(21) Appl. No.: 10/810,211

(22) Filed: Mar. 26, 2004

(30) Foreign Application Priority Data
Mar. 26, 2003 (DE) 103 13 480.8

(51) Int. Cl. A01N 43/66; A01N 25/32

(52) U.S. Cl. 504/111

(57) ABSTRACT

Compounds of the formula (I) or salts thereof,

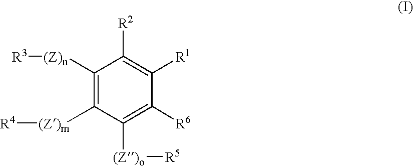

where

R¹ is carboxyl or a derivative of the carboxyl group, preferably a radical of the formula

—CN or

—C(═X)-Y—R or

—C(═X)-Het,

in which

X is a divalent radical of the formula O, S or NR^{a} or N—NR^{a}R^{b}, where R^{a} and R^{b} are as defined in claim 1,

Y is a group of the formula O, S, NR^{c} or NR^{c}—NR^{d}R^{e}, where R^{C}, R^{d} and R^{e} are as defined in claim 1,

R², R³, R⁴, R⁵ and R⁶, Z, Z′, Z″ are as defined in claim 1,

m is an integer 0 or 1,

n is an integer 0 or 1 and

o is an integer 0 or 1,

where the sum m+n+o is an integer 1, 2 or 3 and, in the case of the alternative (b) defined above, at least one of the radicals R³, R⁴ and R⁵ is selected from radicals of the group consisting of hydrogen and acyl,

are suitable as safeners or resistance inductors for crop plants or useful plants, preferably as safeners against phytotoxic actions of agrochemicals such as pesticides in these plants.

### DESCRIPTION

The present invention relates to the field of safeners or resistance inductors for protecting crop plants or useful plants against damage caused by the use of agrochemicals such as xenobiocides or biocides, for example herbicides, insecticides, acaricides, nematicides or fungicides, infection by pathogens such as fungi, bacteria, viruses or else by harmful environmental factors such as aridity or drought. Specifically, the invention relates to the novel use of certain hydroxy-aromatic compounds as safeners, and to novel compounds from this group.

When controlling unwanted organisms in crops of plants which are useful for agriculture or forestry by using pesticides, the useful plants are frequently also damaged to a greater or lesser extent, in a manner which is unwanted per se, by the pesticides employed. This effect is encountered in particular with the use of a considerable number of herbicides in monocotyledonous and dicotyledonous crops of useful plants—and there primarily in the post-emergence application. In some instances, the useful plants can be protected against the phytotoxic properties of the pesticides by employing safeners or antidotes, without diminishing the pesticidal activity against the harmful organisms.

The action of the compounds which have hitherto been disclosed as safeners is frequently limited to certain crops and certain classes of pesticides. In particular, hardly any commercial safeners for dicotyledonous crops have become known. Likewise, for a number of pesticides, non-selective herbicides or total herbicides, hardly any safeners have been described.

US-A4,808,208 describes the use of phenols such as mono- or dihydroxyaceto-phenone or hydroxycinnamic acids and some derivatives of these carboxylic acids as safeners for soybean crops against phytotoxic actions of the herbicide glyphosate (phosphonomethylglycine and its salts).

Moreover, DE-A-1 9933897 discloses that the resistance of crop plants against chemical stress caused by the use of insufficiently selective agrochemicals can be improved by using resistance inductors from the group of the acylcyclohexane-diones, such as prohexadione (salts) and trinexpac-ethyl or trinexpac salts, or benzothiadiazoles or benzothiazoles or derivatives thereof, such as acibenzolar-S-methyl and probenazole.

Furthermore, it is known that growth-regulator herbicides such as dicamba (2,5-di-chloro-6-methoxybenzoic acid) and phenoxyalkanecarboxylic acid derivatives (2,4-D, MCPA) have been used in some cases as crop-plant-protecting compounds for coherbicides (see, for example, U.S. Pat. No. 5,846,902, U.S. Pat. No. 5,739,080, EP-A-512737).

US-A4,321,084 describes herbicidal compositions comprising herbicidal thio-carbamates such as vernolate or butylate in combination with an antidote (=safener) from the group of specifically halogenated phenols. These phenols comprise known herbicides, such as the hydroxybenzonitriles bromoxynil and ioxynil, and also analogues in which the nitrile group is replaced by a carboxyl, carbalkoxy or alkyl group.

WO-A-92/11761 describes herbicide/biocide/antidote combinations where the biocide may be an insecticide, a fungicide or a nematicide and the antidotes are selected from the group of amides of different structures, which generally also includes aromatic amides, which combinations are used to avoid “negative synergism” in the interaction of herbicide and biocide.

It has now been found that, surprisingly, compounds of the formula (I) shown below or salts thereof from the group comprising certain meta- or para-hydroxybenzoic acids and derivatives thereof can be used effectively as safeners or resistance inductors for crop plants or useful plants, preferably as safeners against damage by agrochemicals such as, preferably, herbicides, in these plants.

Accordingly, the invention provides the use of compounds of the formula (I) or salts thereof,

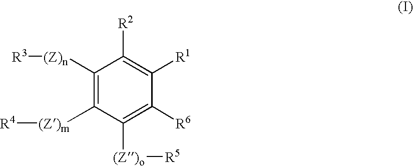

where

R¹ is carboxyl or a derivative of the carboxyl group, preferably a radical of the formula

—CN or

—C(═X)-Y—R or

—C(═X)-Het,

where

X is a divalent radical of the formula O, S or NR^{a} or N—NR^{a}R^{b}, where R^{a} and R^{b} are as defined below,

Y is a group of the formula O, S, NR^{c} or NR^{c}—NR^{d}R^{e}, where R^{C}, R^{d} and R^{e} are as defined below,

R is hydrogen or an unsubstituted or substituted hydrocarbon radical or an unsubstituted or substituted heterocyclic radical or acyl, and

Het is an aliphatic N-heterocycle having a total of 1 to 4 heterocyclic ring atoms which is attached via a heterocyclic N-ring atom to the group C(═X) and which may contain, as heterocyclic ring atoms, in addition to the N-atom in the yl-position, further heteroatoms selected from the group consisting of N, O and S, and which is unsubstituted or substituted,

where each of the radicals R^{a}, R^{b}, R^{C}, R^{d} and R^{e} in the radicals X and Y is, in each case independently of one another and independently of the radical R, as defined for R or is a radical of the formula —OR*, where R* is, independently of R, as defined for R,

R² and R⁶, in each case independently of one another, are hydrogen, halogen, SCN, CN or an unsubstituted or substituted hydrocarbon radical,

R³ (a) in the case that n=0 is a radical selected from the group consisting of hydrogen, halogen, SCN and CN or a radical of the formula A¹ or B¹ or (b) in the case that n=1 is hydrogen or a radical of the formula A¹, B¹ or C¹ and

R⁴ (a) in the case that m 0 is a radical selected from the group consisting of hydrogen, halogen, SCN and CN or a radical of the formula A² or B² or (b) in the case that m=1 is hydrogen or a radical of the formula A², B² or C² and

R⁵ (a) in the case o=0 is hydrogen or a radical of the formula A³ or B³ or (b) in the case o=1 is hydrogen or a radical of the formula A³, B³ or C³, where each of the radicals A¹, A²; A³, in each case independently of one another, is an unsubstituted or substituted hydrocarbon radical, each of the radicals B¹, B², B³, in each case independently of one another, is an acyl radical and each of the radicals C¹, C², C³, in each case independently of one another, is an unsubstituted or substituted heterocyclic radical,

Z, Z′, Z″, in each case independently of one another, are a group of the formula O, S(O)ₓ, or NR′, where x=0, 1 or 2 and R′ is hydrogen or an unsubstituted or substituted hydrocarbon radical or an unsubstituted or substituted hydrocarbonoxy radical or acyl or acyloxy,

m is an integer 0 or 1,

n is an integer 0 or 1 and

o is an integer 0 or 1,

where the sum m+n+o is an integer 1, 2 or 3 and, in the case of the alternatives (b) defined above, at least one of the radicals R³, R⁴ and R⁵ is selected from radicals from the group consisting of hydrogen and B¹, B² and B³ (=acyl), respectively, as safeners or resistance inductors for crop plants or useful plants, preferably as safeners against phytotoxic actions of agrochemicals such as pesticides in these plants.

If, by a hydrogen shift, the compounds are capable of forming tautomers whose structure is not formally covered by formula (1), these tautomers are nevertheless embraced by the definition of the compounds of the formula (I) according to the invention.

The formula (I) also embraces all stereoisomers of the compounds whose specific stereochemical configuration is not explicitly expressed by the formula, and mixtures thereof. Such compounds of the formula (I) contain one or more asymmetrically substituted C-atoms or else double bonds which are not specifically mentioned in the formulae (1). All possible stereoisomers defined by their specific spatial form, such as enantiomers, diastereomers, Z- and E-isomers, are embraced by the formula (I) and can be obtained by customary methods from mixtures of the stereoisomers or else by stereoselective reactions in combination with the use of stereochemically pure starting materials.

By addition of a suitable inorganic or organic acid, such as, for example, HCl, HBr, H₂SO₄ or HNO₃, or else oxalic acid or sulfonic acids, to a basic group, such as, for example, amino or alkylamino, the compounds of the formula (I) are capable of forming salts. Suitable substituents which are present in deprotonated form, such as, for example, sulfonic acids or carboxylic acids, are capable of forming inner salts with groups which for their part can be protonated, such as amino groups. Salts can also be formed by replacing the hydrogen in suitable substituents, such as, for example, sulfonic acids or carboxylic acids, by an agriculturally suitable cation. These salts are, for example, metal salts, in particular alkali metal salts or alkaline earth metal salts, in particular sodium and potassium salts, or else ammonium salts, salts with organic amines or quaternary ammonium salts.

In the formula (I) and in all formulae below, the following definitions apply:

A hydrocarbon radical is an aliphatic, cycloaliphatic or aromatic monocyclic or, in the case of an unsubstituted or substituted hydrocarbon radical, also bicyclic or polycyclic organic radical based on the elements carbon and hydrogen, comprising, for example, the radicals alkyl, alkenyl, alkynyl, cycloalkyl, cycloalkenyl, aryl, phenyl, naphthyl, indanyl, indenyl, etc.; this applies correspondingly to hydrocarbonoxy radicals.

Unless defined in more detail, the hydrocarbon and hydrocarbonoxy radicals in the above definitions preferably have 1 to 20 C-atoms, particularly preferably 1 to 16 C-atoms, in particular 1 to 12 C-atoms.

The carbon skeleton of the hydrocarbon radicals and the specific radicals alkyl, alkoxy, haloalkyl, haloalkoxy, alkylamino and alkylthio and the corresponding unsaturated and/or substituted radicals can in each case be straight-chain or branched.

The term “(C₁-C₄)-alkyl” is an abbreviated notation for open-chain alkyl having one to 4 carbon atoms, i.e. it comprises the radicals methyl, ethyl, 1-propyl, 2-propyl, 1-butyl, 2-butyl, 2-methylpropyl and tert-butyl. Correspondingly, general alkyl radicals having a wider stated range of carbon atoms, for example “(C₁-C₆)-alkyl”, also comprise straight-chain or branched alkyl radicals having a larger number of carbon atoms, i.e., according to the example, also the alkyl radicals having 5 and 6 C-atoms. Unless specifically indicated, the lower carbon skeletons, for example those having 1 to 6 C-atoms or, in the case of unsaturated groups, having 2 to 6 C-atoms, are preferred for the hydrocarbon radicals, such as alkyl, alkenyl and alkynyl radicals. Alkyl radicals, including in the composite meaning, such as alkoxy, haloalkyl, etc., are, for example, methyl, ethyl, n- or i-propyl, n-, i-, t- or 2-butyl, pentyls, hexyls, such as n-hexyl, isohexyl and 1,3-dimethylbutyl, heptyls, such as n-heptyl, 1-methylhexyl and 1,4-dimethylpentyl; alkenyl and alkynyl radicals denote the possible unsaturated radicals which correspond to the meaning of the alkyl radicals; alkenyl is, for example, vinyl, allyl, 1-methyl-2-propenyl, 2-methyl-2-propenyl, 2-butenyl, pentenyl, 2-methylpentenyl or hexenyl, preferably allyl, 1-methyl prop-2-en-1-yl, 2-methylprop-2-en-1-yl, but-2-en-1-yl, but-3-en-1-yl, 1-methylbut-3-en-1-yl or 1-methylbut-2-en-1-yl. (C₂-C₆)-alkynyl is, for example, ethynyl, propargyl, 1-methyl-2-propynyl, 2-methyl-2-propynyl, 2-butynyl, 2-pentynyl or 2-hexynyl, preferably propargyl, but-2-yn-1-yl, but-3-yn-1-yl or 1-methyl-but-3-yn-1-yl.

Alkylidene, for example also in the form of (C₁-C₁₀)-alkylidene, denotes the radical of a straight-chain or branched alkane which is attached via a double bond, where the position of the point of attachment has not yet been determined. In the case of a branched alkane, of course, only those positions are suitable where two hydrogen atoms can be replaced by the double bond; such radicals are, for example, ═CH₂, =CH—CH₃, =C(CH₃)—CH₃, =C(CH₃)—C₂H₅ or ═C(C₂H₅)—C₂H₅.

Cycloalkyl denotes a carbocyclic saturated ring system having preferably 3-8 carbon atoms, for example cyclopropyl, cyclobutyl, cyclopentyl or cyclohexyl. Substituted cycloalkyl comprises cyclic systems having substituents, including substituents having a double bond to the cycloalkyl radical, for example an alkylidene group, such as methylidene. Substituted cycloalkyl also comprises polycyclic aliphatic systems, such as, for example, bicyclo[1.1.0]butan-1-yl, bicyclo[1.1.0]butan-2-yl, bicyclo-[2.1.0]pentan-1-yl, bicyclo[2.1.0]pentan-2-yl, bicyclo[2.1.0]pentan-5-yl, adamantan-1-yl and adamantan-2-yl.

Cycloalkenyl denotes a carbocyclic non-aromatic partially unsaturated ring system having preferably 4-8 carbon atoms, for example 1-cyclobutenyl, 2-cyclobutenyl, 1-cyclopentenyl, 2-cyclopentenyl, 3-cyclopentenyl, or 1-cyclohexenyl, 2-cyclo-hexenyl, 3-cyclohexenyl, 1,3-cyclohexadienyl or 1,4-cyclohexadienyl. In the case of substituted cycloalkenyl, the comments for substituted cycloalkyl apply correspondingly.

Halogen denotes, for example, fluorine, chlorine, bromine or iodine. Haloalkyl, -alkenyl and -alkynyl denote alkyl, alkenyl and alkynyl, respectively, which are partially or fully substituted by identical or different halogen atoms, preferably selected from the group consisting of fluorine, chlorine and bromine, in particular the group consisting of fluorine and chlorine, for example monohaloalkyl, perhaloalkyl, CF₃, CHF₂, CH₂F, CF₃CF₂, CH₂FCHCl, CCl₃, CHCl₂, CH₂CH₂Cl; haloalkoxy is, for example, OCF₃, OCHF₂, OCH₂F, CF₃CF₂O, OCH₂CF₃ and OCH₂CH₂Cl; this applies correspondingly to haloalkenyl and other halogen-substituted radicals.

Aryl denotes a mono-, bi- or polycyclic aromatic system, for example phenyl, naphthyl, tetrahydronaphthyl, indenyl, indanyl, pentalenyl, fluorenyl and the like, preferably phenyl.

A heterocyclic radical or ring (heterocyclyl) can be saturated, unsaturated or hetero-aromatic; unless defined otherwise, it preferably contains one or more, in particular 1, 2 or 3, heteroatoms in the heterocyclic ring, preferably selected from the group consisting of N, O and S; it is preferably an aliphatic heterocyclyl radical having 3 to 7 ring atoms or a heteroaromatic radical having 5 or 6 ring atoms. The heterocyclic radical can, for example, be a heteroaromatic radical or ring (heteroaryl), such as, for example, a mono-, bi- or polycyclic aromatic system in which at least 1 ring contains one or more heteroatoms. It is preferably a heteroaromatic ring having a heteroatom selected from the group consisting of N, O and S, for example pyridyl, pyrrolyl, thienyl or furyl; moreover, it is preferably a corresponding heteroaromatic ring having 2 or 3 heteroatoms, for example pyrimidinyl, pyridazinyl, pyrazinyl, triazinyl, thiazolyl, thiadiazolyl, oxazolyl, isoxazolyl, pyrazolyl, imidazolyl and triazolyl. Moreover, it is preferably a partially or fully hydrogenated heterocyclic radical having a heteroatom selected from the group consisting of N, O and S, for example oxiranyl, oxetanyl, oxolanyl (=tetrahydrofuryl), oxanyl, pyrrolinyl, pyrrolidyl or piperidyl.

Moreover, it is preferably a partially or fully hydrogenated heterocyclic radical having 2 heteroatoms selected from the group consisting of N, O and S, for example piperazinyl, dioxolanyl, oxazolinyl, isoxazolinyl, oxazolidinyl, isoxazolidinyl and morpholinyl.

Suitable substituents for a substituted heterocyclic radical are the substituents mentioned further below, and additionally also oxo. The oxo group may also be present on the heterocyclic ring atoms which can exist in various oxidation states, for example on N and S.

Preferred examples of heterocyclyl are heterocyclic radicals having 3 to 6 ring atoms selected from the group consisting of pyridyl, thienyl, furyl, pyrrolyl, oxiranyl, 2-oxetanyl, 3-oxetanyl, oxolanyl (=tetrahydrofuryl), pyrrolidyl, piperidyl, in particular oxiranyl, 2-oxetanyl, 3-oxetanyl or oxolanyl, or heterocyclic radicals having two or three heteroatoms, for example pyrimidinyl, pyridazinyl, pyrazinyl, triazinyl, thienyl, thiazolyl, thiadiazolyl, oxazolyl, isoxazolyl, pyrazolyl, triazolyl, piperazinyl, dioxolanyl, oxazolinyl, isoxazolinyl, oxazolidinyl, isoxazolidinyl or morpholinyl.

If a basic structure is substituted “by one or more radicals” from a list of radicals (=group) or a generically defined group of radicals, this includes in each case the simultaneous substitution by a plurality of identical and/or structurally different radicals.

Substituted radicals, such as substituted alkyl, alkenyl, alkynyl, aryl, phenyl, benzyl, heterocyclyl and heteroaryl radicals, are, for example, substituted radicals derived from an unsubstituted basic structure, the substituents being, for example, one or more, preferably 1, 2 or 3, radicals selected from the group consisting of halogen, alkoxy, alkylthio, hydroxyl, amino, nitro, carboxyl, cyano, azido, alkoxycarbonyl, alkylcarbonyl, formyl, carbamoyl, mono- and dialkylaminocarbonyl, substituted amino, such as acylamino, mono- and dialkylamino, and alkylsulfinyl, alkylsulfonyl and, in the case of cyclic radicals, also alkyl, haloalkyl, alkylthioalkyl, alkoxyalkyl, unsubstituted or substituted mono- and dialkylamino and hydroxyalkyl; the term “substituted radicals” such as substituted alkyl, etc. includes, as substituents, in addition to the saturated hydrocarbon-containing radicals mentioned, corresponding unsaturated aliphatic and aromatic radicals, such as unsubstituted or substituted alkenyl, alkynyl, alkenyloxy, alkynyloxy, phenyl, phenoxy, etc. Substituted cyclic radicals having aliphatic moieties in the ring also include cyclic systems having substituents attached to the ring via a double bond, for example those which are substituted by an alkylidene group, such as methylidene or ethylidene, or an oxo group, imino group or substituted imino group.

The substituents mentioned by way of example (“first substituent level”) can, if they contain hydrocarbon-containing moieties, be, if appropriate, substituted further in the moieties (“second substituent level”), for example by one of the substituents as defined for the first substituent level. Corresponding further substituent levels are possible. The term “substituted radical” preferably embraces only one or two substituent levels.

Preferred substituents for the substituent levels are, for example,

amino, hydroxyl, halogen, nitro, cyano, mercapto, carboxyl, carboxamide, SF₅, aminosulfonyl, alkyl, cycloalkyl, alkenyl, cycloalkenyl, alkynyl, monoalkylamino, dialkylamino, N-alkanoylamino, alkoxy, alkenyloxy, alkynyloxy, cycloalkoxy, cycloalkenyloxy, alkoxycarbonyl, alkenyloxycarbonyl, alkynyloxycarbonyl, aryloxycarbonyl, alkanoyl, alkenylcarbonyl, alkynylcarbonyl, arylcarbonyl, alkylthio, cycloalkylthio, alkenylthio, cycloalkenylthio, alkynylthio, alkylsulfinyl, alkylsulfonyl, monoalkylaminosulfonyl, dialkylaminosulfonyl, N-alkylaminocarbonyl, N,N-dialkyl-aminocarbonyl, N-alkanoylaminocarbonyl, N-alkanoyl-N-alkylaminocarbonyl, aryl, aryloxy, benzyl, benzyloxy, benzylthio, arylthio, arylamino and benzylamino.

In the case of radicals having carbon atoms, preference is given to those having 1 to 6 carbon atoms, preferably 1 to 4 carbon atoms, in particular 1 or 2 carbon atoms. Preference is generally given to substituents selected from the group consisting of halogen, for example fluorine and chlorine, (C₁-C₄)-alkyl, preferably methyl or ethyl, (C₁-C₄)-haloalkyl, preferably trifluoromethyl, (C₁-C₄)-alkoxy, preferably methoxy or ethoxy, (C₁-C₄)-haloalkoxy, nitro and cyano. Here, particular preference is given to the substituents methyl, methoxy, fluorine and chlorine.

Substituted amino, such as mono- or disubstituted amino, denotes a radical from the group of the substituted amino radicals which are substituted, for example, by one or two identical or different radicals selected from the group consisting of alkyl, alkoxy, acyl and aryl; preferably mono- and dialkylamino, mono- and diarylamino, acylamino, N-alkyl-N-arylamino, N-alkyl-N-acylamino and N-heterocycles; here, preference is given to alkyl radicals having 1 to 4 carbon atoms; aryl is preferably phenyl or substituted phenyl; for acyl, the definition given further down applies, preference is given to (C₁-C₄)-alkanoyl. This applies correspondingly to substituted hydroxylamino or hydrazino.

Unsubstituted or substituted phenyl is preferably phenyl which is unsubstituted or mono- or polysubstituted, preferably up to trisubstituted, by identical or different radicals selected from the group consisting of halogen, (C₁-C₄)-alkyl, (C₁-C₄)-alkoxy, (C₁-C₄)-haloalkyl, (C₁-C₄)-haloalkoxy and nitro, for example o-, m- and p-tolyl, dimethylphenyls, 2-, 3- and 4-chlorophenyl, 2-, 3- and 4-trifluoro- and -trichloro-phenyl, 2,4-, 3,5-, 2,5- and 2,3-dichlorophenyl, o-, m- and p-methoxyphenyl.

Acyl denotes a radical of an organic acid which, formally, is formed by removing a hydroxyl group from the acid function, it also being possible for the organic radical in the acid to be attached to the acid function via a heteroatom. Examples of acyl are the radicals —CO—R of a carboxylic acid HO—CO—R and radicals of acids derived therefrom, such as thiocarboxylic acid, unsubstituted or N-substituted iminocarboxylic acids or the radicals of carbonic acid monoesters, N-substituted carbamic acid, sulfonic acids, sulfinic acids, N-substituted sulfonamido acids, phosphonic acids, phosphinic acids.

Acyl denotes, for example, formyl, alkylcarbonyl, such as [(C₁-C₄)-alkyl]carbonyl, phenylcarbonyl, alkyloxycarbonyl, phenyloxycarbonyl, benzyloxycarbonyl, alkylsulfonyl, alkylsulfinyl, N-alkyl-1-iminoalkyl and other radicals of organic acids. Here, the radicals may in each case be substituted further in the alkyl or phenyl moiety, for example in the alkyl moiety by one or more radicals selected from the group consisting of halogen, alkoxy, phenyl and phenoxy; examples of substituents in the phenyl moiety are the substituents which have already been mentioned further up in a general manner for substituted phenyl.

Acyl denotes preferably an acyl radical in the narrower sense, i.e. a radical of an organic acid where the acid group is attached directly to the carbon atom of an organic radical, for example formyl, alkylcarbonyl, such as acetyl or [(C₁-C₄)alkyl]carbonyl, phenylcarbonyl, alkylsulfonyl, alkylsulfinyl and other radicals of organic acids.

If a general radical is defined as “hydrogen”, this means a hydrogen atom.

The “yl-position” of a radical denotes its point of attachment.

Hereinbelow, compounds of formula (I) and salts thereof which can be used according to the invention are, in short, also referred to as “compounds (I) according to the invention”.

In particular for reasons of a more pronounced crop-plant-protecting or useful-plant-protecting action, better selectivity and/or better preparability, those compounds of the formula (I) according to the invention mentioned or salts thereof are of particular interest when individual radicals have one of the preferred meanings already mentioned or mentioned below, and in particular those which contain a combination of one or more of the preferred meanings already mentioned or mentioned below.

Of particular interest is the use according to the invention of compounds of the formula (I) or salts thereof in which R¹ is a nitrile group (—CN).

Of particular interest is also the use according to the invention of compounds of the formula (I) or salts thereof where

R¹ is a radical of the formula —C(═X)-Y—R or —C(═X)-Het,

in which

X is a divalent radical of the formula O, S or NR^{a} or N—NR^{a}R^{b}, where R^{a} and R^{b}are as defined below,

Y is a group of the formula O, S, NR^{c} or NR^{c}—NR^{d}R^{e}, where Rc, R^{d} and R^{e} are as defined below,

R is hydrogen, (C₁-C₁₈)-alkyl, (C₂-C₁₈)-alkenyl, (C₂-C₁₈)-alkynyl, (C₃-C₉)-cycloalkyl, (C₅-C₉)-cycloalkenyl, (C₃-C₉)-cycloalkyl-(C₁-C₁₂)-alkyl, phenyl, phenyl-(C₁-C₁₂)-alkyl, heterocyclyl or heterocyclyl-(C₁-C₁₂)-alkyl,

where each of the 10 last-mentioned radicals is unsubstituted or substituted by one or more radicals selected from the group consisting of halogen, hydroxyl, amino, cyano, nitro, thiocyanato, (C₁-C₄)-alkoxy, (C₁-C₄)-haloalkoxy, (C₂-C₄)-alkenyloxy, (C₂-C₄)— haloalkenyloxy, (C₁-C₄)-alkylthio, (C₁-C₄)-alkylsulfinyl, (C₁-C₄)-alkylsulfonyl, (C₁-C₄)-haloalkylsulfinyl, (C₁-C₄)-haloalkylsulfonyl, mono-(C₁-C₄)-alkylamino, di-(C₁-C₄)-alkylamino, (C₁-C₄)-alkanoyl, (C₁-C₄)-haloalkanoyl, [(C₁-C₄)-alkoxy]carbonyl, [(C₁-C₄)-haloalkoxy]carbonyl, aminocarbonyl, mono-[(C₁-C₄)-alkylamino]carbonyl, di-[(C₁-C₄)-alkylamino]carbonyl and, in the case of cyclic radicals, also (C₁-C₄)-alkyl and (C₁-C₄)-haloalkyl, or

(C₁-C₆)-alkanoyl, (C₁-C₄)-haloalkanoyl, [(C₁-C₄)-alkoxy]carbonyl, [(C₁-C₄)-haloalkoxy]carbonyl, phenylcarbonyl, phenoxycarbonyl, [phenyl-(C₁-C₄)-alkyl]carbonyl, [phenyl-(C₁-C₄)-alkoxy]carbonyl, where the phenyl ring of each of the 4 last-mentioned radicals is unsubstituted or substituted, aminocarbonyl, mono-[(C₁-C₄)-alkylamino]carbonyl, di-[(C₁-C₄)-alkylamino]carbonyl, (C₁-C₄)-alkylsulfinyl, (C₁-C₄)-alkylsulfonyl, (C₁-C₄)-haloalkylsulfinyl or (C₁-C₄)-haloalkylsulfonyl, and, including substituents, has 1 to 30 C-atoms, preferably 1 to 20 C-atoms, in particular 1 to 16 C-atoms, and/or

Het is an aliphatic N-heterocycle having a total of 1 to 3 heterocyclic ring atoms and a total of 5 or 6 ring atoms, which is attached via a heterocyclic ring N-atom to the group C(═X) and which may contain, as heterocyclic ring atoms, in addition to the N-atom in the yl-position, further heteroatoms selected from the group consisting of N, O and S and which is unsubstituted or substituted by one or more radicals selected from the group consisting of halogen, hydroxyl, amino, (C₁-C₄)-alkyl, (C₁-C₄)-alkoxy, (C₁-C₄)-haloalkyl, (C₁-C₄)-haloalkoxy, (C₁-C₄)-alkylthio and oxo,

where each of the radicals R^{a}, R^{b}, R^{C}, R^{d} and R^{e} in the radicals X and Y, in each case independently of one another and independently of the radical R, is as defined for R or a radical of the formula —OR*, where R*, independently of R, is as defined for R, and

R² and R⁶, in each case independently of one another, are hydrogen, halogen, SCN,

CN, (C₁-C₄)-alkyl, (C₂-C₄)-alkenyl, (C₂-C₄)-alkynyl or (C₃-C₆)-cycloalkyl, where each of the 4 last-mentioned radicals is unsubstituted or substituted by one or more radicals selected from the group consisting of halogen, hydroxyl, amino, cyano, nitro, thiocyanato, (C₁-C₄)-alkoxy, (C₁-C₄)-haloalkoxy, (C₁-C₄)-alkylthio, (C₁-C₄)-alkylsulfinyl, (C₁-C₄)-alkylsulfonyl, (C₁-C₄)-haloalkylsulfinyl, (C₁-C₄)-haloalkylsulfonyl, mono-(C₁-C₄)-alkylamino, di-(C₁-C₄)-alkylamino, (C₁-C₄)-alkanoyl, (C₁-C₄)— haloalkanoyl, [(C₁-C₄)-alkoxy]carbonyl, [(C₁-C₄)-haloalkoxy]carbonyl, aminocarbonyl, mono-[(C₁-C₄)-alkylamino]carbonyl, di-[(C₁-C₄)-alkylamino]carbonyl and, in the case of cyclic radicals, also (C₁-C₄)-alkyl and (C₁-C₄)-haloalkyl, and/or

R³ (a) in the case that n=0 is a radical selected from the group consisting of hydrogen, halogen, SCN and CN or a radical of the formula A¹ or B¹ or (b) in the case that n=1 is hydrogen or a radical of the formula A¹, B¹ or C¹: and

R⁴ (a) in the case that m=0 is a radical selected from the group consisting of hydrogen, halogen, SCN and CN or a radical of the formula A² or B² or

(b) in the case that m=1 is hydrogen or a radical of the formula A², B² or C² and

R⁵ (a) in the case that o=0 is hydrogen or a radical of the formula A³ or B³ or

(b) in the case that o=1 is hydrogen or a radical of the formula A³, B³ or c³

where each of the radicals A¹, A², A³, in each case independently of one another, is hydrogen, (C₁-C₁₈)-alkyl, (C₂-C₁₈)-alkenyl, (C₂-C₁₈)-alkynyl, (C₃-C₉)-cycloalkyl, (C₅-C₉)-cycloalkenyl, (C₃-C₉)-cycloalkyl-(C₁-C₁₂)-alkyl, phenyl, phenyl-(C₁-C₁₂)-alkyl, heterocyclyl or heterocyclyl-(C₁-C₁₂)-alkyl, where each of the 10 last-mentioned radicals is unsubstituted or substituted

by one or more radicals selected from the group consisting of halogen, hydroxyl, amino, cyano, nitro, thiocyanato, (C₁-C₄)-alkoxy, (C₁-C₄)- haloalkoxy, (C₂-C₄)-alkenyloxy, (C₂-C₄)-haloalkenyloxy, (C₁-C₄)-alkyl-thio, (C₁-C₄)-alkylsulfinyl, (C₁-C₄)-alkylsulfonyl, (C₁-C₄)-haloalkylsulfinyl, (C₁-C₄)-haloalkylsulfonyl, mono-(C₁-C₄)-alkylamino, di-(C₁-C₄)-alkyl-amino, (C₁-C₄)-alkanoyl, (C₁-C₄)-haloalkanoyl, [(C₁-C₄)-alkoxy]carbonyl, [(C₁-C₄)-haloalkoxy]carbonyl, aminocarbonyl, mono-[(C₁-C₄)-alkyl-amino]carbonyl, di-[(C₁-C₄)-alkylamino]carbonyl and, in the case of cyclic radicals, also (C₁-C₄)-alkyl and (C₁-C₄)-haloalkyl,

and has, including substituents, 1 to 30 C-atoms, preferably 1 to 20 C-atoms, in particular 1 to 16 C-atoms, and/or

where each of the radicals B¹, B², B³, in each case independently of one another, is (C₁-C₆)-alkanoyl, (C₁-C₄)-haloalkanoyl, [(C₁-C₄)-alkoxy]carbonyl, [(C₁-C₄)-haloalkoxy]carbonyl, phenylcarbonyl, phenoxycarbonyl, [phenyl-(C₁-C₄)-alkyl]carbonyl, [phenyl-(C₁-C₄)-alkoxy]carbonyl, where the phenyl ring of each of the 4 last-mentioned radicals may be unsubstituted or substituted, aminocarbonyl, mono-[(C₁-C₄)-alkylamino]carbonyl, di-[(C₁-C₄)-alkylamino]-carbonyl, (C₁-C₄)-alkylsulfinyl, (C₁-C₄)-alkylsulfonyl, (C₁-C₄)-haloalkylsulfinyl or (C₁-C₄)-haloalkylsulfonyl and/or

where each of the radicals C¹, C², C³, in each case independently of one another, is an aliphatic or aromatic heterocycle having a total of 1 to 3 heterocyclic ring atoms selected from the group consisting of N, O and S and a total of 5 or 6 ring atoms, which is unsubstituted or substituted by one or more radicals selected from the group consisting of halogen, hydroxyl, amino, (C₁-C₄)-alkyl, (C₁-C₄)-alkoxy, (C₁-C₄)-haloalkyl, (C₁-C₄)-haloalkoxy, (C₁-C₄)-alkylthio and oxo, and/or

Z, Z′, Z″, in each case independently of one another, are a group of the formula O, S(O)ₓ or NR′,

where x=0, 1 or 2 and R′ is hydrogen, (C₁-C₄)-alkyl, (C₂-C₄)-alkenyl, (C₂-C₄)-alkynyl, (C₃-C₆)-cycloalkyl, (C₁-C₄)-alkoxy, (C₂-C₄)-alkenyloxy, (C₂-C₄)-alkynyl-oxy or (C₃-C₆)-cycloalkyloxy,

where each of the 8 last-mentioned radicals is unsubstituted or substituted by one or more radicals selected from the group consisting of halogen, hydroxyl, amino, cyano, nitro, thiocyanato, (C₁-C₄)-alkoxy, (C₁-C₄)-haloalkoxy, (C₁-C₄)-alkylthio, (C₁-C₄)-alkylsulfinyl, (C₁-C₄)-alkylsulfonyl, (C₁-C₄)-haloalkylsulfinyl, (C₁-C₄)-haloalkylsulfonyl, mono-(C₁-C₄)-alkylamino, di-(C₁-C₄)-alkylamino, (C₁-C₄)-alkanoyl, (C₁-C₄)-haloalkanoyl, [(C₁-C₄)-alkoxy]carbonyl, [(C₁-C₄)-haloalkoxy]carbonyl, aminocarbonyl, mono-[(C₁-C₄)-alkylamino]carbonyl, di-[(C₁-C₄)-alkylamino]carbonyl and, in the case of cyclic radicals, also (C₁-C₄)-alkyl and (C₁-C₄)-haloalkyl, or

(C₁-C₆)-alkanoyl, (C₁-C₄)-haloalkanoyl, (C₁-C₆)-alkanoyloxy, (C₁-C₄)-halo-alkanoyloxy, [(C₁-C₄)-alkoxy]carbonyl, [(C₁-C₄)-haloalkoxy]carbonyl, [(C₁-C₄)-alkoxy]carbonyloxy, [(C₁-C₄)-haloalkoxy]carbonyloxy, phenylcarbonyl, phenoxycarbonyl, [phenyl-(C₁-C₄)-alkyl]carbonyl, [phenyl-(C₁-C₄)-alkoxy]-carbonyl, phenylcarbonyloxy, phenoxycarbonyloxy, [phenyl-(C₁-C₄)-alkyl]-carbonyloxy or [phenyl-(C₁-C₄)-alkoxy]carbonyloxy, where the phenyl ring of each of the 8 last-mentioned radicals is unsubstituted or substituted, or amino-carbonyl, mono-[(C₁-C₄)-alkylamino]carbonyl, di-[(C₁-C₄)-alkylamino]carbonyl, (C₁-C₄)-alkylsulfinyl, (C₁-C₄)-alkylsulfonyl, (C₁-C₄)-haloalkylsulfinyl or (C₁-C₄)-haloalkylsulfonyl,

m is an integer 0 or 1,

n is an integer o or 1 and

o is an integer 0 or 1,

where the sum m+n+o is an integer 1, 2 or 3 and, in the case of the alternatives (b) defined above, at least one of the radicals R³, R⁴ and R⁵ is selected from radicals from the group consisting of hydrogen and a radical of the formula B¹, B² and B³, respectively.

Of particular interest is also the use according to the invention of compounds of the formula (I) or salts thereof where

R¹ is a radical of the formula —C(═X)-Y—R or —C(═X)-Het,

in which

X is a divalent radical of the formula O, S or NR^{a} or N—NR^{a}R^{b}, where R^{a} and R^{b} are as defined below,

Y is a group of the formula O, S, NR^{c} or NR^{c}—NR^{d}R^{e}, where R^{C}, R^{d} and R^{e} are as defined below,

R is hydrogen, (C₁-C₁₂)-alkyl, (C₂-C₁₂)-alkenyl, (C₂-C₁₂)-alkynyl, (C₃-C₆)-cyclo-alkyl, (C₅-C₆)-cycloalkenyl, (C₃-C₆)-cycloalkyl-(C₁-C₄)-alkyl, phenyl, phenyl-(C₁-C₄)-alkyl, heterocyclyl or heterocyclyl-(C₁-C₄)-alkyl,

where each of the 10 last-mentioned radicals is unsubstituted or substituted by one or more radicals selected from the group consisting of halogen, hydroxyl, (C₁-C₄)-alkoxy, (C₁-C₄)-haloalkoxy, (C₂-C₄)-alkenyloxy, (C₂-C₄)-haloalkenyloxy, (C₁-C₄)-alkylthio, (C₁-C₄)-alkylsulfinyl, (C₁-C₄)-alkyl-sulfonyl, (C₁-C₄)-haloalkylsulfinyl, (C₁-C₄)-haloalkylsulfonyl, mono-(C₁-C₄)-alkylamino, di-(C₁-C₄)-alkylamino, (C₁-C₄)-alkanoyl, (C₁-C₄)-haloalkanoyl, [(C₁-C₄)-alkoxy]carbonyl, [(C₁-C₄)-haloalkoxy]carbonyl, aminocarbonyl, mono-[(C₁-C₄)-alkylamino]carbonyl, di-[(C₁-C₄)-alkylamino]carbonyl and, in the case of cyclic radicals, also (C₁-C₄)-alkyl and (C₁-C₄)-haloalkyl, or

(C₁-C₄)-alkanoyl, (C₁-C₄)-haloalkanoyl, [(C₁-C₄)-alkoxy]carbonyl, [(C₁-C₄)-haloalkoxy]carbonyl, phenylcarbonyl, phenoxycarbonyl, [phenyl-(C₁-C₄)-alkyl]-carbonyl, [phenyl-(C₁-C₄)-alkoxy]carbonyl, aminocarbonyl, mono-[(C₁-C₄)-alkylamino]carbonyl, di[—(C₁-C₄)-alkylamino]carbonyl, (C₁-C₄)-alkylsulfinyl, (C₁-C₄)-alkylsulfonyl, (C₁-C₄)-haloalkylsulfinyl or (C₁-C₄)-haloalkylsulfonyl and/or

Het is the radical of an aliphatic N-heterocycle selected from the group consisting of piperazinyl, piperidinyl, oxazolidinyl, isoxazolidinyl and morpholinyl, which is in each case attached via the N-ring atom and which is unsubstituted or substituted by one or more radicals selected from the group consisting of halogen, hydroxyl, amino, (C₁-C₄)-alkyl, (C₁-C₄)-alkoxy, (C₁-C₄)-haloalkyl, (C₁-C₄)-haloalkoxy, (C₁-C₄)-alkylthio and oxo,

where each of the radicals R^{a}, R^{b}, R^{C}, R^{d} and R^{e} in the radicals X and Y, in each case independently of one another and of the radical R, is as defined for R or a radical of the formula —OR*, where R*, independently of R, is as defined for R.

Preference is given to the use according to the invention of compounds of the formula (I) or salts thereof where

R¹ is a radical of the formula —C(═X)-Y—R,

in which

X is a divalent radical of the formula O, S or NR^{a} or N—NR^{a}R^{b}, preferably O or NR^{a}, where R^{a}and R^{b} are as defined below,

Y is a group of the formula O, S, NR^{c} or NR^{c}—NR^{d}R^{e}, preferably O or NR^{C}, where R^{C}, R^{d} and R^{e} are as defined below,

R is hydrogen, (C₁-C₈)-alkyl, (C₂-C₈)-alkenyl, (C₂-C₈)-alkynyl, (C₃-C₆)-cycloalkyl, (C₃-C₆)-cycloalkyl-(C₁-C₄)-alkyl, phenyl, phenyl-(C₁-C₄)-alkyl, heterocyclyl or heterocyclyl-(C₁-C₄)-alkyl,

where each of the 9 last-mentioned radicals is unsubstituted or substituted by one or more radicals selected from the group consisting of halogen, hydroxyl, (C₁-C₄)-alkoxy, (C₁-C₄)-haloalkoxy, (C₁-C₄)-alkylthio, (C₁-C₄)-alkylsulfinyl, (C₁-C₄)-alkylsulfonyl, mono-(C₁-C₄)-alkylamino, di-(C₁-C₄)-alkylamino, (C₁-C₄)-alkanoyl, (C₁-C₄)-haloalkanoyl, [(C₁-C₄)— alkoxy]carbonyl and, in the case of cyclic radicals, also (C₁-C₄)-alkyl and (C₁-C₄)-haloalkyl, or

(C₁-C₄)-alkanoyl, (C₁-C₄)-haloalkanoyl, [(C₁-C₄)-alkoxy]carbonyl, [(C₁-C₄)— haloalkoxy]carbonyl, phenylcarbonyl, phenoxycarbonyl, [phenyl-(C₁-C₄)-alkyl]-carbonyl, [phenyl-(C₁-C₄)-alkoxy]carbonyl, aminocarbonyl, mono-[(C₁-C₄)-alkylamino]carbonyl, di-[(C₁-C₄)-alkylamino]carbonyl, (C₁-C₄)-alkylsulfinyl, (C₁-C₄)-alkylsulfonyl, (C₁-C₄)-haloalkylsulfinyl or (C₁-C₄)-haloalkylsulfonyl,

where each of the radicals R^{a}, R^{b}, R^{C}, R^{d} and R^{e} in the radicals X and Y, in each case independently of one another and of the radical R, is as defined for R or a radical of the formula —OR*, where R*, independently of R, is as defined for R.

Particular preference is given to the use according to the invention of compounds of formula (I) or salts thereof where

R¹ is a radical of the formula

—CO—OR or

—C(═NR^{a})-OR or

—CO—NR^{c}R,

where R, R^{a}, R^{b} and Rc are as defined above;

preferably,

R¹ is a radical of the formula —CO—OR, where

R is hydrogen, (C₁-C₈)-alkyl, (C₂-C₈)-alkenyl, (C₂-C₈)-alkynyl, (C₃-C₆)-cycloalkyl, (C₃-C₆)-cycloalkyl-(C₁-C₄)-alkyl, phenyl, phenyl-(C₁-C₄)-alkyl, heterocyclyl or heterocyclyl-(C₁-C₄)-alkyl,

where each of the 9 last-mentioned radicals is unsubstituted or substituted by one or more radicals selected from the group consisting of halogen, hydroxyl, (C₁-C₄)-alkoxy, (C₁-C₄)-haloalkoxy, (C₁-C₄)-alkylthio, (C₁-C₄)-alkylsulfinyl, (C₁-C₄)-alkylsulfonyl, mono-(C₁-C₄)-alkylamino, di-(C₁-C₄)-alkylamino, (C₁-C₄)-alkanoyl, (C₁-C₄)-haloalkanoyl, [(C₁-C₄)-alkoxy]-carbonyl and, in the case of cyclic radicals, also (C₁-C₄)-alkyl and (C₁-C₄)-haloalkyl, and,

in particular

R is hydrogen, (C₁-C₆)-alkyl, (C₂-C₈)-alkenyl, (C₂-C₈)-alkynyl, (C₃-C₆)-cycloalkyl, or (C₃-C₆)-cycloalkyl-(C₁-C₄)-alkyl,

where each of the 5 last-mentioned radicals is unsubstituted or substituted by one or more radicals selected from the group consisting of halogen, hydroxyl, (C₁-C₄)-alkoxy, (C₁-C₄)-alkylthio and, in the case of cyclic radicals, also (C₁-C₄)-alkyl.

Very preferably, R¹ is a radical of the formula

—CO—OH or

—CO—O⁻M⁺or

—CO—OR,

where

R is (C₁-C₄)-alkyl, which is unsubstituted or substituted by one or more radicals selected from the group consisting of halogen, hydroxyl, (C₁-C₄)-alkoxy and (C₁-C₄)-alkylthio, and

M⁺is an agriculturally suitable cation, preferably one cation equivalent of an alkali metal or alkaline earth metal, in particular a sodium ion or potassium ion, or else an unsubstituted or substituted ammonium ion, preferably NH₄+ or an ammonium ion of an organic amine or a quaternary ammonium ion.

Examples of such radicals are:

R¹=carboxyl and salts thereof, methoxycarbonyl, ethoxycarbonyl, n-propoxycarbonyl, n-butoxycarbonyl, isopropoxycarbonyl, (2-hydroxyethoxy)-carbonyl.

Preferably, R¹ is also a radical of the formula

—C(═NR^{a})-OR, where

R and R^{a}are as defined above, preferably

R is (C₁-C₈)-alkyl, (C₂-C₈)-alkenyl, (C₂-C₈)-alkynyl, (C₃-C₆)-cycloalkyl, (C₃-C₆)— cycloalkyl-(C₁-C₄)-alkyl, phenyl, phenyl-(C₁-C₄)-alkyl, heterocyclyl or heterocyclyl-(C₁-C₄)-alkyl,

where each of the 9 last-mentioned radicals is unsubstituted or substituted by one or more radicals selected from the group consisting of halogen, hydroxyl, (C₁-C₄)-alkoxy, (C₁-C₄)-haloalkoxy, (C₁-C₄)-alkylthio, (C₁, —C₄)-alkylsulfinyl, (C₁-C₄)-alkylsulfonyl, mono-(C₁-C₄)-alkylamino, di-(C₁-C₄)-alkylamino, (C₁-C₄)-alkanoyl, (C₁-C₄)-haloalkanoyl, [(C₁-C₄)-alkoxy]carbonyl and, in the case of cyclic radicals, also (C₁-C₄)-alkyl and (C₁-C₄)-haloalkyl, or

(C₁-C₄)-alkanoyl, (C₁-C₄)-haloalkanoyl, [(C₁-C₄)-alkoxy]carbonyl, [(C₁-C₄)-halo-alkoxy]carbonyl, phenylcarbonyl, phenoxycarbonyl, [phenyl-(C₁-C₄)-alkyl]-carbonyl, [phenyl-(C₁-C₄)-alkoxy]carbonyl, aminocarbonyl, mono-[(C₁-C₄)-alkylamino]carbonyl, di-[(C₁-C₄)-alkylamino]carbonyl, (C₁-C₄)-alkylsulfinyl, (C₁-C₄)-alkylsulfonyl, (C₁-C₄)-haloalkylsulfinyl or (C₁-C₄)-haloalkylsulfonyl and

R^{a}is hydrogen or, independently of one another, defined as the radical R above, or, preferably,

(C₁-C₄)-alkanoyl, (C₁-C₄)-haloalkanoyl, [(C₁-C₄)-alkoxy]carbonyl, [(C₁-C₄)-halo-alkoxy]carbonyl, phenylcarbonyl, phenoxycarbonyl, [phenyl-(C₁-C₄)-alkyl]-carbonyl, [phenyl-(C₁-C₄)-alkoxy]carbonyl, aminocarbonyl, mono-[(C₁-C₄)— alkylamino]carbonyl, di-[(C₁-C₄)-alkylamino]carbonyl, (C₁-C₄)-alkylsulfinyl, (C₁-C₄)-alkylsulfonyl, (C₁-C₄)-haloalkylsulfinyl or (C₁-C₄)-haloalkylsulfonyl.

Examples of such radicals are:

R¹=methoxyacetiminocarbonyl, ethoxyacetiminocarbonyl, n-propoxyacetimino-carbonyl, isopropoxyacetiminocarbonyl, (2-hydroxyethoxy)acetiminocarbonyl, acetoxyiminocarbonyl, acetoxymethyliminocarbonyl, acetoxyethylimino-carbonyl, acetoxyacetiminocarbonyl.

Preferably, R¹ is also a radical of the formula

—CO—NR^{c}R, where R and Rc are as defined above; preferably,

R is hydrogen, (C₁-C₈)-alkyl, (C₂-C₈)-alkenyl, (C₂-C₈)-alkynyl, (C₃-C₆)-cycloalkyl, (C₃-C₆)-cycloalkyl-(C₁-C₄)-alkyl, phenyl, phenyl-(C₁-C₄)-alkyl, heterocyclyl or heterocyclyl-(C₁-C₄)-alkyl,

where each of the 9 last-mentioned radicals is unsubstituted or substituted by one or more radicals selected from the group consisting of halogen, hydroxyl, (C₁-C₄)-alkoxy, (C₁-C₄)-haloalkoxy, (C₁-C₄)-alkylthio, (C₁-C₄)-alkylsulfinyl, (C₁-C₄)-alkylsulfonyl, mono-(C₁-C₄)alkylamino, di-(C₁-C₄)-alkylamino, (C₁-C₄)-alkanoyl, (C₁-C₄)-haloalkanoyl, [(C₁-C₄)-alkoxy]carbonyl and, in the case of cyclic radicals, also (C₁-C₄)-alkyl and (C₁-C₄)-haloalkyl, or

(C₁-C₄)-alkanoyl, (C₁-C₄)-haloalkanoyl, [(C₁-C₄)-alkoxy]carbonyl, [(C₁-C₄)-halo-alkoxy]carbonyl, phenylcarbonyl, phenoxycarbonyl, [phenyl-(C₁-C₄)-alkyl]-carbonyl, [phenyl-(C₁-C₄)-alkoxy]carbonyl, aminocarbonyl, mono-[(C₁-C₄)-alkylamino]carbonyl, di-[(C₁-C₄)-alkylamino]carbonyl, (C₁-C₄)-alkylsulfinyl, (C₁-C₄)-alkylsulfonyl, (C₁-C₄)-haloalkylsulfinyl or (C₁-C₄)-haloalkylsulfonyl and

R^{c} is hydrogen or, independently of one another, is defined as the radical R above, or, preferably,

R^{c} is hydrogen, (C₁-C₄)-alkyl, which is unsubstituted or substituted by one or more radicals selected from the group consisting of halogen, hydroxyl, (C₁-C₄)-alkoxy and (C₁-C₄)-alkylthio, or

(C₁-C₄)-alkanoyl, (C₁-C₄)-haloalkanoyl, [(C₁-C₄)-alkoxy]carbonyl, [(C₁-C₄)-halo-alkoxy]carbonyl, (C₁-C₄)-alkylsulfinyl and (C₁-C₄)-alkylsulfonyl, or, in particular, hydrogen or (C₁-C₄)-alkyl.

Examples of such radicals are:

R¹=aminocarbonyl, N-methylaminocarbonyl, N-ethylaminocarbonyl, N-(n-propyl)-aminocarbonyl, N-isopropylaminocarbonyl, N-butylaminocarbonyl, N-(2-hydroxyethyl)aminocarbonyl, N-cycopropylaminocarbonyl, N-acetylamino-carbonyl, N-propionylaminocarbonyl, N,N-dimethylaminocarbonyl, N,N-di-ethylaminocarbonyl, N-ethyl-N-methylaminocarbonyl, N-acetyl-N-methyl-aminocarbonyl.

Preference is given to the use according to the invention of compounds of the formula (I) or salts thereof where

R² and R⁶, in each case independently of one another, are hydrogen, halogen, (C₁-C₄)-alkyl, which is unsubstituted or substituted by one or more radicals selected from the group consisting of halogen, hydroxyl, (C₁-C₄)-alkoxy, (C₁-C₄)-haloalkoxy, (C₁-C₄)-alkylthio, (C₁-C₄)-alkylsulfinyl, (C₁-C₄)-alkylsulfonyl, (C₁-C₄)-haloalkylsulfinyl, (C₁-C₄)-haloalkylsulfonyl, mono-(C₁-C₄)-alkylamino, di-(C₁-C₄)-alkylamino, (C₁-C₄)-alkanoyl, (C₁-C₄)-haloalkanoyl, [(C₁-C₄)-alkoxy]carbonyl, [(C₁-C₄)-haloalkoxy]-carbonyl, aminocarbonyl, mono-[(C₁-C₄)-alkylamino]carbonyl and di-[(C₁-C₄)-alkylamino]carbonyl; preferably,

R² and R⁶, in each case independently of one another, are hydrogen, halogen, (C₁-C₄)-alkyl, (C₁-C₄)-hydroxyalkyl or (C₁-C₄)-haloalkyl.

Preference is given to the use according to the invention of compounds of the formula (I) or salts thereof where

R³ (a) in the case that n=0 is a radical selected from the group consisting of hydrogen, halogen, SCN and CN or a radical of the formula A¹ or B¹ or (

b) in the case that n=1 is hydrogen or a radical of the formula A¹, B¹ or C¹ and

R⁴ (a) in the case that m=0 is a radical selected from the group consisting of hydrogen, halogen, SCN and CN or a radical of the formula A² or B² or

(b) in the case that m=1 is hydrogen or a radical of the formula A², B² or C² and

R⁵ (a) in the case that o=0 is hydrogen or a radical of the formula A³ or B³ or (b) in the case that o=1 is hydrogen or a radical of the formula A³, B³ or c³,

where each of the radicals A¹, A², A³, in each case independently of one another, is hydrogen, (C₁-C₁₂)-alkyl, (C₂-C₁₂)-alkenyl, (C₂-C₁₂)-alkynyl, (C₃-C₆)-cycloalkyl, (C₅-C₆)-cycloalkenyl, (C₃-C₆)-cycloalkyl-(C₁-C₄)-alkyl, phenyl, phenyl-(C₁-C₄)-alkyl, heterocyclyl or heterocyclyl-(C₁-C₄)-alkyl,

where each of the 10 last-mentioned radicals is unsubstituted or substituted by one or more radicals selected from the group consisting of halogen, hydroxyl, amino, (C₁-C₄)-alkoxy, (C₁-C₄)-haloalkoxy, (C₂-C₄)-alkenyloxy, (C₂-C₄)-haloalkenyloxy, (C₁-C₄)-alkylthio, (C₁-C₄)-alkylsulfinyl, (C₁-C₄)-alkylsulfonyl, (C₁-C₄)-haloalkylsulfinyl, (C₁-C₄)— haloalkylsulfonyl, mono-(C₁-C₄)-alkylamino, di-(C₁-C₄)-alkylamino, (C₁-C₄)-alkanoyl, (C₁-C₄)-haloalkanoyl, [(C₁-C₄)-alkoxy]carbonyl, [(C₁-C₄)-haloalkoxy]carbonyl, aminocarbonyl, mono-[(C₁-C₄)-alkyl-amino]carbonyl, di-[(C₁-C₄)-alkylamino]carbonyl and, in the case cyclic radicals, also (C₁-C₄)-alkyl and (C₁-C₄)-haloalkyl,

and, preferably,

each of the radicals A¹, A², A³, in each case independently of one another, is hydrogen, (C₁-C₈)-alkyl, (C₂-C₈)-alkenyl, (C₂-C₈)-alkynyl or (C₃-C₆)-cycloalkyl, where each of the 4 last-mentioned radicals is unsubstituted or substituted by one or more radicals selected from the group consisting of halogen, hydroxyl, (C₁-C₄)-alkoxy, (C₁-C₄)-haloalkoxy, (C₁-C₄)-alkylthio, (C₁-C₄)-alkylsulfinyl, (C₁-C₄)-alkylsulfonyl, (C₁-C₄)-alkanoyl, (C₁-C₄)-haloalkanoyl, [(C₁-C₄)-alkoxy]-carbonyl and, in the case of cyclic radicals, also (C₁-C₄)-alkyl and (C₁-C₄)-haloalkyl, and/or

where each of the radicals B¹, B², B³, in each case independently of one another, is (C₁-C₄)-alkanoyl, (C₁-C₄)-haloalkanoyl, [(C₁-C₄)-alkoxy]carbonyl, (C₁-C₄)-alkylsulfinyl, (C₁-C₄)-alkylsulfonyl, (C₁-C₄)-haloalkylsulfinyl or (C₁-C₄)— haloalkylsulfonyl or,

preferably, each of the radicals B¹, B², B³, in each case independently of one another, is (C₁-C₄)-alkanoyl, [(C₁-C₄)-alkoxy]carbonyl or (C₁-C₄)-alkylsulfonyl, and/or

where each of the radicals C¹, C², C³, in each case independently of one another, is an aliphatic or aromatic heterocycle having a total of 1 to 3 heterocyclic ring atoms selected from the group consisting of N, O and S and a total of 5 or 6 ring atoms, which is unsubstituted or substituted by one or more radicals selected from the group consisting of halogen, (C₁-C₄)-alkyl, (C₁-C₄)-alkoxy, (C₁-C₄)-haloalkyl, (C₁-C₄)-haloalkoxy, (C₁-C₄)-alkylthio and oxo, and

Z, Z′, Z″, in each case independently of one another, are a group of the formula O, S, SO, SO₂ or NR′,

where R′ is hydrogen, (C₁-C₄)-alkyl, (C₃-C₆)-cycloalkyl or (C₁-C₄)-alkoxy, where each of the 3 last-mentioned radicals is unsubstituted or substituted by one or more radicals selected from the group consisting of halogen, hydroxyl, (C₁-C₄)-alkoxy, (C₁-C₄)-haloalkoxy, (C₁-C₄)alkylthio and, in the case of cyclic radicals, also (C₁-C₄)-alkyl and (C₁-C₄)-haloalkyl, or

(C₁-C₆)-alkanoyl, (C₁-C₄)-haloalkanoyl, (C₁-C₆)-alkanoyloxy, (C₁-C₄)-halo-alkanoyloxy, [(C₁-C₄)-alkoxy]carbonyl, phenylcarbonyl, [phenyl-(C₁-C₄)-alkyl]-carbonyl or [phenyl-(C₁-C₄)-alkoxy]carbonyl, where the phenyl ring of each of the 3 last-mentioned radicals is unsubstituted or substituted, or (C₁-C₄)-alkyl-sulfinyl or (C₁-C₄)-alkylsulfonyl, or,

preferably, Z, Z′, Z″, in each case independently of one another, are a radical of the

formula O, or NR′, where R′ is hydrogen, (C₁-C₄)-alkyl or (C₃-C₆)-cycloalkyl, where each of the 9 last-mentioned radicals is unsubstituted or substituted by one or more radicals selected from the group consisting of halogen, hydroxyl, (C₁-C₄)-alkoxy, (C₁-C₄)-haloalkoxy, (C₁-C₄)-alkyl-thio and, in the case of cyclic radicals, also (C₁-C₄)-alkyl and (C₁-C₄)-haloalkyl, or

(C₁-C₆)-alkanoyl, (C₁-C₄)-haloalkanoyl or [(C₁-C₄)-alkoxy]carbonyl, and

m is an integer 0 or 1,

n is an integer 0 or 1 and

o is an integer 0 or 1,

where the sum m+n+o is an integer 1, 2 or 3 and, in the case of the alternatives (b) defined above, at least one of the radicals R³, R⁴ and R⁵ selected from radicals from the group consisting of hydrogen and a radical of the formula B¹, B² and B³, respectively.

Very preferred is the use according to the invention of compounds of the formula (I) or salts thereof where one, two or three of the radicals R³(Z)ₙ, R⁴(Z′)ₘ and R⁵(Z″)ₒ are a hydroxyl group or an acyloxy group, for example acetyloxy.

Of particular interest is the use of compounds of the formulae (Ia), (Ib), (Ic), (Id) and (Ie),

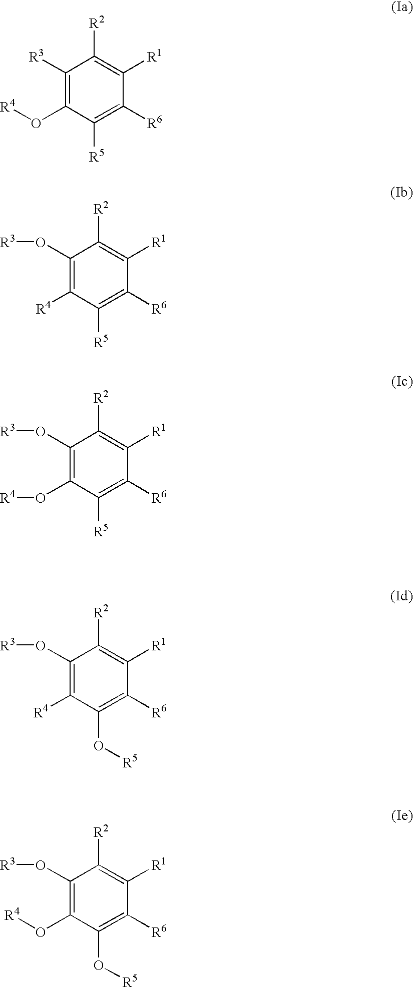

where R¹ to R⁵ are as defined and the radicals R³, R⁴and R⁵, which are attached to the oxygen atoms shown, are in each case hydrogen or an acyl radical as per B¹, B² or B³; p referably, at least one of the radicals attached to oxygen is hydrogen.

Examples of compounds (I) to be used according to the invention are listed in the tables below.

Some of the compounds of the formula (I) are known or can be prepared analogously to known processes. Their use as safeners or resistance inductors in plants has hitherto not been known.

Some compounds of the formula (I) or salts thereof (hereinbelow together referred to as “compounds (I) according to the invention” or “compounds (I)” or “safeners”) are novel and also form part of the subject-matter of the invention.

The compounds of the formula (I) can be prepared by derivatizing, for example acylating or etherifying, the hydroxybenzoates and their carboxyl derivatives as parent compounds by customary methods.

The invention also provides a method for protecting crop plants or useful plants against phytotoxic actions of agrochemicals, such as pesticides, or against environmental factors which cause damage to plants, which method comprises using compounds of the formula (I) or salts thereof as safeners or resistance inductors, preferably by applying an effective amount of the compounds of the formula (I) or their salts to the plants, to parts of plants or seeds or propagation material.

The safeners, together with active compounds (pesticides) are suitable for the selective control of harmful organisms in a number of plant crops, for example in crops of economic importance, such as cereals (wheat, barley, triticale, rye, rice, corn, millet), sugar beet, sugar cane, oilseed rape, cotton and soybeans. Of particular interest is the use in monocotyledonous crops, such as cereals (wheat, barley, triticale, sorghum), including corn and rice, and monocotyledonous vegetable crops, but also in dicotyledonous crops, such as, for example, soybean, oilseed rape, cotton, grape vines, vegetable plants, fruit plants and ornamental plants. Also of interest are mutant crops which are partially tolerant to some pesticides or transgenic crops which are partially tolerant, for example corn crops resistant to glufosinate or glyphosate, or soybean crops resistant to herbicidal imidazolinones. However, the particular advantage of the novel use of the safeners is their effective action in crops which are normally not tolerant to the pesticides mentioned.

For the joint use with pesticides, the compounds of the formula (I) according to the invention can be applied simultaneously with the active compounds or in any order, and they are then capable of reducing or completely eliminating harmful side-effects of these active compounds in crop plants, without negatively affecting or substantially reducing the activity of these active compounds against unwanted harmful organisms. Here, even damage caused by using a plurality of pesticides, for example a plurality of herbicides or herbicides in combination with insecticides or fungicides, can be reduced substantially or eliminated completely. In this manner, it is possible to extend the field of use of conventional herbicides considerably.

If the compositions according to the invention comprise pesticides, these compositions are, after appropriate dilution, applied either directly to the area under cultivation, to the already germinated harmful and/or useful plants or to the already emerged harmful and/or useful plants. If the compositions according to the invention do not comprise any pesticide, these compositions can be employed by the tank mix method—i.e. the user mixes and dilutes the separately available products (=the pesticide and the agent protecting the useful plants) immediately prior to application to the area to be treated—or prior to the application of a pesticide, or after the application of a pesticide, or for the pretreatment of seed, i.e., for example, for dressing the seed of the useful plants.

The advantageous actions of the compounds (I) according to the invention are observed when they are used together with the pesticides by the pre-emergence method or the post-emergence method, for example in the case of simultaneous application as a tank mix or a coformulation or in the case of a separate application, in parallel or in succession (split application). It is also possible to repeat the application a number of times. In some cases, it may be expedient to combine a pre-emergence application with a post-emergence application. In most cases, one option is a post-emergence application to the useful plant or crop plant together with a simultaneous or later application of the pesticide. Also possible is the use of the compounds (I) according to the invention for seed dressing, for (dip) treatment of seedlings or for the treatment of other propagation material (for example potato tubers).

When using the compounds (I) according to the invention in combination with herbicides, in addition to the safener action, enhanced herbicidal action against harmful plants is frequently also observed. Furthermore, in many cases, there is an improved growth of the useful plants and crop plants, and it is possible to increase the harvest yields.

Some of the last-mentioned advantageous actions are also observed when the compounds (I) are used without additional pesticides, in particular when other environmental factors negatively affect plant growth.

The compositions according to the invention may comprise one or more pesticides. Suitable pesticides are, for example, herbicides, insecticides, fungicides, acaricides and nematicides, which, when used on their own, would cause phytotoxic damage to the crop plants or would probably cause damage. Of particular interest are corresponding pesticidally active compounds from the groups of the herbicides, insecticides, acaricides, nematicides and fungicides, in particular herbicides.

The weight ratio of safener to pesticide can be varied within wide limits and is generally in the range from 1:100 to 100:1, preferably from 1:20 to 20:1, in particular from 1:10 to 10:1. The optimum weight ratio of safener to pesticide depends both on the respective safener used and the respective pesticide, and on the type of useful plant or crop plant to be protected. The required application rate of safener can, depending on the pesticide used and the type of useful plant to be protected, be varied within wide limits and is generally in the range from 0.001 to 10 kg, preferably from 0.005 to 5 kg, in particular from 0.1 to 1 kg, of safener per hectare.

For seed dressing, for example, from 0.005 to 20 g of safener per kilogram of seed, preferably from 0.01 to 10 g of safener per kilogram of seed, in particular from 0.05 to 5 g of safener per kilogram of seed, are used.

If solutions of safener are used for seed dressing and the seeds or seedlings are wetted with the solutions, the suitable concentration is generally in the range from 1 to 10 000 ppm, preferably from 100 to 1 000 ppm, based on the weight. The amounts and weight ratios required for a successful treatment can be determined by simple preliminary experiments.

The safeners can be formulated in the customary manner, separately or together with the pesticides. Accordingly, the present invention also provides the useful-plant-protecting or crop-plant-protecting compositions.

Insecticides which, on their own or together with herbicides, can cause damage to plants include, for example: organophosphates, for example terbufos (Counter®), fonofos (Dyfonate®), phorate (Thimet®), chlorpyriphos (Reldan®), carbamates, such as carbofuran (Furadan®), pyrethroid insecticides, such as tefluthrin (Force®), deltamethrin (Decis®) and tralomethrin (Scout®), and other insecticidal agents having a different mechanism of action.

Herbicides whose phytotoxic side effects on crop plants can be reduced using compounds of the formula I can be from entirely different structural classes and have entirely different mechanisms of action. Preference is given to commercially available herbicides as described, for example, in the handbook “The Pesticide Manual”, 13th Edition 2003, The British Crop Protection Council, and the e-Pesticide Manual Version 3 (2003), or else names which are referred to in the “Compendium of Pesticide Common Names” (searchable via the Internet) and in literature quoted therein. The herbicides and plant growth regulators mentioned hereinbelow by way of example are in each case referred to by their standardized common active compound name according to the “International Organization for Standardization” (ISO), or by the chemical name and the code number. Examples of active compounds whose phytotoxic action in crop plants and useful plants can be reduced by the compounds (I) according to the invention are:

acetochlor; acifluorfen(-sodium); aclonifen; AKH 7088, i.e. [[[1-[5-[2-chloro4-(tri-fluoromethyl)phenoxy]-2-nitrophenyl]-2-methoxyethylidene]amino]oxy]acetic acid and its methyl ester; alachlor; alloxydim(-sodium); ametryn; amicarbazone, amidochlor, amidosulfuron; aminopyralid, amitrol; AMS, i.e. ammonium sulfamate; anilofos; asulam; atrazine; azafenidin; azimsulfuron (DPX-A8947); aziprotryn; barban; BAS 516H, i.e. 5-fluoro-2-phenyl-4H-3,1-benzoxazin4-one; beflubutamid; benazolin(-ethyl); benfluralin; benfuresate; bensulfuron(-methyl); bensulide; bentazone(-sodium); benzfendizone, benzobicyclone; benzofenap; benzofluor; benzoylprop(-ethyl); benzthiazuron; bialaphos (bilanafos); bifenox; bispyribac-(-sodium); bromacil; bromobutide; bromofenoxim; bromoxynil; bromuron; buminafos; busoxinone; butachlor; butafenacil; butamifos; butenachlor; buthidazole; butralin; butroxydim; butylate; cafenstrole (CH-900); carbetamide; carfentrazone(-ethyl); caloxydim, CDAA, i.e. 2-chloro-N,N-di-2-propenylacetamide; CDEC, i.e. 2-chloroallyl diethyldithiocarbamate; chlomethoxyfen; chloramben; chlorazifop-butyl; chlorbromuron; chlorbufam; chlorfenac; chlorfenprop, chlorflurenol-methyl; chloridazon; chlorimuron(-ethyl); chlornitrofen; chlorotoluron; chloroxuron; chlorpropham; chlorsulfuron; chlorthal-dimethyl; chlorthiamid; chlortoluron, cinidon-(-methyl or -ethyl), cinmethylin; cinosulfuron; clethodim; clefoxydim, clodinafop and its ester derivatives (for example clodinafop-propargyl); clomazone; clomeprop; cloprop, cloproxydim; clopyralid; clopyrasulfuron(-methyl); cloransulam(-methyl); cumyluron (JC 940); cyanazine; cycloate; cyclosulfamuron (AC 104); cycloxydim; cycluron; cyhalofop and its ester derivatives (for example butyl ester, DEH-112); cyperquat; cyprazine; cyprazole; daimuron; 2,4-D; 2,4-DB; dalapon; dazomet, desmedipham; desmetryn; di-allate; dicamba; dichlobenil; dichlorprop(—P); diclofop and its esters such as diclofop-methyl; diclosulam, diethatyl(-ethyl); difenoxuron; difenzoquat; diflufenican; diflufenzopyr; dimefuron; dimepiperate; dimethachlor; dimethametryn; dimethenamid (SAN-582H); dimethenamid(—P); dimethazone, dimethipin; dimexyflam, dimetrasulfuron, dinitramine; dinoseb; dinoterb; diphenamid; dipropetryn; diquat; dithiopyr; diuron; DNOC; eglinazine-ethyl; EL 77, i.e. 5-cyano-1-(1,1-dimethylethyl)-N-methyl-1H-pyrazole4-carboxamide; endothal; epoprodan, EPTC; esprocarb; ethalfluralin; ethametsulfuron-methyl; ethidimuron; ethiozin; ethofumesate; ethoxyfen and its esters (for example ethyl ester, HC-252), ethoxysulfuron, etobenzanid (HW 52); F5231, i.e. N-[2-chloro4-fluoro-5-[4-(3-fluoropropyl)4,5-dihydro-5-oxo-1H-tetrazol-1-yl]-phenyl]ethanesulfonamide; fenoprop; fenoxan, fenoxaprop and fenoxaprop-P and their esters, for example fenoxaprop-P-ethyl and fenoxaprop-ethyl; fenoxydim; fentrazamide; fenuron; flamprop(-methyl or -isopropyl or -isopropyl-L); flazasulfuron; florasulam; fluazifop and fluazifop-P and their esters, for example fluazifop-butyl and fluazifop-P-butyl; fluazolate, flucarbazone(-sodium); flucetosulfuron, fluchloralin; flufenacet (FOE 5043), flufenpyr, flumetsulam; flumeturon; flumiclorac(-pentyl); flumioxazin (S-482); flumipropyn; fluometuron; fluorochloridone, fluorodifen; fluoroglycofen(-ethyl); flupoxam (KNW-739); flupropacil (UBIC-4243); fluproanate, flupyrsulfuron(-methyl, or -sodium); flurenol(-butyl); fluridone; flurochloridone; fluroxypyr(-meptyl); flurprimidol, flurtamone; fluthiacet(-methyl); fluthiamide (also known as flufenacet); fomesafen; foramsulfuron; fosamine; furilazole (MON 13900), furyloxyfen; glufosinate(-ammonium); glyphosate(-isopropylammonium); halosafen; halosulfuron(-methyl) and its esters (for example the methyl ester, NC-319); haloxyfop and its esters; haloxyfop-P (═R-haloxyfop) and its esters; HC-252 (diphenylether), hexazinone; imazamethabenz(-methyl); imazamethapyr; imazamox; imazapic, imazapyr; imazaquin and salts such as the ammonium salts; imazethamethapyr; imazethapyr, imazosulfuron; indanofan; iodosulfuron-(methyl)-(sodium), ioxynil; isocarbamid; isopropalin; isoproturon; isouron; isoxaben; isoxachlortole; isoxaflutole; isoxapyrifop; karbutilate; lactofen; lenacil; linuron; MCPA; MCPA-thioethyl, MCPB; mecoprop(—P); mefenacet; mefluidid; mesosulfuron(-methyl); mesotrione; metam, metamifop, metamitron; metazachlor; methabenzthiazuron; methazole; methoxyphenone; methyldymron; metobenzuron, metobromuron; (S—)metolachlor; metosulam (XRD 511); metoxuron; metribuzin; metsulfuron-methyl; MK-616; molinate; monalide; monocarbamide dihydrogensulfate; monolinuron; monuron; MT 128, i.e. 6-chloro-N-(3-chloro-2-propenyl)-5-methyl-N-phenyl-3-pyridazinamine; MT 5950, i.e. N-[3-chloro-4-(1-methylethyl)-phenyl]-2-methylpentanamide; naproanilide; napropamide; naptalam; NC 310, i.e. 4-(2,4-dichlorobenzoyl)-1-methyl-5-benzyloxypyrazole; neburon; nicosulfuron; nipyraclophen; nitralin; nitrofen; nitrofluorfen; norflurazon; orbencarb; oryzalin; oxadiargyl (RP-020630); oxadiazone; oxasulfuron; oxaziclomefone; oxyfluorfen; paraquat; pebulate; pelargonic acid; pendimethalin; penoxulam; pentanochlor, pentoxazone; perfluidone; pethoxamid, phenisopham; phenmedipham; picloram; picolinafen; piperophos; piributicarb; pirifenop-butyl; pretilachlor; primisulfuron(-methyl); procarbazone(-sodium); procyazine; prodiamine; profluazole, profluralin; proglinazine(-ethyl); prometon; prometryn; propachlor; propanil; propaquizafop; propazine; propham; propisochlor; propoxycarbazone-(-sodium), propyzamide; prosulfalin; prosulfocarb; prosulfuron (CGA-152005); prynachlor; pyraclonil, pyraflufen(-ethyl); pyrazolinate; pyrazon; pyrazosulfuron-(-ethyl); pyrazoxyfen; pyribenzoxim; pyributicarb; pyridafol; pyridate; pyriftalid, pyrimidobac(-methyl); pyrithiobac(-sodium) (K1H-2031); pyroxofop and its esters (for example propargyl ester); quinclorac; quinmerac; quinoclamine, quinofop and its ester derivatives, quizalofop and quizalofop-P and their ester derivatives, for example quizalofop-ethyl; quizalofop-P-tefuryl and -ethyl; renriduron; rimsulfuron (DPX-E 9636); S 275, i.e. 2-[4-chloro-2-fluoro-5-(2-propynyloxy)phenyl]4,5,6,7-tetrahydro-2H-indazole; secbumeton; sethoxydim; siduron; simazine; simetryn; SN 106279, i.e. 2-[[7-[2-chloro-4-(trifluoromethyl)phenoxy]-2-naphthalenyl]oxy]propanoic acid and its methyl ester; sulcotrione; sulfentrazone (FMC-97285, F-6285); sulfazuron; sulfometuron(-methyl); sulfosate (ICI-A0224); sulfosulfuron; TCA; tebutam (GCP-5544); tebuthiuron; tepraloxydim; terbacil; terbucarb; terbuchlor; terbumeton; terbuthylazine; terbutryn; TFH 450, i.e. N,N-diethyl-3-[(2-ethyl-6-methylphenyl)sulfonyl]-1H-1,2,4-triazole-1-carboxamide; thenylchlor (NSK-850); thiafluamide; thiazafluron; thiazopyr (Mon-13200); thidiazimin (SN-24085); thidiazuron, thifensulfuron(-methyl); thiobencarb; tiocarbazil; tralkoxydim; tri-allate; triasulfuron; triaziflam; triazofenamide; tribenuron(-methyl); 2,3,6-trichlorobenzoic acid (2,3,6-TBA), triclopyr; tridiphane; trietazine; trifloxysulfuron(-sodium), trifluralin; triflusulfuron and esters (e.g. methyl ester, DPX-66037); trimeturon; tritosulfuron; tsitodef; vernolate; WL 110547, i.e. 5-phenoxy-1-[3-(trifluoromethyl)phenyl]-1H-tetrazole; UBH-509; D-489; LS 82-556; KPP-300; NC-324; NC-330; KH-218; DPX—N8189; SC-0774; DOWCO-535; DK-8910; V-53482; PP-600; MBH-001; K1H-9201; ET-751; K1H-6127; K1H-2023 and KIH5996.

Herbicides, whose phytotoxic side effects on crop plants can be reduced using compounds of the formula I are, for example, herbicides from the group of the carbamates, thiocarbamates, haloacetanilides, substituted phenoxy-, naphthoxy- and phenoxyphenoxycarboxylic acid derivatives and heteroaryloxyphenoxyalkane-carboxylic acid derivatives, such as quinolyloxy-, quinoxalyloxy-, pyridyloxy-, benzoxazolyloxy- and benzothiazolyloxyphenoxyalkanecarboxylic acid esters, cyclo-hexanedione oximes, benzoylcyclohexanediones, benzoylisoxazoles, benzoyl-pyrazoles, imidazolinones, pyrimidinyloxypyridinecarboxylic acid derivatives, pyrimidyloxybenzoic acid derivatives, sulfonylureas, sulfonylaminocarbonyl-triazolinones, triazolopyrimidinesulfonamide derivatives, phosphinic acid derivatives and salts thereof, glycine derivatives, triazolinones, triazinones and also S-(N-aryl-N-alkylcarbamoylmethyl)dithiophosphoric esters, pyridinecarboxylic acids, pyridines, pyridinecarboxamides, 1,3,5-triazines and others.

Preference is given to phenoxyphenoxy- and heteroaryloxyphenoxycarboxylic acid esters and salts, cyclohexanedione oximes, benzoylcyclohexanediones, benzoyl-isoxazoles, sulfonylureas, sulfonylaminocarbonyltriazolinones, imidazolinones and mixtures of the active compounds mentioned with one another and/or with active compounds used for broadening the activity spectrum of the herbicides, for example bentazone, cyanazine, atrazine, bromoxynil, dicamba and other leaf-acting herbicides.

Herbicides which are suitable for combination with the safeners according to the invention are, for example:

A) herbicides of the type of the phenoxyphenoxy- and heteroaryloxyphenoxy-carboxylic acid derivatives, such as

A1) phenoxyphenoxy- and benzyloxyphenoxycarboxylic acid derivatives, for example methyl 2-(4-(2,4-dichlorophenoxy)phenoxy)propionate (diclofop-methyl), methyl 2-(4-(4-bromo-2-chlorophenoxy)phenoxy)propionate (DE-A 26 01 548), methyl 2-(4-(4-bromo-2-fluorophenoxy)phenoxy)propionate (U.S. Pat. No. 4,808,750), methyl 2-(4-(2-chloro-4-trifluoromethylphenoxy)phenoxy)propionate (DE-A 24 33 067),

methyl 2-(4-(2-fluoro-4-trifluoromethylphenoxy)phenoxy)propionate (U.S. Pat. No. 4,808,750),

methyl 2-(4-(2,4-dichlorobenzyl)phenoxy)propionate (DE-A 24 17 487),

ethyl 4-(4-(4-trifluoromethylphenoxy)phenoxy)pent-2-enoate, methyl 2-(4-(4-trifluoromethylphenoxy)phenoxy)propionate (DE-A 24 33 067), butyl (R)-2-[4-(4-cyano-2-fluorophenoxy)phenoxy]propionate (cyhalofop-butyl)

A2) “monocyclic” heteroaryloxyphenoxyalkanecarboxylic acid derivatives, for example

ethyl 2-(4-(3,5-dichloropyridyl-2-oxy)phenoxy)propionate (EP-A 0 002 925), propargyl 2-(4-(3,5-dichloropyridyl-2-oxy)phenoxy)propionate (EP-A 0 003 114), methyl (RS)- or (R)-2-(4-(3-chloro-5-trifluoromethyl-2-pyridyloxy)phenoxy)propionate (haloxyfop-methyl or haloxyfop-P-methyl),

ethyl 2-(4-(3-chloro-5-trifluoromethyl-2-pyridyloxy)phenoxy)propionate (EP-A 0 003 890),

propargyl 2-(4-(5-chloro-3-fluoro-2-pyridyloxy)phenoxy)propionate (clodinafop-propargyl),

butyl (RS)- or (R)-2-(4-(5-trifluoromethyl-2-pyridyloxy)phenoxy)propionate (fluazifop-butyl or fluazifop-P-butyl),

(R)-2-[4-(3-chloro-5-trifluoromethyl-2-pyridyloxy)phenoxy]propionic acid;

A3) “bicyclic” heteroaryloxyphenoxyalkanecarboxylic acid derivatives, for example

methyl and ethyl (RS)- or (R)-2-(4-(6-chloro-2-quinoxalyloxy)phenoxy)propionate (quizalofop-methyl and -ethyl or quizalofop-P-methyl and —P-ethyl), methyl 2-(4-(6-fluoro-2-quinoxalyloxy)phenoxy)propionate (see J. Pest. Sci. Vol. 10, 61 (1985)),

2-isopropylidenaminooxyethyl (R)-2-(4-(6-chloro-2-quinoxalyloxy)phenoxy)-propionate (propaquizafop),

ethyl (RS)- or (R)-2-(4-(6-chlorobenzoxazol-2-yloxy)phenoxy)propionate (fenoxaprop-ethyl or fenoxaprop-P-ethyl),

ethyl 2-(4-(6-chlorobenzthiazol-2-yloxy)phenoxy)propionate (DE-A-26 40 730), tetrahydro-2-furylmethyl (RS)- or (R)-2-(4-(6-chloroquinoxalyloxy)phenoxy)propionate (EP-A-0 323 727);

B) herbicides from the group of the sulfonylureas, such as pyrimidinyl- or triazinylaminocarbonyl[benzene-, -pyridine-, -pyrazole-, -thiophene- and -(alkyl-sulfonyl)alkylamino]sulfamides. Preferred substituents on the pyrimidine ring or the triazine ring are alkoxy, alkyl, haloalkoxy, haloalkyl, halogen or dimethylamino, it being possible to combine all substituents independently of one another. Preferred substituents in the benzene, pyridine, pyrazole, thiophene or (alkylsulfonyl)alkyl-amino moiety are alkyl, alkoxy, halogen, nitro, alkoxycarbonyl, aminocarbonyl, alkylaminocarbonyl, dialkylaminocarbonyl, alkoxyaminocarbonyl, haloalkoxy, haloalkyl, alkylcarbonyl, alkoxyalkyl, (alkanesulfonyl)alkylamino. Such suitable sulfonylureas are, for example,

B1) phenyl- and benzylsulfonylureas and related compounds, for example

1-(2-chlorophenylsulfonyl)-3-(4-methoxy-6-methyl-1,3,5-triazin-2-yl)urea (chlorsulfuron),

1-(2-ethoxycarbonylphenylsulfonyl)-3-(4-chloro-6-methoxypyrimidin-2-yl)ᵤ rea (chlorimuron-ethyl),

1-(2-methoxyphenylsulfonyl)-3-(4-methoxy-6-methyl-1,3,5-triazin-2-yl)urea (metsulfuron-methyl),

1-(2-chloroethoxyphenylsulfonyl)-3-(4-methoxy-6-methyl-1,3,5-triazin-2-yl)urea (triasulfuron),

1-(2-Methoxycarbonylphenylsulfonyl)-3-(4,6-dimethylpyrimidin-2-yl)harnstoff (sulfumeturon-methyl),

1-(2-methoxycarbonylphenylsulfonyl)-3-(4-methoxy-6-methyl-1,3,5-triazin-2-yl)-3-methylurea (tribenuron-methyl),

1-(2-methoxycarbonylbenzylsulfonyl)-3-(4,6-dimethoxypyrimidin-2-yl)urea (bensulfuron-methyl),

1-(2-methoxycarbonylphenylsulfonyl)-3-(4,6-bis-(difluoromethoxy)pyrimidin-2-yl)urea, (primisulfuron-methyl),

3-(4-ethyl-6-methoxy-1,3,5-triazin-2-yl)-1-(2,3-dihydro-1,1-dioxo-2-methylbenzo[b]-thiophene-7-sulfonyl)urea (EP-A 0 796 83),

3-(4-ethoxy-6-ethyl-1,3,5-triazin-2-yl)-1-(2,3-dihydro-1,1-dioxo-2-methylbenzo[b]-thiophene-7-sulfonyl)urea (EP-A 0 079 683),

3-(4-methoxy-6-methyl-1,3,5-triazin-2-yl)-1-(2-methoxycarbonyl-5-iodophenyl-sulfonyl)urea (WO 92/13845),

methyl 2-[4-dimethylamino-6-(2,2,2-trifluoroethoxy)-1,3,5-triazin-2-ylcarbamoyl-sulfamoyl]-3-methylbenzoate (DPX-66037, triflusulfuron-methyl), oxetan-3-yl 2-[(4,6-dimethylpyrimidin-2-yl)carbamoylsulfamoyl]benzoate (CGA-277476, oxasulfuron),

methyl 4-iodo-2-[3-(4-methoxy-6-methyl-1,3,5-triazin-2-yl)ureidosulfonyl]benzoate, sodium salt (iodosulfuron-methyl-sodium),

methyl 2-[3-(4,6-dimethoxypyrimidin-2-yl)ureidosulfonyl]-4-methanesulfonylamino-methylbenzoate (mesosulfuron-methyl, WO 95/10507),

N,N-dimethyl-2-[3-(4,6-dimethoxypyrimidin-2-yl)ureidosulfonyl]4-formylamino-benzamide (foramsulfuron, WO 95/01344),

1-(4,6-dimethoxy-1,3,5-triazin-2-yl)-3-[2-(2-methoxyethoxy)phenylsulfonyl]urea (cinosulfuron),

methyl 2-[(4-ethoxy-6-methylamino-1,3,5-triazin-2-yl)carbamoylsulfamoyl]benzoate (ethametsulfuron-methyl),

1-(4-methoxy-6-methyl-1,3,5-triazin-2-yl)-3-[2-(3,3,3-trifluoropropyl)phenylsulfonyl]-urea (prosulfuron),

methyl 2-(4,6-dimethylpyrimidin-2-ylcarbamoylsulfamoyl)benzoate (sulfometuron-methyl),

1-(4-methoxy-6-trifluoromethyl-1,3,5-triazin-2-yl)-3-(2-trifluoromethyl-benzenesulfonyl)urea (tritosulfuron);

B2) thienylsulfonylureas, for example

1-(2-methoxycarbonylthiophen-3-yl)-3-(4-methoxy-6-methyl-1,3,5-triazin-2-yl)urea (thifensulfuron-methyl);

B3) pyrazolylsulfonylureas, for example

1-(4-ethoxycarbonyl-1-methylpyrazol-5-ylsulfonyl)-3-(4,6-dimethoxypyrimidin-2-yl)-urea (pyrazosulfuron-ethyl),

methyl 3-chloro-5-(4,6-dimethoxypyrimidin-2-ylcarbamoylsulfamoyl)-1-methyl-pyrazole4-carboxylate (halosulfuron-methyl),

methyl 5-(4,6-dimethylpyrimidin-2-yl-carbamoylsulfamoyl)-1-(2-pyridyl)pyrazole-4-carboxylate (NC-330, see Brighton Crop Prot. Conference ‘Weeds’ 1991, Vol. 1, p. 45 ff.),

1-(4,6-dimethoxypyrimidin-2-yl)-3-[1-methyl4-(2-methyl-2H-tetrazol-5-yl)pyrazol-5-yl-sulfonyl]urea (DPX-A8947, azimsulfuron);

B4) sulfonediamide derivatives, for example

3-(4,6-dimethoxypyrimidin-2-yl)-1-(N-methyl-N-methylsulfonylaminosulfonyl)urea (amidosulfuron) and its structural analogs (EP-A 0 131 258 and Z. Pfl. Krankh. Pfl. Schutz, special issue XII, 489-497 (1990));

B5) pyridylsulfonylureas, for example

1-(3-N,N-dimethylaminocarbonylpyridin-2-ylsulfonyl)-3-(4,6-dimethoxypyrimidin-2-yl)-urea (nicosulfuron),

1-(3-ethylsulfonylpyridin-2-ylsulfonyl)-3-(4,6-dimethoxypyrimidin-2-yl)urea (rimsulfuron),

methyl 2-[3-(4,6-dimethoxypyrimidin-2-yl)ureidosulfonyl]-6-trifluoromethyl-3-pyridine-carboxylate, sodium salt (DPX-KE 459, flupyrsulfuron-methyl-sodium),

3-(4,6-dimethoxypyrimidin-2-yl)-1-(3-N-methylsulfonyl-N-methylaminopyridin-2-yl)-sulfonylurea or its salts (DE-A 40 00 503 and DE-A 40 30 577),

1-(4,6-dimethoxypyrimidin-2-y)-3-(3-trifluoromethyl-2-pyridylsulfonyl)urea (flazasulfuron),

1-(4,6-dimethoxypyrimidin-2-yl)-3-[3-(2,2,2-trifluoroethoxy)-2-pyridylsulfonyl]ᵤ rea sodium salt (trifloxysulfuron-sodium);

B6) alkoxyphenoxysulfonylureas, for example

3-(4,6-dimethoxypyrimidin-2-yl)-1-(2-ethoxyphenoxy)sulfonylurea or its salts (ethoxysulfuron);

B7) imidazolylsulfonylureas, for example

1-(4,6-dimethoxypyrimidin-2-yl)-3-(2-ethylsulfonylimidazo[1,2-a]pyridin-3-yl)sulfonyl-urea (MON 37500, sulfosulfuron),

1-(2-chloroimidazo[1,2-a]pyridin-3-ylsulfonyl)-3-(4,6-dimethoxypyrimidin-2-yl)urea (imazosulfuron);

B8) phenylaminosulfonylureas, for example

1-[2-(cyclopropylcarbonyl)phenylaminosulfonyl]-3-(4,6-dimethoxypyrimidin-2-yl)urea (cyclosulfamuron);

C) chloroacetanilides, for example acetochlor, alachlor, butachlor, dimethachlor, dimethenamid, metazachlor,

metolachlor, S-metolachlor, pethoxamid, pretilachlor, propachlor, propisochlor and thenylchlor;

D) thiocarbamates, for example S-ethyl N,N-dipropylthiocarbamate (EPTC),

S-ethyl N,N-diisobutylthiocarbamate (butylate);

cycloate, dimepiperate, esprocarb, molinate, orbencarb, pebulate, prosulfocarb, thiobencarb, tiocarbazil and tri-allate;

E) cyclohexanedione oximes, for example

alloxydim, butroxydim, clethodim, cloproxydim, cycloxydim, protoxydim, sethoxydim, tepraloxydim and tralkoxydim;

F) imidazolinones, for example imazamethabenz-methyl, imazapic, imazamox, imazapyr, imazaquin and imazethapyr;

G) triazolopyrimidinesulfonamide derivatives, for example chloransulam-methyl, diclosulam, florasulam, flumetsulam, metosulam and penoxulam;

H) benzoylcyclohexanediones, for example

2-(2-chloro4-methylsulfonylbenzoyl)cyclohexane-1,3-dione (SC-0051, sulcotrione),

2-(2-nitrobenzoyl)4,4-dimethylcyclohexane-1,3-dione (EP-A 0 274 634),

2-(2-nitro-3-methylsulfonylbenzoyl)4,4-dimethylcyclohexane-1,3-dione (WO 91/13548),

2-[4-(methylsulfonyl)-2-nitrobenzoyl]-1,3-cyclohexanedione (mesotrione);

I) benzoylisoxazoles, for example

5-cyclopropyl-[2-(methylsulfonyl)₄-(trifluoromethyl)benzoyl]isoxazole (isoxaflutole);

J) benzoylpyrazoles, for example

2-[4-(2,4-dichloro-m-toluyl)-1,3-dimethylpyrazol-5-yloxy]4′-methylacetophenone (benzofenap),

4-(2,4-dichlorobenzoyl)-1,3-dimethylpyrazol-5-yl toluene-4-sulfonate (pyrazolynate),

2-[4-(2,4-dichlorobenzoyl)-1,3-dimethylpyrazol-5-yloxy]acetophenone (pyrazoxyfen);

K) sulfonylaminocarbonyltriazolinones, for example

4,5-dihydro-3-methoxy-4-methyl-5-oxo-N-(2-trifluoromethoxyphenylsulfonyl)-1H-1,2,4-triazole-1-carboxamide sodium salt (flucarbazone-sodium),

methyl 2-(4,5-dihydro-4-methyl-5-oxo-3-propoxy-1H-1,2,4-triazol-1-yl)carboxamido-sulfonylbenzoate sodium salt (propoxycarbazone-Na);

L) triazolinones, for example

4-amino-N-tert-butyl-4,5-dihydro-3-isopropyl-5-oxo-1, 2, 4-1H-triazole-1-carboxamide (amicarbazone),

2-(2,4-dichloro-5-prop-2-ynyloxyphenyl)-5,6,7,8-tetrahydro-1,2,4-triazolo[4,3-a]-pyridin-3(2H)-one (azafenidin),

ethyl (RS)-2-chloro-3-[2-chloro-5-(4-difluoromethyl-4,5-dihydro-3-methyl-5-oxo-1H-1,2,4-triazol-1-yl)-4-fluorophenyl]propionate (carfentrazone-ethyl),

2′,4′-dichloro-5′-(4-difluoromethyl-4,5-dihydro-3-methyl-5-oxo-1H-1,2,4-triazol-1-yl)-methanesulfonanilide (sulfentrazone);

M) phosphinic acids and derivatives, for example

4-[hydroxy(methyl)phosphinoyl]-L-homoalanyl-L-alanyl-L-alanine (bilanafos), DL-homoalanin4-yl(methyl)phosphinic acid ammonium salt (glufosinate-ammonium);

N) glycine derivatives, for example

N-(phosphonomethyl)glycine and its salts (glyphosate and salts, for example the sodium salt or the isopropylammonium salt),

N-(phosphonomethyl)glycine trimesium salt (sulfosate);

0) pyrimidinyloxypyridinecarboxylic acid derivatives and pyrimidinyloxybenzoic acid derivatives, for example

benzyl 3-(4,6-dimethoxypyrimidin-2-yl)oxypyridine-2-carboxylate (EP-A 0 249 707),

methyl 3-(4,6-dimethoxypyrimidin-2-yl)oxypyridine-2-carboxylate (EP-A 0 249 707), 1-(ethoxycarbonyloxyethyl) 2,6-bis[(4,6-dimethoxypyrimidin-2-yl)oxy]benzoate (EP-A 0 472 113),

2,6-bis[(4,6-dimethoxypyrimidin-2-yl)oxy]benzoic acid (bispyribac-sodium), pyribenzoxim, pyriftalid, pyriminobac-methyl and pyrithiobac-sodium;

P)S-(N-aryl-N-alkylcarbamoylmethyl)dithiophosphonic acid esters, such as S-[N-(4-chlorophenyl)-N-isopropylcarbamoylmethyl] O,O-dimethyl dithiophosphate (anilophos);

Q) triazinones, for example 3-cyclohexyl-6-dimethylamino-1-methyl-1,3,5-triazine-2,4-(1H,3H)-dione (hexazinone),

4-amino-4,5-dihydro-3-methyl-6-phenyl-1,2,4-triazin-5-one (metamitron), 4-amino-6-tert-butyl-4,5-dihydro-3-methylthio-1,2,4-triazin-5-one (metribuzin);

R) pyridinecarboxylic acids, for example clopyralid, fluroxypyr, picloram and triclopyr;

S) pyridines, for example dithiopyr and thiazopyr;

T) pyridinecarboxamides, for example diflufenican and picolinafen;

U) 1,3,5-triazines, for example ametryn, atrazine, cyanazine, dimethametrin, prometon, prometryn, propazine, simazine, symetryn, terbumeton, terbuthylazine, terbutryn and trietazine;

V) plant growth regulators, for example forchlorfenuron and thidiazuron.

The herbicides of groups A to V are known, for example, from the respective abovementioned publications and from “The Pesticide Manual”, The British Crop Protection Council, 13th Edition, 2003, or the e-Pesticide Manual, Version 3.0, British Crop Protection Council 2003.

The compounds of the formula (I) and their combinations with one or more of the abovementioned pesticides can be formulated in various ways, depending on the prevailing physicochemical and biological parameters. Examples of suitable formulation types are:

emulsifiable concentrates which are prepared by dissolving the active compounds in an organic solvent, for example butanol, cyclohexanone, dimethylformamide, xylene or else relatively high-boiling hydrocarbons or mixtures of the organic solvents with addition of one or more ionic and/or nonionic surfactants (emulsifiers). Suitable emulsifiers are, for example, calcium alkylarylsulfonates, fatty acid polyglycol esters, alkyaryl polyglycol ethers, fatty alcohol polyglycol ethers, propylene oxide/ethylene oxide condensates, alkyl polyethers, sorbitan esters and polyoxyethylenesorbitan fatty acid esters;

dusts, which are obtained by binding the active compounds with finely dispersed inorganic or organic substances, for example talc, natural clays, such as kaolin, bentonite and pyrophyllite, diatomaceous earth or meals;

water- or oil-based suspension concentrates, which can be prepared, for example, by wet grinding using bead mills;

water-soluble powders;

water-soluble concentrates;

granules, such as water-soluble granules, water-dispersible granules and granules for application by broadcasting and soil application;

wettable powders which, in addition to active compound, also contain diluents or inert substances and surfactants;

capsule suspensions and microcapsules;

ultra-low-volume formulations.

The abovementioned formulation types are known to the person skilled in the art and described, for example, in: K. Martens, “Spray Drying Handbook”, 3rd Ed., G.

Goodwin Ltd., London, 1979; W. van Valkenburg, “Pesticide Formulations”, Marcel Dekker, N.Y. 1973; Winnaker-Kuchler, “Chemische Technologie” [Chemical Technology], volume 7, C. Hanser Verlag Munich, 4th edition 1986; “Perry's Chemical Engineer's Handbook”, 5th Ed., McGraw-Hill, N.Y. 1973, pages 8-57.

The formulation auxiliaries required, such as inert materials, surfactants, solvents and other additives are also known and are described, for example, in: McCutcheon's “Detergents and Emulsifiers Annual”, MC Publ. Corp., Ridgewood N.J.; C. Marsden, “Solvents Guide”, 2nd Ed., Interscience, N.Y. 1963; H. von Olphen, “Introduction to Clay Colloid Chemistry”, 2nd Ed., J. Wiley & Sons, N.Y.; Schbnfeldt, “Grenzflächenaktive Äthylenoxidaddukte” [Surface-active ethylene oxide adducts], Wiss. Verlagsgesellschaft, Stuttgart 1976; Sisley and Wood, “Encyclopedia of Surface Active Agents”, Chem. Publ. Co. Inc., N.Y. 1964; Watkins, “Handbook of Insecticide Dust Diluents and Carriers”, 2nd Ed., Darland Books, Caldwell N.J.; Winnacker-Küchler, “Chemische Technologie”, volume 7, C. Hanser Verlag Munich, 4th edition 1986.

In addition to the abovementioned formulation auxiliaries, the useful-plant-protecting compositions may comprise, if appropriate, customary tackifiers, wetting agents, dispersants, penetrants, emulsifiers, preservatives, antifreeze agents, fillers, carriers, colorants, anti-foams, evaporation inhibitors and pH or viscosity regulators.

Depending on the formulation type, the useful-plant-protecting compositions generally comprise 0.1 to 99% by weight, in particular 0.2 to 95% by weight, of one or more safeners of the formula I or a combination of safener and pesticide. Furthermore, they comprise 1 to 99.9, in particular 4 to 99.5, % by weight of one or more solid or liquid additives and 0 to 25, in particular 0.1 to 25, % by weight of a surfactant. In emulsifiable concentrates, the concentration of active compound, i.e. the concentration of safener and/or pesticide, is generally 1 to 90, in particular 5 to 80, % by weight. Dusts usually comprise 1 to 30, preferably 5 to 20, % by weight of active compound. In wettable powders, the concentration of active compound is generally 10 to 90% by weight. In water-dispersible granules, the content of active compound is, for example, between 1 and 95% by weight, preferably between 10 and 80% by weight.

For use, the formulations, which are present in commercially available form, are, if appropriate, diluted in a customary manner, for example in the case of wettable powders, emulsifiable concentrates, dispersions and water-dispersible granules, with water. Preparations in the form of dusts, granules and sprayable solutions are usually not diluted with any further inert substances prior to use. The required application rate of the safeners varies with the external conditions such as, inter alia, temperature, humidity and the type of herbicide used.

In the examples below, which illustrate the invention but do not limit it, the amounts are based on weight, unless defined otherwise.

### A) CHEMICAL EXAMPLES

### EXAMPLE 1

### Ethyl 3,4,5-triacetoxybenzoate

At 0° C., 1.00 g (0.0047 mol) of ethyl gallate is initially charged in 50 ml of dichloro-methane, and a spatula-tip of dimethylaminopyridine (DMAP) and then, dropwise, 20 ml of acetic anhydride are added. The reaction mixture is stirred at room temperature for 18 hours and then concentrated under reduced pressure, the residue is taken up in dichloromethane and the mixture is then washed with water and 5% strength sodium bicarbonate solution. Drying over magnesium sulfate and concentration using a rotary evaporator gives 1.43 g (90% of theory) of the desired product as an oil which, after a short while, solidifies to a crystalline mass. M.p. 76-78° C.

Examples of compounds of (I) according to the invention are compiled in the table below:

TABLE 1
Compounds of the formula (I)

| | |
|---|---|
| | (I) |
| 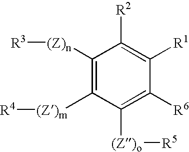 | |

| | | | | | | | Phys- |
|---|---|---|---|---|---|---|---|
| Comp. | | | | | | | ical |
| No. | R¹ | R² | R³(Z)ₙ | R⁴(Z′)ₘ | R⁵(Z″)ₒ | R⁶ | data |
| 1 | CO—OH | H | OH | H | H | H | |
| 2 | CO—OMe | H | OH | H | H | H | |
| 3 | CO—OEt | H | OH | H | H | H | |
| 4 | CO—O-n-Pr | H | OH | H | H | H | |
| 5 | CO—O-n-Bu | H | OH | H | H | H | |
| 6 | CO—O-c-Pr | H | OH | H | H | H | |
| 7 | CO—O— | H | OH | H | H | H | |
| | CH₂CH₂OH | | | | | | |
| 8 | CO—O—C₁₂H₂₅ | H | OH | H | H | H | |
| 9 | CO—O—C₁₆H₃₃ | H | OH | H | H | H | |
| 10 | CO—NH₂ | H | OH | H | H | H | |
| 11 | CO—NHMe | H | OH | H | H | H | |
| 12 | CO—NHEt | H | OH | H | H | H | |
| 13 | CO—NH-n-Pr | H | OH | H | H | H | |
| 14 | CO—NH-i-Pr | H | OH | H | H | H | |
| 15 | CO—NH-c-Pr | H | OH | H | H | H | |
| 16 | CO—NH-n-Pr | H | OH | H | H | H | |
| 17 | CO—NH-n-Bu | H | OH | H | H | H | |
| 18 | CO—NMe₂ | H | OH | H | H | H | |
| 19 | CO—NEt₂ | H | OH | H | H | H | |
| 20 | CO—NHNH₂ | H | OH | H | H | H | |
| 21 | CN | H | OH | H | H | H | |
| 22 | CO—OH | H | OAc | H | H | H | |
| 23 | CO—OMe | H | OAc | H | H | H | |
| 24 | CO—OEt | H | OAc | H | H | H | |
| 25 | CO—O-n-Pr | H | OAc | H | H | H | |
| 26 | CO—O-n-Bu | H | OAc | H | H | H | |
| 27 | CO—O-c-Pr | H | OAc | H | H | H | |
| 28 | CO—O— | H | OAc | H | H | H | |
| | CH₂CH₂OH | | | | | | |
| 29 | CO—O—C₁₂H₂₅ | H | OAc | H | H | H | |
| 30 | CO—O—C₁₆H₃₃ | H | OAc | H | H | H | |
| 31 | CO—NH₂ | H | OAc | H | H | H | |
| 32 | CO—NHMe | H | OAc | H | H | H | |
| 33 | CO—NHEt | H | OAc | H | H | H | |
| 34 | CO—NH-n-Pr | H | OAc | H | H | H | |
| 35 | CO—NH-i-Pr | H | OAc | H | H | H | |
| 36 | CO—NH-c-Pr | H | OAc | H | H | H | |
| 37 | CO—NH-n-Pr | H | OAc | H | H | H | |
| 38 | CO—NH-n-Bu | H | OAc | H | H | H | |
| 39 | CO—NMe₂ | H | OAc | H | H | H | |
| 40 | CO—NEt₂ | H | OAc | H | H | H | |
| 41 | CO—NHNH₂ | H | OAc | H | H | H | |
| 42 | CN | H | OAc | H | H | H | |
| 43 | CO—OH | H | OH | Me | H | H | |
| 44 | CO—OMe | H | OH | Me | H | H | |
| 45 | CO—OEt | H | OH | Me | H | H | |
| 46 | CO—O-n-Pr | H | OH | Me | H | H | |
| 47 | CO—O-n-Bu | H | OH | Me | H | H | |
| 48 | CO—O-c-Pr | H | OH | Me | H | H | |
| 49 | CO—O— | H | OH | Me | H | H | |
| | CH₂CH₂OH | | | | | | |
| 50 | CO—O—C₁₂H₂₅ | H | OH | Me | H | H | |
| 51 | CO—O—C₁₆H₃₃ | H | OH | Me | H | H | |
| 52 | CO—NH₂ | H | OH | Me | H | H | |
| 53 | CO—NHMe | H | OH | Me | H | H | |
| 54 | CO—NHEt | H | OH | Me | H | H | |
| 55 | CO—NH-n-Pr | H | OH | Me | H | H | |
| 56 | CO—NH-i-Pr | H | OH | Me | H | H | |
| 57 | CO—NH-c-Pr | H | OH | Me | H | H | |
| 58 | CO—NH-n-Pr | H | OH | Me | H | H | |
| 59 | CO—NH-n-Bu | H | OH | Me | H | H | |
| 60 | CO—NMe₂ | H | OH | Me | H | H | |
| 61 | CO—NEt₂ | H | OH | Me | H | H | |
| 62 | CO—NHNH₂ | H | OH | Me | H | H | |
| 63 | CN | H | OH | Me | H | H | |
| 64 | CO—OH | H | OAc | Me | H | H | |
| 65 | CO—OMe | H | OAc | Me | H | H | |
| 66 | CO—OEt | H | OAc | Me | H | H | |
| 67 | CO—O-n-Pr | H | OAc | Me | H | H | |
| 68 | CO—O-n-Bu | H | OAc | Me | H | H | |
| 69 | CO—O-c-Pr | H | OAc | Me | H | H | |
| 70 | CO—O— | H | OAc | Me | H | H | |
| | CH₂CH₂OH | | | | | | |
| 71 | CO—O—C₁₂H₂₅ | H | OAc | Me | H | H | |
| 72 | CO—O—C₁₆H₃₃ | H | OAc | Me | H | H | |
| 73 | CO—NH₂ | H | OAc | Me | H | H | |
| 74 | CO—NHMe | H | OAc | Me | H | H | |
| 75 | CO—NHEt | H | OAc | Me | H | H | |
| 76 | CO—NH-n-Pr | H | OAc | Me | H | H | |
| 77 | CO—NH-i-Pr | H | OAc | Me | H | H | |
| 78 | CO—NH-c-Pr | H | OAc | Me | H | H | |
| 79 | CO—NH-n-Pr | H | OAc | Me | H | H | |
| 80 | CO—NH-n-Bu | H | OAc | Me | H | H | |
| 81 | CO—NMe₂ | H | OAc | Me | H | H | |
| 82 | CO—NEt₂ | H | OAc | Me | H | H | |
| 83 | CO—NHNH₂ | H | OAc | Me | H | H | |
| 84 | CN | H | OAc | Me | H | H | |
| 85 | CO—OH | H | OH | H | Me | H | |
| 86 | CO—OMe | H | OH | H | Me | H | |
| 87 | CO—OEt | H | OH | H | Me | H | |
| 88 | CO—O-n-Pr | H | OH | H | Me | H | |
| 89 | CO—O-n-Bu | H | OH | H | Me | H | |
| 90 | CO—O-c-Pr | H | OH | H | Me | H | |
| 91 | CO—O— | H | OH | H | Me | H | |
| | CH₂CH₂OH | | | | | | |
| 92 | CO—O—C₁₂H₂₅ | H | OH | H | Me | H | |
| 93 | CO—O—C₁₆H₃₃ | H | OH | H | Me | H | |
| 94 | CO—NH₂ | H | OH | H | Me | H | |
| 95 | CO—NHMe | H | OH | H | Me | H | |
| 96 | CO—NHEt | H | OH | H | Me | H | |
| 97 | CO—NH-n-Pr | H | OH | H | Me | H | |
| 98 | CO—NH-i-Pr | H | OH | H | Me | H | |
| 99 | CO—NH-c-Pr | H | OH | H | Me | H | |
| 100 | CO—NH-n-Pr | H | OH | H | Me | H | |
| 101 | CO—NH-n-Bu | H | OH | H | Me | H | |
| 102 | CO—NMe₂ | H | OH | H | Me | H | |
| 103 | CO—NEt₂ | H | OH | H | Me | H | |
| 104 | CO—NHNH₂ | H | OH | H | Me | H | |
| 105 | CN | H | OH | H | Me | H | |
| 106 | CO—OH | H | OAc | H | Me | H | |
| 107 | CO—OMe | H | OAc | H | Me | H | |
| 108 | CO—OEt | H | OAc | H | Me | H | |
| 109 | CO—O-n-Pr | H | OAc | H | Me | H | |
| 110 | CO—O-n-Bu | H | OAc | H | Me | H | |
| 111 | CO—O-c-Pr | H | OAc | H | Me | H | |
| 112 | CO—O— | H | OAc | H | Me | H | |
| | CH₂CH₂OH | | | | | | |
| 113 | CO—O—C₁₂H₂₅ | H | OAc | H | Me | H | |
| 114 | CO—O—C₁₆H₃₃ | H | OAc | H | Me | H | |
| 115 | CO—NH₂ | H | OAc | H | Me | H | |
| 116 | CO—NHMe | H | OAc | H | Me | H | |
| 117 | CO—NHEt | H | OAc | H | Me | H | |
| 118 | CO—NH-n-Pr | H | OAc | H | Me | H | |
| 119 | CO—NH-i-Pr | H | OAc | H | Me | H | |
| 120 | CO—NH-c-Pr | H | OAc | H | Me | H | |
| 121 | CO—NH-n-Pr | H | OAc | H | Me | H | |
| 122 | CO—NH-n-Bu | H | OAc | H | Me | H | |
| 123 | CO—NMe₂ | H | OAc | H | Me | H | |
| 124 | CO—NEt₂ | H | OAc | H | Me | H | |
| 125 | CO—NHNH₂ | H | OAc | H | Me | H | |
| 126 | CN | H | OAc | H | Me | H | |
| 127 | CO—OH | H | OH | H | H | Me | |
| 128 | CO—OMe | H | OH | H | H | Me | |
| 129 | CO—OEt | H | OH | H | H | Me | |
| 130 | CO—O-n-Pr | H | OH | H | H | Me | |
| 131 | CO—O-n-Bu | H | OH | H | H | Me | |
| 132 | CO—O-c-Pr | H | OH | H | H | Me | |
| 133 | CO—O— | H | OH | H | H | Me | |
| | CH₂CH₂OH | | | | | | |
| 134 | CO—O—C₁₂H₂₅ | H | OH | H | H | Me | |
| 135 | CO—O—C₁₆H₃₃ | H | OH | H | H | Me | |
| 136 | CO—NH₂ | H | OH | H | H | Me | |
| 137 | CO—NHMe | H | OH | H | H | Me | |
| 138 | CO—NHEt | H | OH | H | H | Me | |
| 139 | CO—NH-n-Pr | H | OH | H | H | Me | |
| 140 | CO—NH-i-Pr | H | OH | H | H | Me | |
| 141 | CO—NH-c-Pr | H | OH | H | H | Me | |
| 142 | CO—NH-n-Pr | H | OH | H | H | Me | |
| 143 | CO—NH-n-Bu | H | OH | H | H | Me | |
| 144 | CO—NMe₂ | H | OH | H | H | Me | |
| 145 | CO—NEt₂ | H | OH | H | H | Me | |
| 146 | CO—NHNH₂ | H | OH | H | H | Me | |
| 147 | CN | H | OH | H | H | Me | |
| 148 | CO—OH | H | OAc | H | H | Me | |
| 149 | CO—OMe | H | OAc | H | H | Me | |
| 150 | CO—OEt | H | OAc | H | H | Me | |
| 151 | CO—O-n-Pr | H | OAc | H | H | Me | |
| 152 | CO—O-n-Bu | H | OAc | H | H | Me | |
| 153 | CO—O-c-Pr | H | OAc | H | H | Me | |
| 154 | CO—O— | H | OAc | H | H | Me | |
| | CH₂CH₂OH | | | | | | |
| 155 | CO—O—C₁₂H₂₅ | H | OAc | H | H | Me | |
| 156 | CO—O—C₁₆H₃₃ | H | OAc | H | H | Me | |
| 157 | CO—NH₂ | H | OAc | H | H | Me | |
| 158 | CO—NHMe | H | OAc | H | H | Me | |
| 159 | CO—NHEt | H | OAc | H | H | Me | |
| 160 | CO—NH-n-Pr | H | OAc | H | H | Me | |
| 161 | CO—NH-i-Pr | H | OAc | H | H | Me | |
| 162 | CO—NH-c-Pr | H | OAc | H | H | Me | |
| 163 | CO—NH-n-Pr | H | OAc | H | H | Me | |
| 164 | CO—NH-n-Bu | H | OAc | H | H | Me | |
| 165 | CO—NMe₂ | H | OAc | H | H | Me | |
| 166 | CO—NEt₂ | H | OAc | H | H | Me | |
| 167 | CO—NHNH₂ | H | OAc | H | H | Me | |
| 168 | CN | H | OAc | H | H | Me | |
| 169 | CO—OH | Me | OH | H | H | H | |
| 170 | CO—OMe | Me | OH | H | H | H | |
| 171 | CO—OEt | Me | OH | H | H | H | |
| 172 | CO—O-n-Pr | Me | OH | H | H | H | |
| 173 | CO—O-n-Bu | Me | OH | H | H | H | |
| 174 | CO—O-c-Pr | Me | OH | H | H | H | |
| 175 | CO—O— | Me | OH | H | H | H | |
| | CH₂CH₂OH | | | | | | |
| 176 | CO—O—C₁₂H₂₅ | Me | OH | H | H | H | |
| 177 | CO—O—C₁₆H₃₃ | Me | OH | H | H | H | |
| 178 | CO—NH₂ | Me | OH | H | H | H | |
| 179 | CO—NHMe | Me | OH | H | H | H | |
| 180 | CO—NHEt | Me | OH | H | H | H | |
| 181 | CO—NH-n-Pr | Me | OH | H | H | H | |
| 182 | CO—NH-i-Pr | Me | OH | H | H | H | |
| 183 | CO—NH-c-Pr | Me | OH | H | H | H | |
| 184 | CO—NH-n-Pr | Me | OH | H | H | H | |
| 185 | CO—NH-n-Bu | Me | OH | H | H | H | |
| 186 | CO—NMe₂ | Me | OH | H | H | H | |
| 187 | CO—NEt₂ | Me | OH | H | H | H | |
| 188 | CO—NHNH₂ | Me | OH | H | H | H | |
| 189 | CN | Me | OH | H | H | H | |
| 190 | CO—OH | Me | OAc | H | H | H | |
| 191 | CO—OMe | Me | OAc | H | H | H | |
| 192 | CO—OEt | Me | OAc | H | H | H | |
| 193 | CO—O-n-Pr | Me | OAc | H | H | H | |
| 194 | CO—O-n-Bu | Me | OAc | H | H | H | |
| 195 | CO—O-c-Pr | Me | OAc | H | H | H | |
| 196 | CO—O— | Me | OAc | H | H | H | |
| | CH₂CH₂OH | | | | | | |
| 197 | CO—O—C₁₂H₂₅ | Me | OAc | H | H | H | |
| 198 | CO—O—C₁₆H₃₃ | Me | OAc | H | H | H | |
| 199 | CO—NH₂ | Me | OAc | H | H | H | |
| 200 | CO—NHMe | Me | OAc | H | H | H | |
| 201 | CO—NHEt | Me | OAc | H | H | H | |
| 202 | CO—NH-n-Pr | Me | OAc | H | H | H | |
| 203 | CO—NH-i-Pr | Me | OAc | H | H | H | |
| 204 | CO—NH-c-Pr | Me | OAc | H | H | H | |
| 205 | CO—NH-n-Pr | Me | OAc | H | H | H | |
| 206 | CO—NH-n-Bu | Me | OAc | H | H | H | |
| 207 | CO—NMe₂ | Me | OAc | H | H | H | |
| 208 | CO—NEt₂ | Me | OAc | H | H | H | |
| 209 | CO—NHNH₂ | Me | OAc | H | H | H | |
| 210 | CN | Me | OAc | H | H | H | |
| 211 | CO—OH | H | H | OH | H | H | |
| 212 | CO—OMe | H | H | OH | H | H | |
| 213 | CO—OEt | H | H | OH | H | H | |
| 214 | CO—O-n-Pr | H | H | OH | H | H | |
| 215 | CO—O-n-Bu | H | H | OH | H | H | |
| 216 | CO—O-c-Pr | H | H | OH | H | H | |
| 217 | CO—O— | H | H | OH | H | H | |
| | CH₂CH₂OH | | | | | | |
| 218 | CO—O—C₁₂H₂₅ | H | H | OH | H | H | |
| 219 | CO—O—C₁₆H₃₃ | H | H | OH | H | H | |
| 220 | CO—NH₂ | H | H | OH | H | H | |
| 221 | CO—NHMe | H | H | OH | H | H | |
| 222 | CO—NHEt | H | H | OH | H | H | |
| 223 | CO—NH-n-Pr | H | H | OH | H | H | |
| 224 | CO—NH-i-Pr | H | H | OH | H | H | |
| 225 | CO—NH-c-Pr | H | H | OH | H | H | |
| 226 | CO—NH-n-Pr | H | H | OH | H | H | |
| 227 | CO—NH-n-Bu | H | H | OH | H | H | |
| 228 | CO—NMe₂ | H | H | OH | H | H | |
| 229 | CO—NEt₂ | H | H | OH | H | H | |
| 230 | CO—NHNH₂ | H | H | OH | H | H | |
| 231 | CN | H | H | OH | H | H | |
| 232 | CO—OH | H | H | OAc | H | H | |
| 233 | CO—OMe | H | H | OAc | H | H | |
| 234 | CO—OEt | H | H | OAc | H | H | |
| 235 | CO—O-n-Pr | H | H | OAc | H | H | |
| 236 | CO—O-n-Bu | H | H | OAc | H | H | |
| 237 | CO—O-c-Pr | H | H | OAc | H | H | |
| 238 | CO—O— | H | H | OAc | H | H | |
| | CH₂CH₂OH | | | | | | |
| 239 | CO—O—C₁₂H₂₅ | H | H | OAc | H | H | |
| 240 | CO—O—C₁₆H₃₃ | H | H | OAc | H | H | |
| 241 | CO—NH₂ | H | H | OAc | H | H | |
| 242 | CO—NHMe | H | H | OAc | H | H | |
| 243 | CO—NHEt | H | H | OAc | H | H | |
| 244 | CO—NH-n-Pr | H | H | OAc | H | H | |
| 245 | CO—NH-i-Pr | H | H | OAc | H | H | |
| 246 | CO—NH-c-Pr | H | H | OAc | H | H | |
| 247 | CO—NH-n-Pr | H | H | OAc | H | H | |
| 248 | CO—NH-n-Bu | H | H | OAc | H | H | |
| 249 | CO—NMe₂ | H | H | OAc | H | H | |
| 250 | CO—NEt₂ | H | H | OAc | H | H | |
| 251 | CO—NHNH₂ | H | H | OAc | H | H | |
| 252 | CN | H | H | OAc | H | H | |
| 253 | CO—OH | Me | H | OH | H | H | |
| 254 | CO—OMe | Me | H | OH | H | H | |
| 255 | CO—OEt | Me | H | OH | H | H | |
| 256 | CO—O-n-Pr | Me | H | OH | H | H | |
| 257 | CO—O-n-Bu | Me | H | OH | H | H | |
| 258 | CO—O-c-Pr | Me | H | OH | H | H | |
| 259 | CO—O— | Me | H | OH | H | H | |
| | CH₂CH₂OH | | | | | | |
| 260 | CO—O—C₁₂H₂₅ | Me | H | OH | H | H | |
| 261 | CO—O—C₁₆H₃₃ | Me | H | OH | H | H | |
| 262 | CO—NH₂ | Me | H | OH | H | H | |
| 263 | CO—NHMe | Me | H | OH | H | H | |
| 264 | CO—NHEt | Me | H | OH | H | H | |
| 265 | CO—NH-n-Pr | Me | H | OH | H | H | |
| 266 | CO—NH-i-Pr | Me | H | OH | H | H | |
| 267 | CO—NH-c-Pr | Me | H | OH | H | H | |
| 268 | CO—NH-n-Pr | Me | H | OH | H | H | |
| 269 | CO—NH-n-Bu | Me | H | OH | H | H | |
| 270 | CO—NMe₂ | Me | H | OH | H | H | |
| 271 | CO—NEt₂ | Me | H | OH | H | H | |
| 272 | CO—NHNH₂ | Me | H | OH | H | H | |
| 273 | CN | Me | H | OH | H | H | |
| 274 | CO—OH | Me | H | OAc | H | H | |
| 275 | CO—OMe | Me | H | OAc | H | H | |
| 276 | CO—OEt | Me | H | OAc | H | H | |
| 277 | CO—O-n-Pr | Me | H | OAc | H | H | |
| 278 | CO—O-n-Bu | Me | H | OAc | H | H | |
| 279 | CO—O-c-Pr | Me | H | OAc | H | H | |
| 280 | CO—O— | Me | H | OAc | H | H | |
| | CH₂CH₂OH | | | | | | |
| 281 | CO—O—C₁₂H₂₅ | Me | H | OAc | H | H | |
| 282 | CO—O—C₁₆H₃₃ | Me | H | OAc | H | H | |
| 283 | CO—NH₂ | Me | H | OAc | H | H | |
| 284 | CO—NHMe | Me | H | OAc | H | H | |
| 285 | CO—NHEt | Me | H | OAc | H | H | |
| 286 | CO—NH-n-Pr | Me | H | OAc | H | H | |
| 287 | CO—NH-i-Pr | Me | H | OAc | H | H | |
| 288 | CO—NH-c-Pr | Me | H | OAc | H | H | |
| 289 | CO—NH-n-Pr | Me | H | OAc | H | H | |
| 290 | CO—NH-n-Bu | Me | H | OAc | H | H | |
| 291 | CO—NMe₂ | Me | H | OAc | H | H | |
| 292 | CO—NEt₂ | Me | H | OAc | H | H | |
| 293 | CO—NHNH₂ | Me | H | OAc | H | H | |
| 294 | CN | Me | H | OAc | H | H | |
| 295 | CO—OH | H | H | OH | Me | H | |
| 296 | CO—OMe | H | H | OH | Me | H | |
| 297 | CO—OEt | H | H | OH | Me | H | |
| 298 | CO—O-n-Pr | H | H | OH | Me | H | |
| 299 | CO—O-n-Bu | H | H | OH | Me | H | |
| 300 | CO—O-c-Pr | H | H | OH | Me | H | |
| 301 | CO—O— | H | H | OH | Me | H | |
| | CH₂CH₂OH | | | | | | |
| 302 | CO—O—C₁₂H₂₅ | H | H | OH | Me | H | |
| 303 | CO—O—C₁₆H₃₃ | H | H | OH | Me | H | |
| 304 | CO—NH₂ | H | H | OH | Me | H | |
| 305 | CO—NHMe | H | H | OH | Me | H | |
| 306 | CO—NHEt | H | H | OH | Me | H | |
| 307 | CO—NH-n-Pr | H | H | OH | Me | H | |
| 308 | CO—NH-i-Pr | H | H | OH | Me | H | |
| 309 | CO—NH-c-Pr | H | H | OH | Me | H | |
| 310 | CO—NH-n-Pr | H | H | OH | Me | H | |
| 311 | CO—NH-n-Bu | H | H | OH | Me | H | |
| 312 | CO—NMe₂ | H | H | OH | Me | H | |
| 313 | CO—NEt₂ | H | H | OH | Me | H | |
| 314 | CO—NHNH₂ | H | H | OH | Me | H | |
| 315 | CN | H | H | OH | Me | H | |
| 316 | CO—OH | H | H | OAc | Me | H | |
| 317 | CO—OMe | H | H | OAc | Me | H | |
| 318 | CO—OEt | H | H | OAc | Me | H | |
| 319 | CO—O-n-Pr | H | H | OAc | Me | H | |
| 320 | CO—O-n-Bu | H | H | OAc | Me | H | |
| 321 | CO—O-c-Pr | H | H | OAc | Me | H | |
| 322 | CO—O— | H | H | OAc | Me | H | |
| | CH₂CH₂OH | | | | | | |
| 323 | CO—O—C₁₂H₂₅ | H | H | OAc | Me | H | |
| 324 | CO—O—C₁₆H₃₃ | H | H | OAc | Me | H | |
| 325 | CO—NH₂ | H | H | OAc | Me | H | |
| 326 | CO—NHMe | H | H | OAc | Me | H | |
| 327 | CO—NHEt | H | H | OAc | Me | H | |
| 328 | CO—NH-n-Pr | H | H | OAc | Me | H | |
| 329 | CO—NH-i-Pr | H | H | OAc | Me | H | |
| 330 | CO—NH-c-Pr | H | H | OAc | Me | H | |
| 331 | CO—NH-n-Pr | H | H | OAc | Me | H | |
| 332 | CO—NH-n-Bu | H | H | OAc | Me | H | |
| 333 | CO—NMe₂ | H | H | OAc | Me | H | |
| 334 | CO—NEt₂ | H | H | OAc | Me | H | |
| 335 | CO—NHNH₂ | H | H | OAc | Me | H | |
| 336 | CN | H | H | OAc | Me | H | |
| 337 | CO—OH | Me | H | OH | H | Me | |
| 338 | CO—OMe | Me | H | OH | H | Me | |
| 339 | CO—OEt | Me | H | OH | H | Me | |
| 340 | CO—O-n-Pr | Me | H | OH | H | Me | |
| 341 | CO—O-n-Bu | Me | H | OH | H | Me | |
| 342 | CO—O-c-Pr | Me | H | OH | H | Me | |
| 343 | CO—O— | Me | H | OH | H | Me | |
| | CH₂CH₂OH | | | | | | |
| 344 | CO—O—C₁₂H₂₅ | Me | H | OH | H | Me | |
| 345 | CO—O—C₁₆H₃₃ | Me | H | OH | H | Me | |
| 346 | CO—NH₂ | Me | H | OH | H | Me | |
| 347 | CO—NHMe | Me | H | OH | H | Me | |
| 348 | CO—NHEt | Me | H | OH | H | Me | |
| 349 | CO—NH-n-Pr | Me | H | OH | H | Me | |
| 350 | CO—NH-i-Pr | Me | H | OH | H | Me | |
| 351 | CO—NH-c-Pr | Me | H | OH | H | Me | |
| 352 | CO—NH-n-Pr | Me | H | OH | H | Me | |
| 353 | CO—NH-n-Bu | Me | H | OH | H | Me | |
| 354 | CO—NMe₂ | Me | H | OH | H | Me | |
| 355 | CO—NEt₂ | Me | H | OH | H | Me | |
| 356 | CO—NHNH₂ | Me | H | OH | H | Me | |
| 357 | CN | Me | H | OH | H | Me | |
| 358 | CO—OH | Me | H | OAc | H | Me | |
| 359 | CO—OMe | Me | H | OAc | H | Me | |
| 360 | CO—OEt | Me | H | OAc | H | Me | |
| 361 | CO—O-n-Pr | Me | H | OAc | H | Me | |
| 362 | CO—O-n-Bu | Me | H | OAc | H | Me | |
| 363 | CO—O-c-Pr | Me | H | OAc | H | Me | |
| 364 | CO—O— | Me | H | OAc | H | Me | |
| | CH₂CH₂OH | | | | | | |
| 365 | CO—O—C₁₂H₂₅ | Me | H | OAc | H | Me | |
| 366 | CO—O—C₁₆H₃₃ | Me | H | OAc | H | Me | |
| 367 | CO—NH₂ | Me | H | OAc | H | Me | |
| 368 | CO—NHMe | Me | H | OAc | H | Me | |
| 369 | CO—NHEt | Me | H | OAc | H | Me | |
| 370 | CO—NH-n-Pr | Me | H | OAc | H | Me | |
| 371 | CO—NH-i-Pr | Me | H | OAc | H | Me | |
| 372 | CO—NH-c-Pr | Me | H | OAc | H | Me | |
| 373 | CO—NH-n-Pr | Me | H | OAc | H | Me | |
| 374 | CO—NH-n-Bu | Me | H | OAc | H | Me | |
| 375 | CO—NMe₂ | Me | H | OAc | H | Me | |
| 376 | CO—NEt₂ | Me | H | OAc | H | Me | |
| 377 | CO—NHNH₂ | Me | H | OAc | H | Me | |
| 378 | CN | Me | H | OAc | H | Me | |
| 379 | CO—OH | H | Me | OH | H | Me | |
| 380 | CO—OMe | H | Me | OH | H | Me | |
| 381 | CO—OEt | H | Me | OH | H | Me | |
| 382 | CO—O-n-Pr | H | Me | OH | H | Me | |
| 383 | CO—O-n-Bu | H | Me | OH | H | Me | |
| 384 | CO—O-c-Pr | H | Me | OH | H | Me | |
| 385 | CO—O— | H | Me | OH | H | Me | |
| | CH₂CH₂OH | | | | | | |
| 386 | CO—O—C₁₂H₂₅ | H | Me | OH | H | Me | |
| 387 | CO—O—C₁₆H₃₃ | H | Me | OH | H | Me | |
| 388 | CO—NH₂ | H | Me | OH | H | Me | |
| 389 | CO—NHMe | H | Me | OH | H | Me | |
| 390 | CO—NHEt | H | Me | OH | H | Me | |
| 391 | CO—NH-n-Pr | H | Me | OH | H | Me | |
| 392 | CO—NH-i-Pr | H | Me | OH | H | Me | |
| 393 | CO—NH-c-Pr | H | Me | OH | H | Me | |
| 394 | CO—NH-n-Pr | H | Me | OH | H | Me | |
| 395 | CO—NH-n-Bu | H | Me | OH | H | Me | |
| 396 | CO—NMe₂ | H | Me | OH | H | Me | |
| 397 | CO—NEt₂ | H | Me | OH | H | Me | |
| 398 | CO—NHNH₂ | H | Me | OH | H | Me | |
| 399 | CO—OH | H | Me | OAc | H | Me | |
| 400 | CO—OMe | H | Me | OAc | H | Me | |
| 401 | CO—OEt | H | Me | OAc | H | Me | |
| 402 | CO—O-n-Pr | H | Me | OAc | H | Me | |
| 403 | CO—O-n-Bu | H | Me | OAc | H | Me | |
| 404 | CO—O-c-Pr | H | Me | OAc | H | Me | |
| 405 | CO—O— | H | Me | OAc | H | Me | |
| | CH₂CH₂OH | | | | | | |
| 406 | CO—O—C₁₂H₂₅ | H | Me | OAc | H | Me | |
| 407 | CO—O—C₁₆H₃₃ | H | Me | OAc | H | Me | |
| 408 | CO—NH₂ | H | Me | OAc | H | Me | |
| 409 | CO—NHMe | H | Me | OAc | H | Me | |
| 410 | CO—NHEt | H | Me | OAc | H | Me | |
| 411 | CO—NH-n-Pr | H | Me | OAc | H | Me | |
| 412 | CO—NH-i-Pr | H | Me | OAc | H | Me | |
| 413 | CO—NH-c-Pr | H | Me | OAc | H | Me | |
| 414 | CO—NH-n-Pr | H | Me | OAc | H | Me | |
| 415 | CO—NH-n-Bu | H | Me | OAc | H | Me | |
| 416 | CO—NMe₂ | H | Me | OAc | H | Me | |
| 417 | CO—NEt₂ | H | Me | OAc | H | Me | |
| 418 | CO—NHNH₂ | H | Me | OAc | H | Me | |
| 419 | CN | H | Me | OAc | H | Me | |
| 420 | CO—OH | Me | Me | OH | H | H | |
| 421 | CO—OMe | Me | Me | OH | H | H | |
| 422 | CO—OEt | Me | Me | OH | H | H | |
| 423 | CO—O-n-Pr | Me | Me | OH | H | H | |
| 424 | CO—O-n-Bu | Me | Me | OH | H | H | |
| 425 | CO—O-c-Pr | Me | Me | OH | H | H | |
| 426 | CO—O— | Me | Me | OH | H | H | |
| | CH₂CH₂OH | | | | | | |
| 427 | CO—O—C₁₂H₂₅ | Me | Me | OH | H | H | |
| 428 | CO—O—C₁₆H₃₃ | Me | Me | OH | H | H | |
| 429 | CO—NH₂ | Me | Me | OH | H | H | |
| 430 | CO—NHMe | Me | Me | OH | H | H | |
| 431 | CO—NHEt | Me | Me | OH | H | H | |
| 432 | CO—NH-n-Pr | Me | Me | OH | H | H | |
| 433 | CO—NH-i-Pr | Me | Me | OH | H | H | |
| 434 | CO—NH-c-Pr | Me | Me | OH | H | H | |
| 435 | CO—NH-n-Pr | Me | Me | OH | H | H | |
| 436 | CO—NH-n-Bu | Me | Me | OH | H | H | |
| 437 | CO—NMe₂ | Me | Me | OH | H | H | |
| 438 | CO—NEt₂ | Me | Me | OH | H | H | |
| 439 | CO—NHNH₂ | Me | Me | OH | H | H | |
| 440 | CN | Me | Me | OH | H | H | |
| 441 | CO—OH | Me | Me | OAc | H | H | |
| 442 | CO—OMe | Me | Me | OAc | H | H | |
| 443 | CO—OEt | Me | Me | OAc | H | H | |
| 444 | CO—O-n-Pr | Me | Me | OAc | H | H | |
| 445 | CO—O-n-Bu | Me | Me | OAc | H | H | |
| 446 | CO—O-c-Pr | Me | Me | OAc | H | H | |
| 447 | CO—O— | Me | Me | OAc | H | H | |
| | CH₂CH₂OH | | | | | | |
| 448 | CO—O—C₁₂H₂₅ | Me | Me | OAc | H | H | |
| 449 | CO—O—C₁₆H₃₃ | Me | Me | OAc | H | H | |
| 450 | CO—NH₂ | Me | Me | OAc | H | H | |
| 451 | CO—NHMe | Me | Me | OAc | H | H | |
| 452 | CO—NHEt | Me | Me | OAc | H | H | |
| 453 | CO—NH-n-Pr | Me | Me | OAc | H | H | |
| 454 | CO—NH-i-Pr | Me | Me | OAc | H | H | |
| 455 | CO—NH-c-Pr | Me | Me | OAc | H | H | |
| 456 | CO—NH-n-Pr | Me | Me | OAc | H | H | |
| 457 | CO—NH-n-Bu | Me | Me | OAc | H | H | |
| 458 | CO—NMe₂ | Me | Me | OAc | H | H | |
| 459 | CO—NEt₂ | Me | Me | OAc | H | H | |
| 460 | CO—NHNH₂ | Me | Me | OAc | H | H | |
| 461 | CN | Me | Me | OAc | H | H | |
| 462 | CO—OH | H | Me | OH | Me | H | |
| 463 | CO—OMe | H | Me | OH | Me | H | |
| 464 | CO—OEt | H | Me | OH | Me | H | |
| 465 | CO—O-n-Pr | H | Me | OH | Me | H | |
| 466 | CO—O-n-Bu | H | Me | OH | Me | H | |
| 467 | CO—O-c-Pr | H | Me | OH | Me | H | |
| 468 | CO—O— | H | Me | OH | Me | H | |
| | CH₂CH₂OH | | | | | | |
| 469 | CO—O—C₁₂H₂₅ | H | Me | OH | Me | H | |
| 470 | CO—O—C₁₆H₃₃ | H | Me | OH | Me | H | |
| 471 | CO—NH₂ | H | Me | OH | Me | H | |
| 472 | CO—NHMe | H | Me | OH | Me | H | |
| 473 | CO—NHEt | H | Me | OH | Me | H | |
| 474 | CO—NH-n-Pr | H | Me | OH | Me | H | |
| 475 | CO—NH-i-Pr | H | Me | OH | Me | H | |
| 476 | CO—NH-c-Pr | H | Me | OH | Me | H | |
| 477 | CO—NH-n-Pr | H | Me | OH | Me | H | |
| 478 | CO—NH-n-Bu | H | Me | OH | Me | H | |
| 479 | CO—NMe₂ | H | Me | OH | Me | H | |
| 480 | CO—NEt₂ | H | Me | OH | Me | H | |
| 481 | CO—NHNH₂ | H | Me | OH | Me | H | |
| 482 | CN | H | Me | OH | Me | H | |
| 483 | CO—OH | H | Me | OAc | Me | H | |
| 484 | CO—OMe | H | Me | OAc | Me | H | |
| 485 | CO—OEt | H | Me | OAc | Me | H | |
| 486 | CO—O-n-Pr | H | Me | OAc | Me | H | |
| 487 | CO—O-n-Bu | H | Me | OAc | Me | H | |
| 488 | CO—O-c-Pr | H | Me | OAc | Me | H | |
| 489 | CO—O— | H | Me | OAc | Me | H | |
| | CH₂CH₂OH | | | | | | |
| 490 | CO—O—C₁₂H₂₅ | H | Me | OAc | Me | H | |
| 491 | CO—O—C₁₆H₃₃ | H | Me | OAc | Me | H | |
| 492 | CO—NH₂ | H | Me | OAc | Me | H | |
| 493 | CO—NHMe | H | Me | OAc | Me | H | |
| 494 | CO—NHEt | H | Me | OAc | Me | H | |
| 495 | CO—NH-n-Pr | H | Me | OAc | Me | H | |
| 496 | CO—NH-i-Pr | H | Me | OAc | Me | H | |
| 497 | CO—NH-c-Pr | H | Me | OAc | Me | H | |
| 498 | CO—NH-n-Pr | H | Me | OAc | Me | H | |
| 499 | CO—NH-n-Bu | H | Me | OAc | Me | H | |
| 500 | CO—NMe₂ | H | Me | OAc | Me | H | |
| 501 | CO—NEt₂ | H | Me | OAc | Me | H | |
| 502 | CO—NHNH₂ | H | Me | OAc | Me | H | |
| 503 | CN | H | Me | OAc | Me | H | |
| 504 | CO—OH | H | OH | OH | H | H | |
| 505 | CO—OMe | H | OH | OH | H | H | |
| 506 | CO—OEt | H | OH | OH | H | H | |
| 507 | CO—O-n-Pr | H | OH | OH | H | H | |
| 508 | CO—O-n-Bu | H | OH | OH | H | H | |
| 509 | CO—O-c-Pr | H | OH | OH | H | H | |
| 510 | CO—O— | H | OH | OH | H | H | |
| | CH₂CH₂OH | | | | | | |
| 511 | CO—O—C₁₂H₂₅ | H | OH | OH | H | H | |
| 512 | CO—O—C₁₆H₃₃ | H | OH | OH | H | H | |
| 513 | CO—NH₂ | H | OH | OH | H | H | |
| 514 | CO—NHMe | H | OH | OH | H | H | |
| 515 | CO—NHEt | H | OH | OH | H | H | |
| 516 | CO—NH-n-Pr | H | OH | OH | H | H | |
| 517 | CO—NH-i-Pr | H | OH | OH | H | H | |
| 518 | CO—NH-c-Pr | H | OH | OH | H | H | |
| 519 | CO—NH-n-Pr | H | OH | OH | H | H | |
| 520 | CO—NH-n-Bu | H | OH | OH | H | H | |
| 521 | CO—NMe₂ | H | OH | OH | H | H | |
| 522 | CO—NEt₂ | H | OH | OH | H | H | |
| 523 | CO—NHNH₂ | H | OH | OH | H | H | |
| 524 | CN | H | OH | OH | H | H | |
| 525 | CO—OH | H | OAc | OH | H | H | |
| 526 | CO—OMe | H | OAc | OH | H | H | |
| 527 | CO—OEt | H | OAc | OH | H | H | |
| 528 | CO—O-n-Pr | H | OAc | OH | H | H | |
| 529 | CO—O-n-Bu | H | OAc | OH | H | H | |
| 530 | CO—O-c-Pr | H | OAc | OH | H | H | |
| 531 | CO—O— | H | OAc | OH | H | H | |
| | CH₂CH₂OH | | | | | | |
| 532 | CO—O—C₁₂H₂₅ | H | OAc | OH | H | H | |
| 533 | CO—O—C₁₆H₃₃ | H | OAc | OH | H | H | |
| 534 | CO—NH₂ | H | OAc | OH | H | H | |
| 535 | CO—NHMe | H | OAc | OH | H | H | |
| 536 | CO—NHEt | H | OAc | OH | H | H | |
| 537 | CO—NH-n-Pr | H | OAc | OH | H | H | |
| 538 | CO—NH-i-Pr | H | OAc | OH | H | H | |
| 539 | CO—NH-c-Pr | H | OAc | OH | H | H | |
| 540 | CO—NH-n-Pr | H | OAc | OH | H | H | |
| 541 | CO—NH-n-Bu | H | OAc | OH | H | H | |
| 542 | CO—NMe₂ | H | OAc | OH | H | H | |
| 543 | CO—NEt₂ | H | OAc | OH | H | H | |
| 544 | CO—NHNH₂ | H | OAc | OH | H | H | |
| 545 | CN | H | OAc | OH | H | H | |
| 546 | CO—OH | H | OH | OAc | H | H | |
| 547 | CO—OMe | H | OH | OAc | H | H | |
| 548 | CO—OEt | H | OH | OAc | H | H | |
| 549 | CO—O-n-Pr | H | OH | OAc | H | H | |
| 550 | CO—O-n-Bu | H | OH | OAc | H | H | |
| 551 | CO—O-c-Pr | H | OH | OAc | H | H | |
| 552 | CO—O— | H | OH | OAc | H | H | |
| | CH₂CH₂OH | | | | | | |
| 553 | CO—O—C₁₂H₂₅ | H | OH | OAc | H | H | |
| 554 | CO—O—C₁₆H₃₃ | H | OH | OAc | H | H | |
| 555 | CO—NH₂ | H | OH | OAc | H | H | |
| 556 | CO—NHMe | H | OH | OAc | H | H | |
| 557 | CO—NHEt | H | OH | OAc | H | H | |
| 558 | CO—NH-n-Pr | H | OH | OAc | H | H | |
| 559 | CO—NH-i-Pr | H | OH | OAc | H | H | |
| 560 | CO—NH-c-Pr | H | OH | OAc | H | H | |
| 561 | CO—NH-n-Pr | H | OH | OAc | H | H | |
| 562 | CO—NH-n-Bu | H | OH | OAc | H | H | |
| 563 | CO—NMe₂ | H | OH | OAc | H | H | |
| 564 | CO—NEt₂ | H | OH | OAc | H | H | |
| 565 | CO—NHNH₂ | H | OH | OAc | H | H | |
| 566 | CN | H | OH | OAc | H | H | |
| 567 | CO—OH | H | OAc | OH | H | H | |
| 568 | CO—OMe | H | OAc | OAc | H | H | |
| 569 | CO—OEt | H | OAc | OAc | H | H | |
| 570 | CO—O-n-Pr | H | OAc | OAc | H | H | |
| 571 | CO—O-n-Bu | H | OAc | OAc | H | H | |
| 572 | CO—O-c-Pr | H | OAc | OAc | H | H | |
| 573 | CO—O— | H | OAc | OAc | H | H | |
| | CH₂CH₂OH | | | | | | |
| 574 | CO—O—C₁₂H₂₅ | H | OAc | OAc | H | H | |
| 575 | CO—O—C₁₆H₃₃ | H | OAc | OAc | H | H | |
| 576 | CO—NH₂ | H | OAc | OAc | H | H | |
| 577 | CO—NHMe | H | OAc | OAc | H | H | |
| 578 | CO—NHEt | H | OAc | OAc | H | H | |
| 579 | CO—NH-n-Pr | H | OAc | OAc | H | H | |
| 580 | CO—NH-i-Pr | H | OAc | OAc | H | H | |
| 581 | CO—NH-c-Pr | H | OAc | OAc | H | H | |
| 582 | CO—NH-n-Pr | H | OAc | OAc | H | H | |
| 583 | CO—NH-n-Bu | H | OAc | OAc | H | H | |
| 584 | CO—NMe₂ | H | OAc | OAc | H | H | |
| 585 | CO—NEt₂ | H | OAc | OAc | H | H | |
| 586 | CO—NHNH₂ | H | OAc | OAc | H | H | |
| 587 | CN | H | OAc | OAc | H | H | |
| 588 | COOH | H | OH | OH | Me | H | |
| 589 | CO—OMe | H | OH | OH | Me | H | |
| 590 | CO—OEt | H | OH | OH | Me | H | |
| 591 | CO—O-n-Pr | H | OH | OH | Me | H | |
| 592 | CO—O-n-Bu | H | OH | OH | Me | H | |
| 593 | CO—O-c-Pr | H | OH | OH | Me | H | |
| 594 | CO—O— | H | OH | OH | Me | H | |
| | CH₂CH₂OH | | | | | | |
| 595 | CO—O—C₁₂H₂₅ | H | OH | OH | Me | H | |
| 596 | CO—O—C₁₆H₃₃ | H | OH | OH | Me | H | |
| 597 | CO—NH₂ | H | OH | OH | Me | H | |
| 598 | CO—NHMe | H | OH | OH | Me | H | |
| 599 | CO—NHEt | H | OH | OH | Me | H | |
| 600 | CO—NH-n-Pr | H | OH | OH | Me | H | |
| 601 | CO—NH-i-Pr | H | OH | OH | Me | H | |
| 602 | CO—NH-c-Pr | H | OH | OH | Me | H | |
| 603 | CO—NH-n-Pr | H | OH | OH | Me | H | |
| 604 | CO—NH-n-Bu | H | OH | OH | Me | H | |
| 605 | CO—NMe₂ | H | OH | OH | Me | H | |
| 606 | CO—NEt₂ | H | OH | OH | Me | H | |
| 607 | CO—NHNH₂ | H | OH | OH | Me | H | |
| 608 | CN | H | OH | OH | Me | H | |
| 609 | CO—OH | H | OAc | OH | Me | H | |
| 610 | CO—OMe | H | OAc | OH | Me | H | |
| 611 | CO—OEt | H | OAc | OH | Me | H | |
| 612 | CO—O-n-Pr | H | OAc | OH | Me | H | |
| 613 | CO—O-n-Bu | H | OAc | OH | Me | H | |
| 614 | CO—O-c-Pr | H | OAc | OH | Me | H | |
| 615 | CO—O— | H | OAc | OH | Me | H | |
| | CH₂CH₂OH | | | | | | |
| 616 | CO—O—C₁₂H₂₅ | H | OAc | OH | Me | H | |
| 617 | CO—O—C₁₆H₃₃ | H | OAc | OH | Me | H | |
| 618 | CO—NH₂ | H | OAc | OH | Me | H | |
| 619 | CO—NHMe | H | OAc | OH | Me | H | |
| 620 | CO—NHEt | H | OAc | OH | Me | H | |
| 621 | CO—NH-n-Pr | H | OAc | OH | Me | H | |
| 622 | CO—NH-i-Pr | H | OAc | OH | Me | H | |
| 623 | CO—NH-c-Pr | H | OAc | OH | Me | H | |
| 624 | CO—NH-n-Pr | H | OAc | OH | Me | H | |
| 625 | CO—NH-n-Bu | H | OAc | OH | Me | H | |
| 626 | CO—NMe₂ | H | OAc | OH | Me | H | |
| 627 | CO—NEt₂ | H | OAc | OH | Me | H | |
| 628 | CO—NHNH₂ | H | OAc | OH | Me | H | |
| 629 | CN | H | OAc | OH | Me | H | |
| 630 | CO—OH | H | OAc | OAc | Me | H | |
| 631 | CO—OMe | H | OAc | OAc | Me | H | |
| 632 | CO—OEt | H | OAc | OAc | Me | H | |
| 633 | CO—O-n-Pr | H | OAc | OAc | Me | H | |
| 634 | CO—O-n-Bu | H | OAc | OAc | Me | H | |
| 635 | CO—O-c-Pr | H | OAc | OAc | Me | H | |
| 636 | CO—O— | H | OAc | OAc | Me | H | |
| | CH₂CH₂OH | | | | | | |
| 637 | CO—O—C₁₂H₂₅ | H | OAc | OAc | Me | H | |
| 638 | CO—O—C₁₆H₃₃ | H | OAc | OAc | Me | H | |
| 639 | CO—NH₂ | H | OAc | OAc | Me | H | |
| 640 | CO—NHMe | H | OAc | OAc | Me | H | |
| 641 | CO—NHEt | H | OAc | OAc | Me | H | |
| 642 | CO—NH-n-Pr | H | OAc | OAc | Me | H | |
| 643 | CO—NH-i-Pr | H | OAc | OAc | Me | H | |
| 644 | CO—NH-c-Pr | H | OAc | OAc | Me | H | |
| 645 | CO—NH-n-Pr | H | OAc | OAc | Me | H | |
| 646 | CO—NH-n-Bu | H | OAc | OAc | Me | H | |
| 647 | CO—NMe₂ | H | OAc | OAc | Me | H | |
| 648 | CO—NEt₂ | H | OAc | OAc | Me | H | |
| 649 | CO—NHNH₂ | H | OAc | OAc | Me | H | |
| 650 | CN | H | OAc | OAc | Me | H | |
| 651 | CO—OH | H | OH | OAc | Me | H | |
| 652 | CO—OMe | H | OH | OAc | Me | H | |
| 653 | CO—OEt | H | OH | OAc | Me | H | |
| 654 | CO—O-n-Pr | H | OH | OAc | Me | H | |
| 655 | CO—O-n-Bu | H | OH | OAc | Me | H | |
| 656 | CO—O-c-Pr | H | OH | OAc | Me | H | |
| 657 | CO—O— | H | OH | OAc | Me | H | |
| | CH₂CH₂OH | | | | | | |
| 658 | CO—O—C₁₂H₂₅ | H | OH | OAc | Me | H | |
| 659 | CO—O—C₁₆H₃₃ | H | OH | OAc | Me | H | |
| 660 | CO—NH₂ | H | OH | OAc | Me | H | |
| 661 | CO—NHMe | H | OH | OAc | Me | H | |
| 662 | CO—NHEt | H | OH | OAc | Me | H | |
| 663 | CO—NH-n-Pr | H | OH | OAc | Me | H | |
| 664 | CO—NH-i-Pr | H | OH | OAc | Me | H | |
| 665 | CO—NH-c-Pr | H | OH | OAc | Me | H | |
| 666 | CO—NH-n-Pr | H | OH | OAc | Me | H | |
| 667 | CO—NH-n-Bu | H | OH | OAc | Me | H | |
| 668 | CO—NMe₂ | H | OH | OAc | Me | H | |
| 669 | CO—NEt₂ | H | OH | OAc | Me | H | |
| 670 | CO—NHNH₂ | H | OH | OAc | Me | H | |
| 671 | CN | H | OAc | OAc | Me | H | |
| 672 | CO—OH | Me | OH | OH | H | H | |
| 673 | CO—OMe | Me | OH | OH | H | H | |
| 674 | CO—OEt | Me | OH | OH | H | H | |
| 675 | CO—O-n-Pr | Me | OH | OH | H | H | |
| 676 | CO—O-n-Bu | Me | OH | OH | H | H | |
| 677 | CO—O-c-Pr | Me | OH | OH | H | H | |
| 678 | CO—O— | Me | OH | OH | H | H | |
| | CH₂CH₂OH | | | | | | |
| 679 | CO—O—C₁₂H₂₅ | Me | OH | OH | H | H | |
| 680 | CO—O—C₁₆H₃₃ | Me | OH | OH | H | H | |
| 681 | CO—NH₂ | Me | OH | OH | H | H | |
| 682 | CO—NHMe | Me | OH | OH | H | H | |
| 683 | CO—NHEt | Me | OH | OH | H | H | |
| 684 | CO—NH-n-Pr | Me | OH | OH | H | H | |
| 685 | CO—NH-i-Pr | Me | OH | OH | H | H | |
| 686 | CO—NH-c-Pr | Me | OH | OH | H | H | |
| 687 | CO—NH-n-Pr | Me | OH | OH | H | H | |
| 688 | CO—NH-n-Bu | Me | OH | OH | H | H | |
| 689 | CO—NMe₂ | Me | OH | OH | H | H | |
| 690 | CO—NEt₂ | Me | OH | OH | H | H | |
| 691 | CO—NHNH₂ | Me | OH | OH | H | H | |
| 692 | CN | Me | OH | OH | H | H | |
| 693 | CO—OH | Me | OAc | OH | H | H | |
| 694 | CO—OMe | Me | OAc | OH | H | H | |
| 695 | CO—OEt | Me | OAc | OH | H | H | |
| 696 | CO—O-n-Pr | Me | OAc | OH | H | H | |
| 697 | CO—O-n-Bu | Me | OAc | OH | H | H | |
| 698 | CO—O-c-Pr | Me | OAc | OH | H | H | |
| 699 | CO—O— | Me | OAc | OH | H | H | |
| | CH₂CH₂OH | | | | | | |
| 700 | CO—O—C₁₂H₂₅ | Me | OAc | OH | H | H | |
| 701 | CO—O—C₁₆H₃₃ | Me | OAc | OH | H | H | |
| 702 | CO—NH₂ | Me | OAc | OH | H | H | |
| 703 | CO—NHMe | Me | OAc | OH | H | H | |
| 704 | CO—NHEt | Me | OAc | OH | H | H | |
| 705 | CO—NH-n-Pr | Me | OAc | OH | H | H | |
| 706 | CO—NH-i-Pr | Me | OAc | OH | H | H | |
| 707 | CO—NH-c-Pr | Me | OAc | OH | H | H | |
| 708 | CO—NH-n-Pr | Me | OAc | OH | H | H | |
| 709 | CO—NH-n-Bu | Me | OAc | OH | H | H | |
| 710 | CO—NMe₂ | Me | OAc | OH | H | H | |
| 711 | CO—NEt₂ | Me | OAc | OH | H | H | |
| 712 | CO—NHNH₂ | Me | OAc | OH | H | H | |
| 713 | CN | Me | OAc | OH | H | H | |
| 714 | CO—OH | Me | OAc | OAc | H | H | |
| 715 | CO—OMe | Me | OAc | OAc | H | H | |
| 716 | CO—OEt | Me | OAc | OAc | H | H | |
| 717 | CO—O-n-Pr | Me | OAc | OAc | H | H | |
| 718 | CO—O-n-Bu | Me | OAc | OAc | H | H | |
| 719 | CO—O-c-Pr | Me | OAc | OAc | H | H | |
| 720 | CO—O— | Me | OAc | OAc | H | H | |
| | CH₂CH₂OH | | | | | | |
| 721 | CO—O—C₁₂H₂₅ | Me | OAc | OAc | H | H | |
| 722 | CO—O—C₁₆H₃₃ | Me | OAc | OAc | H | H | |
| 723 | CO—NH₂ | Me | OAc | OAc | H | H | |
| 724 | CO—NHMe | Me | OAc | OAc | H | H | |
| 725 | CO—NHEt | Me | OAc | OAc | H | H | |
| 726 | CO—NH-n-Pr | Me | OAc | OAc | H | H | |
| 727 | CO—NH-i-Pr | Me | OAc | OAc | H | H | |
| 728 | CO—NH-c-Pr | Me | OAc | OAc | H | H | |
| 729 | CO—NH-n-Pr | Me | OAc | OAc | H | H | |
| 730 | CO—NH-n-Bu | Me | OAc | OAc | H | H | |
| 731 | CO—NMe₂ | Me | OAc | OAc | H | H | |
| 732 | CO—NEt₂ | Me | OAc | OAc | H | H | |
| 733 | CO—NHNH₂ | Me | OAc | OAc | H | H | |
| 734 | CN | Me | OAc | OAc | H | H | |
| 735 | CO—OH | Me | OH | OAc | H | H | |
| 736 | CO—OMe | Me | OH | OAc | H | H | |
| 737 | CO—OEt | Me | OH | OAc | H | H | |
| 738 | CO—O-n-Pr | Me | OH | OAc | H | H | |
| 739 | CO—O-n-Bu | Me | OH | OAc | H | H | |
| 740 | CO—O-c-Pr | Me | OH | OAc | H | H | |
| 741 | CO—O— | Me | OH | OAc | H | H | |
| | CH₂CH₂OH | | | | | | |
| 742 | CO—O—C₁₂H₂₅ | Me | OH | OAc | H | H | |
| 743 | CO—O—C₁₆H₃₃ | Me | OH | OAc | H | H | |
| 744 | CO—NH₂ | Me | OH | OAc | H | H | |
| 745 | CO—NHMe | Me | OH | OAc | H | H | |
| 746 | CO—NHEt | Me | OH | OAc | H | H | |
| 747 | CO—NH-n-Pr | Me | OH | OAc | H | H | |
| 748 | CO—NH-i-Pr | Me | OH | OAc | H | H | |
| 749 | CO—NH-c-Pr | Me | OH | OAc | H | H | |
| 750 | CO—NH-n-Pr | Me | OH | OAc | H | H | |
| 751 | CO—NH-n-Bu | Me | OH | OAc | H | H | |
| 752 | CO—NMe₂ | Me | OH | OAc | H | H | |
| 753 | CO—NEt₂ | Me | OH | OAc | H | H | |
| 754 | CO—NHNH₂ | H | OH | OAc | H | H | |
| 755 | CN | Me | OAc | OAc | H | H | |
| 756 | CO—OH | H | OH | OH | H | Me | |
| 757 | CO—OMe | H | OH | OH | H | Me | |
| 758 | CO—OEt | H | OH | OH | H | Me | |
| 759 | CO—O-n-Pr | H | OH | OH | H | Me | |
| 760 | CO—O-n-Bu | H | OH | OH | H | Me | |
| 761 | CO—O-c-Pr | H | OH | OH | H | Me | |
| 762 | CO—O— | H | OH | OH | H | Me | |
| | CH₂CH₂OH | | | | | | |
| 763 | CO—O—C₁₂H₂₅ | H | OH | OH | H | Me | |
| 764 | CO—O—C₁₈H₃₃ | H | OH | OH | H | Me | |
| 765 | CO—NH₂ | H | OH | OH | H | Me | |
| 766 | CO—NHMe | H | OH | OH | H | Me | |
| 767 | CO—NHEt | H | OH | OH | H | Me | |
| 768 | CO—NH-n-Pr | H | OH | OH | H | Me | |
| 769 | CO—NH-i-Pr | H | OH | OH | H | Me | |
| 770 | CO—NH-c-Pr | H | OH | OH | H | Me | |
| 771 | CO—NH-n-Pr | H | OH | OH | H | Me | |
| 772 | CO—NH-n-Bu | H | OH | OH | H | Me | |
| 773 | CO—NMe₂ | H | OH | OH | H | Me | |
| 774 | CO—NEt₂ | H | OH | OH | H | Me | |
| 775 | CO—NHNH₂ | H | OH | OH | H | Me | |
| 776 | CN | H | OH | OH | H | Me | |
| 777 | CO—OH | H | OAc | OH | H | Me | |
| 778 | CO—OMe | H | OAc | OH | H | Me | |
| 779 | CO—OEt | H | OAc | OH | H | Me | |
| 780 | CO—O-n-Pr | H | OAc | OH | H | Me | |
| 781 | CO—O-n-Bu | H | OAc | OH | H | Me | |
| 782 | CO—O-c-Pr | H | OAc | OH | H | Me | |
| 783 | CO—O— | H | OAc | OH | H | Me | |
| | CH₂CH₂OH | | | | | | |
| 784 | CO—O—C₁₂H₂₅ | H | OAc | OH | H | Me | |
| 785 | CO—O—C₁₆H₃₃ | H | OAc | OH | H | Me | |
| 786 | CO—NH₂ | H | OAc | OH | H | Me | |
| 787 | CO—NHMe | H | OAc | OH | H | Me | |
| 788 | CO—NHEt | H | OAc | OH | H | Me | |
| 789 | CO—NH-n-Pr | H | OAc | OH | H | Me | |
| 790 | CO—NH-i-Pr | H | OAc | OH | H | Me | |
| 791 | CO—NH-c-Pr | H | OAc | OH | H | Me | |
| 792 | CO—NH-n-Pr | H | OAc | OH | H | Me | |
| 793 | CO—NH-n-Bu | H | OAc | OH | H | Me | |
| 794 | CO—NMe₂ | H | OAc | OH | H | Me | |
| 795 | CO—NEt₂ | H | OAc | OH | H | Me | |
| 796 | CO—NHNH₂ | H | OAc | OH | H | Me | |
| 797 | CN | H | OAc | OH | H | Me | |
| 798 | CO—OH | H | OAc | OAc | H | Me | |
| 799 | CO—OMe | H | OAc | OAc | H | Me | |
| 800 | CO—OEt | H | OAc | OAc | H | Me | |
| 801 | CO—O-n-Pr | H | OAc | OAc | H | Me | |
| 802 | CO—O-n-Bu | H | OAc | OAc | H | Me | |
| 803 | CO—O-c-Pr | H | OAc | OAc | H | Me | |
| 804 | CO—O— | H | OAc | OAc | H | Me | |
| | CH₂CH₂OH | | | | | | |
| 805 | CO—O—C₁₂H₂₅ | H | OAc | OAc | H | Me | |
| 806 | CO—O—C₁₆H₃₃ | H | OAc | OAc | H | Me | |
| 807 | CO—NH₂ | H | OAc | OAc | H | Me | |
| 808 | CO—NHMe | H | OAc | OAc | H | Me | |
| 809 | CO—NHEt | H | OAc | OAc | H | Me | |
| 810 | CO—NH-n-Pr | H | OAc | OAc | H | Me | |
| 811 | CO—NH-i-Pr | H | OAc | OAc | H | Me | |
| 812 | CO—NH-c-Pr | H | OAc | OAc | H | Me | |
| 813 | CO—NH-n-Pr | H | OAc | OAc | H | Me | |
| 814 | CO—NH-n-Bu | H | OAc | OAc | H | Me | |
| 815 | CO—NMe₂ | H | OAc | OAc | H | Me | |
| 816 | CO—NEt₂ | H | OAc | OAc | H | Me | |
| 817 | CO—NHNH₂ | H | OAc | OAc | H | Me | |
| 818 | CN | H | OAc | OAc | H | Me | |
| 819 | CO—OH | H | OH | OAc | H | Me | |
| 820 | CO—OMe | H | OH | OAc | H | Me | |
| 821 | CO—OEt | H | OH | OAc | H | Me | |
| 822 | CO—O-n-Pr | H | OH | OAc | H | Me | |
| 823 | CO—O-n-Bu | H | OH | OAc | H | Me | |
| 824 | CO—O-c-Pr | H | OH | OAc | H | Me | |
| 825 | CO—O— | H | OH | OAc | H | Me | |
| | CH₂CH₂OH | | | | | | |
| 826 | CO—O—C₁₂H₂₅ | H | OH | OAc | H | Me | |
| 827 | CO—O—C₁₆H₃₃ | H | OH | OAc | H | Me | |
| 828 | CO—NH₂ | H | OH | OAc | H | Me | |
| 829 | CO—NHMe | H | OH | OAc | H | Me | |
| 830 | CO—NHEt | H | OH | OAc | H | Me | |
| 831 | CO—NH-n-Pr | H | OH | OAc | H | Me | |
| 832 | CO—NH-i-Pr | H | OH | OAc | H | Me | |
| 833 | CO—NH-c-Pr | H | OH | OAc | H | Me | |
| 834 | CO—NH-n-Pr | H | OH | OAc | H | Me | |
| 835 | CO—NH-n-Bu | H | OH | OAc | H | Me | |
| 836 | CO—NMe₂ | H | OH | OAc | H | Me | |
| 837 | CO—NEt₂ | H | OH | OAc | H | Me | |
| 838 | CO—NHNH₂ | H | OH | OAc | H | Me | |
| 839 | CN | H | OAc | OAc | H | Me | |
| 840 | CO—OH | H | OH | OMe | H | H | |
| 841 | CO—OMe | H | OH | OMe | H | H | |
| 842 | CO—OEt | H | OH | OMe | H | H | |
| 843 | CO—O-n-Pr | H | OH | OMe | H | H | |
| 844 | CO—O-n-Bu | H | OH | OMe | H | H | |
| 845 | CO—O-c-Pr | H | OH | OMe | H | H | |
| 846 | CO—O— | H | OH | OMe | H | H | |
| | CH₂CH₂OH | | | | | | |
| 847 | CO—O—C₁₂H₂₅ | H | OH | OMe | H | H | |
| 848 | CO—O—C₁₆H₃₃ | H | OH | OMe | H | H | |
| 849 | CO—NH₂ | H | OH | OMe | H | H | |
| 850 | CO—NHMe | H | OH | OMe | H | H | |
| 851 | CO—NHEt | H | OH | OMe | H | H | |
| 852 | CO—NH-n-Pr | H | OH | OMe | H | H | |
| 853 | CO—NH-i-Pr | H | OH | OMe | H | H | |
| 854 | CO—NH-c-Pr | H | OH | OMe | H | H | |
| 855 | CO—NH-n-Pr | H | OH | OMe | H | H | |
| 856 | CO—NH-n-Bu | H | OH | OMe | H | H | |
| 857 | CO—NMe₂ | H | OH | OMe | H | H | |
| 858 | CO—NEt₂ | H | OH | OMe | H | H | |
| 859 | CO—NHNH₂ | H | OH | OMe | H | H | |
| 860 | CN | H | OH | OMe | H | H | |
| 861 | CO—OH | H | OAc | OMe | H | H | |
| 862 | CO—OMe | H | OAc | OMe | H | H | |
| 863 | CO—OEt | H | OAc | OMe | H | H | |
| 864 | CO—O-n-Pr | H | OAc | OMe | H | H | |
| 865 | CO—O-n-Bu | H | OAc | OMe | H | H | |
| 866 | CO—O-c-Pr | H | OAc | OMe | H | H | |
| 867 | CO—O— | H | OAc | OMe | H | H | |
| | CH₂CH₂OH | | | | | | |
| 868 | CO—O—C₁₂H₂₅ | H | OAc | OMe | H | H | |
| 869 | CO—O—C₁₆H₃₃ | H | OAc | OMe | H | H | |
| 870 | CO—NH₂ | H | OAc | OMe | H | H | |
| 871 | CO—NHMe | H | OAc | OMe | H | H | |
| 872 | CO—NHEt | H | OAc | OMe | H | H | |
| 873 | CO—NH-n-Pr | H | OAc | OMe | H | H | |
| 874 | CO—NH-i-Pr | H | OAc | OMe | H | H | |
| 875 | CO—NH-c-Pr | H | OAc | OMe | H | H | |
| 876 | CO—NH-n-Pr | H | OAc | OMe | H | H | |
| 877 | CO—NH-n-Bu | H | OAc | OMe | H | H | |
| 878 | CO—NMe₂ | H | OAc | OMe | H | H | |
| 879 | CO—NEt₂ | H | OAc | OMe | H | H | |
| 880 | CO—NHNH₂ | H | OAc | OMe | H | H | |
| 881 | CN | H | OAc | OMe | H | H | |
| 882 | CO—OH | H | OMe | OH | H | H | |
| 883 | CO—OMe | H | OMe | OH | H | H | |
| 884 | CO—OEt | H | OMe | OH | H | H | |
| 885 | CO—O-n-Pr | H | OMe | OH | H | H | |
| 886 | CO—O-n-Bu | H | OMe | OH | H | H | |
| 887 | CO—O-c-Pr | H | OMe | OH | H | H | |
| 888 | CO—O— | H | OMe | OH | H | H | |
| | CH₂CH₂OH | | | | | | |
| 889 | CO—O—C₁₂H₂₅ | H | OMe | OH | H | H | |
| 890 | CO—O—C₁₆H₃₃ | H | OMe | OH | H | H | |
| 891 | CO—NH₂ | H | OMe | OH | H | H | |
| 892 | CO—NHMe | H | OMe | OH | H | H | |
| 893 | CO—NHEt | H | OMe | OH | H | H | |
| 894 | CO—NH-n-Pr | H | OMe | OH | H | H | |
| 895 | CO—NH-i-Pr | H | OMe | OH | H | H | |
| 896 | CO—NH-c-Pr | H | OMe | OH | H | H | |
| 897 | CO—NH-n-Pr | H | OMe | OH | H | H | |
| 898 | CO—NH-n-Bu | H | OMe | OH | H | H | |
| 899 | CO—NMe₂ | H | OMe | OH | H | H | |
| 900 | CO—NEt₂ | H | OMe | OH | H | H | |
| 901 | CO—NHNH₂ | H | OMe | OH | H | H | |
| 902 | CN | H | OMe | OH | H | H | |
| 903 | CO—OH | H | OMe | OAc | H | H | |
| 904 | CO—OMe | H | OMe | OAc | H | H | |
| 905 | CO—OEt | H | OMe | OAc | H | H | |
| 906 | CO—O-n-Pr | H | OMe | OAc | H | H | |
| 907 | CO—O-n-Bu | H | OMe | OAc | H | H | |
| 908 | CO—O-c-Pr | H | OMe | OAc | H | H | |
| 909 | CO—O— | H | OMe | OAc | H | H | |
| | CH₂CH₂OH | | | | | | |
| 910 | CO—O—C₁₂H₂₅ | H | OMe | OAc | H | H | |
| 911 | CO—O—C₁₆H₃₃ | H | OMe | OAc | H | H | |
| 912 | CO—NH₂ | H | OMe | OAc | H | H | |
| 913 | CO—NHMe | H | OMe | OAc | H | H | |
| 914 | CO—NHEt | H | OMe | OAc | H | H | |
| 915 | CO—NH-n-Pr | H | OMe | OAc | H | H | |
| 916 | CO—NH-i-Pr | H | OMe | OAc | H | H | |
| 917 | CO—NH-c-Pr | H | OMe | OAc | H | H | |
| 918 | CO—NH-n-Pr | H | OMe | OAc | H | H | |
| 919 | CO—NH-n-Bu | H | OMe | OAc | H | H | |
| 920 | CO—NMe₂ | H | OMe | OAc | H | H | |
| 921 | CO—NEt₂ | H | OMe | OAc | H | H | |
| 922 | CO—NHNH₂ | H | OMe | OAc | H | H | |
| 923 | CN | H | OMe | OAc | H | H | |
| 924 | CO—OH | H | NH₂ | OH | H | H | |
| 925 | CO—OMe | H | NH₂ | OH | H | H | |
| 926 | CO—OEt | H | NH₂ | OH | H | H | |
| 927 | CO—O-n-Pr | H | NH₂ | OH | H | H | |
| 928 | CO—O-n-Bu | H | NH₂ | OH | H | H | |
| 929 | CO—O-c-Pr | H | NH₂ | OH | H | H | |
| 930 | CO—O— | H | NH₂ | OH | H | H | |
| | CH₂CH₂OH | | | | | | |
| 931 | CO—O—C₁₂H₂₅ | H | NH₂ | OH | H | H | |
| 932 | CO—O—C₁₆H₃₃ | H | NH₂ | OH | H | H | |
| 933 | CO—NH₂ | H | NH₂ | OH | H | H | |
| 934 | CO—NHMe | H | NH₂ | OH | H | H | |
| 935 | CO—NHEt | H | NH₂ | OH | H | H | |
| 936 | CO—NH-n-Pr | H | NH₂ | OH | H | H | |
| 937 | CO—NH-i-Pr | H | NH₂ | OH | H | H | |
| 938 | CO—NH-c-Pr | H | NH₂ | OH | H | H | |
| 939 | CO—NH-n-Pr | H | NH₂ | OH | H | H | |
| 940 | CO—NH-n-Bu | H | NH₂ | OH | H | H | |
| 941 | CO—NMe₂ | H | NH₂ | OH | H | H | |
| 942 | CO—NEt₂ | H | NH₂ | OH | H | H | |
| 943 | CO—NHNH₂ | H | NH₂ | OH | H | H | |
| 944 | CN | H | NH₂ | OH | H | H | |
| 945 | CO—OH | H | NH₂ | OAc | H | H | |
| 946 | CO—OMe | H | NH₂ | OAc | H | H | |
| 947 | CO—OEt | H | NH₂ | OAc | H | H | |
| 948 | CO—O-n-Pr | H | NH₂ | OAc | H | H | |
| 949 | CO—O-n-Bu | H | NH₂ | OAc | H | H | |
| 950 | CO—O-c-Pr | H | NH₂ | OAc | H | H | |
| 951 | CO—O— | H | NH₂ | OAc | H | H | |
| | CH₂CH₂OH | | | | | | |
| 952 | CO—O—C₁₂H₂₅ | H | NH₂ | OAc | H | H | |
| 953 | CO—O—C₁₆H₃₃ | H | NH₂ | OAc | H | H | |
| 954 | CO—NH₂ | H | NH₂ | OAc | H | H | |
| 955 | CO—NHMe | H | NH₂ | OAc | H | H | |
| 956 | CO—NHEt | H | NH₂ | OAc | H | H | |
| 957 | CO—NH-n-Pr | H | NH₂ | OAc | H | H | |
| 958 | CO—NH-i-Pr | H | NH₂ | OAc | H | H | |
| 959 | CO—NH-c-Pr | H | NH₂ | OAc | H | H | |
| 960 | CO—NH-n-Pr | H | NH₂ | OAc | H | H | |
| 961 | CO—NH-n-Bu | H | NH₂ | OAc | H | H | |
| 962 | CO—NMe₂ | H | NH₂ | OAc | H | H | |
| 963 | CO—NEt₂ | H | NH₂ | OAc | H | H | |
| 964 | CO—NHNH₂ | H | NH₂ | OAc | H | H | |
| 965 | CN | H | NH₂ | OAc | H | H | |
| 966 | CO—OH | H | OH | NH₂ | H | H | |
| 967 | CO—OMe | H | OH | NH₂ | H | H | |
| 968 | CO—OEt | H | OH | NH₂ | H | H | |
| 969 | CO—O-n-Pr | H | OH | NH₂ | H | H | |
| 970 | CO—O-n-Bu | H | OH | NH₂ | H | H | |
| 971 | CO—O-c-Pr | H | OH | NH₂ | H | H | |
| 972 | CO—O— | H | OH | NH₂ | H | H | |
| | CH₂CH₂OH | | | | | | |
| 973 | CO—O—C₁₂H₂₅ | H | OH | NH₂ | H | H | |
| 974 | CO—O—C₁₆H₃₃ | H | OH | NH₂ | H | H | |
| 975 | CO—NH₂ | H | OH | NH₂ | H | H | |
| 976 | CO—NHMe | H | OH | NH₂ | H | H | |
| 977 | CO—NHEt | H | OH | NH₂ | H | H | |
| 978 | CO—NH-n-Pr | H | OH | NH₂ | H | H | |
| 979 | CO—NH-i-Pr | H | OH | NH₂ | H | H | |
| 980 | CO—NH-c-Pr | H | OH | NH₂ | H | H | |
| 981 | CO—NH-n-Pr | H | OH | NH₂ | H | H | |
| 982 | CO—NH-n-Bu | H | OH | NH₂ | H | H | |
| 983 | CO—NMe₂ | H | OH | NH₂ | H | H | |
| 984 | CO—NEt₂ | H | OH | NH₂ | H | H | |
| 985 | CO—NHNH₂ | H | OH | NH₂ | H | H | |
| 986 | CN | H | OH | NH₂ | H | H | |
| 987 | CO—OH | H | OAc | NH₂ | H | H | |
| 988 | CO—OMe | H | OAc | NH₂ | H | H | |
| 989 | CO—OEt | H | OAc | NH₂ | H | H | |
| 990 | CO—O-n-Pr | H | OAc | NH₂ | H | H | |
| 991 | CO—O-n-Bu | H | OAc | NH₂ | H | H | |
| 992 | CO—O-c-Pr | H | OAc | NH₂ | H | H | |
| 993 | CO—O— | H | OAc | NH₂ | H | H | |
| | CH₂CH₂OH | | | | | | |
| 994 | CO—O—C₁₂H₂₅ | H | OAc | NH₂ | H | H | |
| 995 | CO—O—C₁₆H₃₃ | H | OAc | NH₂ | H | H | |
| 996 | CO—NH₂ | H | OAc | NH₂ | H | H | |
| 997 | CO—NHMe | H | OAc | NH₂ | H | H | |
| 998 | CO—NHEt | H | OAc | NH₂ | H | H | |
| 999 | CO—NH-n-Pr | H | OAc | NH₂ | H | H | |
| 1000 | CO—NH-i-Pr | H | OAc | NH₂ | H | H | |
| 1001 | CO—NH-c-Pr | H | OAc | NH₂ | H | H | |
| 1002 | CO—NH-n-Pr | H | OAc | NH₂ | H | H | |
| 1003 | CO—NH-n-Bu | H | OAc | NH₂ | H | H | |
| 1004 | CO—NMe₂ | H | OAc | NH₂ | H | H | |
| 1005 | CO—NEt₂ | H | OAc | NH₂ | H | H | |
| 1006 | CO—NHNH₂ | H | OAc | NH₂ | H | H | |
| 1007 | CN | H | OAc | NH₂ | H | H | |
| 1008 | CO—OH | H | NH₂ | OMe | H | H | |
| 1009 | CO—OMe | H | NH₂ | OMe | H | H | |
| 1010 | CO—OEt | H | NH₂ | OMe | H | H | |
| 1011 | CO—O-n-Pr | H | NH₂ | OMe | H | H | |
| 1012 | CO—O-n-Bu | H | NH₂ | OMe | H | H | |
| 1013 | CO—O-c-Pr | H | NH₂ | OMe | H | H | |
| 1014 | CO—O— | H | NH₂ | OMe | H | H | |
| | CH₂CH₂OH | | | | | | |
| 1015 | CO—O—C₁₂H₂₅ | H | NH₂ | OMe | H | H | |
| 1016 | CO—O—C₁₆H₃₃ | H | NH₂ | OMe | H | H | |
| 1017 | CO—NH₂ | H | NH₂ | OMe | H | H | |
| 1018 | CO—NHMe | H | NH₂ | OMe | H | H | |
| 1019 | CO—NHEt | H | NH₂ | OMe | H | H | |
| 1020 | CO—NH-n-Pr | H | NH₂ | OMe | H | H | |
| 1021 | CO—NH-i-Pr | H | NH₂ | OMe | H | H | |
| 1022 | CO—NH-c-Pr | H | NH₂ | OMe | H | H | |
| 1023 | CO—NH-n-Pr | H | NH₂ | OMe | H | H | |
| 1024 | CO—NH-n-Bu | H | NH₂ | OMe | H | H | |
| 1025 | CO—NMe₂ | H | NH₂ | OMe | H | H | |
| 1026 | CO—NEt₂ | H | NH₂ | OMe | H | H | |
| 1027 | CO—NHNH₂ | H | NH₂ | OMe | H | H | |
| 1028 | CN | H | NH₂ | OMe | H | H | |
| 1029 | CO—OH | H | OMe | NH₂ | H | H | |
| 1030 | CO—OMe | H | OMe | NH₂ | H | H | |
| 1031 | CO—OEt | H | OMe | NH₂ | H | H | |
| 1032 | CO—O-n-Pr | H | OMe | NH₂ | H | H | |
| 1033 | CO—O-n-Bu | H | OMe | NH₂ | H | H | |
| 1034 | CO—O-c-Pr | H | OMe | NH₂ | H | H | |
| 1035 | CO—O— | H | OMe | NH₂ | H | H | |
| | CH₂CH₂OH | | | | | | |
| 1036 | CO—O—C₁₂H₂₅ | H | OMe | NH₂ | H | H | |
| 1037 | CO—O—C₁₆H₃₃ | H | OMe | NH₂ | H | H | |
| 1038 | CO—NH₂ | H | OMe | NH₂ | H | H | |
| 1039 | CO—NHMe | H | OMe | NH₂ | H | H | |
| 1040 | CO—NHEt | H | OMe | NH₂ | H | H | |
| 1041 | CO—NH-n-Pr | H | OMe | NH₂ | H | H | |
| 1042 | CO—NH-i-Pr | H | OMe | NH₂ | H | H | |
| 1043 | CO—NH-c-Pr | H | OMe | NH₂ | H | H | |
| 1044 | CO—NH-n-Pr | H | OMe | NH₂ | H | H | |
| 1045 | CO—NH-n-Bu | H | OMe | NH₂ | H | H | |
| 1046 | CO—NMe₂ | H | OMe | NH₂ | H | H | |
| 1047 | CO—NEt₂ | H | OMe | NH₂ | H | H | |
| 1048 | CO—NHNH₂ | H | OMe | NH₂ | H | H | |
| 1049 | CN | H | OMe | NH₂ | H | H | |
| 1050 | CO—OH | H | OH | H | OH | H | |
| 1051 | CO—OMe | H | OH | H | OH | H | |
| 1052 | CO—OEt | H | OH | H | OH | H | |
| 1053 | CO—O-n-Pr | H | OH | H | OH | H | |
| 1054 | CO—O-n-Bu | H | OH | H | OH | H | |
| 1055 | CO—O-c-Pr | H | OH | H | OH | H | |
| 1056 | CO—O— | H | OH | H | OH | H | |
| | CH₂CH₂OH | | | | | | |
| 1057 | CO—O—C₁₂H₂₅ | H | OH | H | OH | H | |
| 1058 | CO—O—C₁₆H₃₃ | H | OH | H | OH | H | |
| 1059 | CO—NH₂ | H | OH | H | OH | H | |
| 1060 | CO—NHMe | H | OH | H | OH | H | |
| 1061 | CO—NHEt | H | OH | H | OH | H | |
| 1062 | CO—NH-n-Pr | H | OH | H | OH | H | |
| 1063 | CO—NH-i-Pr | H | OH | H | OH | H | |
| 1064 | CO—NH-c-Pr | H | OH | H | OH | H | |
| 1065 | CO—NH-n-Pr | H | OH | H | OH | H | |
| 1066 | CO—NH-n-Bu | H | OH | H | OH | H | |
| 1067 | CO—NMe₂ | H | OH | H | OH | H | |
| 1068 | CO—NEt₂ | H | OH | H | OH | H | |
| 1069 | CO—NHNH₂ | H | OH | H | OH | H | |
| 1070 | CN | H | OH | H | OH | H | |
| 1071 | CO—OH | H | OAc | H | OAc | H | |
| 1072 | CO—OMe | H | OAc | H | OAc | H | |
| 1073 | CO—OEt | H | OAc | H | OAc | H | |
| 1074 | CO—O-n-Pr | H | OAc | H | OAc | H | |
| 1075 | CO—O-n-Bu | H | OAc | H | OAc | H | |
| 1076 | CO—O-c-Pr | H | OAc | H | OAc | H | |
| 1077 | CO—O— | H | OAc | H | OAc | H | |
| | CH₂CH₂OH | | | | | | |
| 1078 | CO—O—C₁₂H₂₅ | H | OAc | H | OAc | H | |
| 1079 | CO—O—C₁₆H₃₃ | H | OAc | H | OAc | H | |
| 1080 | CO—NH₂ | H | OAc | H | OAc | H | |
| 1081 | CO—NHMe | H | OAc | H | OAc | H | |
| 1082 | CO—NHEt | H | OAc | H | OAc | H | |
| 1083 | CO—NH-n-Pr | H | OAc | H | OAc | H | |
| 1084 | CO—NH-i-Pr | H | OAc | H | OAc | H | |
| 1085 | CO—NH-c-Pr | H | OAc | H | OAc | H | |
| 1086 | CO—NH-n-Pr | H | OAc | H | OAc | H | |
| 1087 | CO—NH-n-Bu | H | OAc | H | OAc | H | |
| 1088 | CO—NMe₂ | H | OAc | H | OAc | H | |
| 1089 | CO—NEt₂ | H | OAc | H | OAc | H | |
| 1090 | CO—NHNH₂ | H | OAc | H | OAc | H | |
| 1091 | CN | H | OAc | H | OAc | H | |
| 1092 | CO—OH | H | OH | H | OAc | H | |
| 1093 | CO—OMe | H | OH | H | OAc | H | |
| 1094 | CO—OEt | H | OH | H | OAc | H | |
| 1095 | CO—O-n-Pr | H | OH | H | OAc | H | |
| 1096 | CO—O-n-Bu | H | OH | H | OAc | H | |
| 1097 | CO—O-c-Pr | H | OH | H | OAc | H | |
| 1098 | CO—O— | H | OH | H | OAc | H | |
| | CH₂CH₂OH | | | | | | |
| 1099 | CO—O—C₁₂H₂₅ | H | OH | H | OAc | H | |
| 1100 | CO—O—C₁₆H₃₃ | H | OH | H | OAc | H | |
| 1101 | CO—NH₂ | H | OH | H | OAc | H | |
| 1102 | CO—NHMe | H | OH | H | OAc | H | |
| 1103 | CO—NHEt | H | OH | H | OAc | H | |
| 1104 | CO—NH-n-Pr | H | OH | H | OAc | H | |
| 1105 | CO—NH-i-Pr | H | OH | H | OAc | H | |
| 1106 | CO—NH-c-Pr | H | OH | H | OAc | H | |
| 1107 | CO—NH-n-Pr | H | OH | H | OAc | H | |
| 1108 | CO—NH-n-Bu | H | OH | H | OAc | H | |
| 1109 | CO—NMe₂ | H | OH | H | OAc | H | |
| 1110 | CO—NEt₂ | H | OH | H | OAc | H | |
| 1111 | CO—NHNH₂ | H | OH | H | OAc | H | |
| 1112 | CN | H | OH | H | OAc | H | |
| 1113 | CO—OH | H | OH | OH | OH | H | |
| 1114 | CO—OMe | H | OH | OH | OH | H | |
| 1115 | CO—OEt | H | OH | OH | OH | H | |
| 1116 | CO—O-n-Pr | H | OH | OH | OH | H | |
| 1117 | CO—O-n-Bu | H | OH | OH | OH | H | |
| 1118 | CO—O-i-Pen | H | OH | OH | OH | H | |
| 1119 | CO—O-c-Pr | H | OH | OH | OH | H | |
| 1120 | CO—O— | H | OH | OH | OH | H | |
| | CH₂CH₂OH | | | | | | |
| 1121 | CO—O—C₈H₁₇ | H | OH | OH | OH | H | |
| 1122 | CO—O—C₁₂H₂₅ | H | OH | OH | OH | H | |
| 1123 | CO—O—C₁₆H₃₃ | H | OH | OH | OH | H | |
| 1124 | CO—NH₂ | H | OH | OH | OH | H | |
| 1125 | CO—NHMe | H | OH | OH | OH | H | |
| 1126 | CO—NHEt | H | OH | OH | OH | H | |
| 1127 | CO—NH-n-Pr | H | OH | OH | OH | H | |
| 1128 | CO—NH-i-Pr | H | OH | OH | OH | H | |
| 1129 | CO—NH-c-Pr | H | OH | OH | OH | H | |
| 1130 | CO—NH-n-Pr | H | OH | OH | OH | H | |
| 1131 | CO—NH-n-Bu | H | OH | OH | OH | H | |
| 1132 | CO—NMe₂ | H | OH | OH | OH | H | |
| 1133 | CO—NEt₂ | H | OH | OH | OH | H | |
| 1134 | CO—NHNH₂ | H | OH | OH | OH | H | |
| 1135 | CN | H | OH | OH | OH | H | |
| 1136 | CO—OH | H | OAc | OH | OH | H | |
| 1137 | CO—OMe | H | OAc | OH | OH | H | |
| 1138 | CO—OEt | H | OAc | OH | OH | H | |
| 1139 | CO—O-n-Pr | H | OAc | OH | OH | H | |
| 1140 | CO—O-n-Bu | H | OAc | OH | OH | H | |
| 1141 | CO—O-c-Pr | H | OAc | OH | OH | H | |
| 1142 | CO—O— | H | OAc | OH | OH | H | |
| | CH₂CH₂OH | | | | | | |
| 1143 | CO—O—C₁₂H₂₅ | H | OAc | OH | OH | H | |
| 1144 | CO—O—C₁₆H₃₃ | H | OAc | OH | OH | H | |
| 1145 | CO—NH₂ | H | OAc | OH | OH | H | |
| 1146 | CO—NHMe | H | OAc | OH | OH | H | |
| 1147 | CO—NHEt | H | OAc | OH | OH | H | |
| 1148 | CO—NH-n-Pr | H | OAc | OH | OH | H | |
| 1149 | CO—NH-i-Pr | H | OAc | OH | OH | H | |
| 1150 | CO—NH-c-Pr | H | OAc | OH | OH | H | |
| 1151 | CO—NH-n-Pr | H | OAc | OH | OH | H | |
| 1152 | CO—NH-n-Bu | H | OAc | OH | OH | H | |
| 1153 | CO—NMe₂ | H | OAc | OH | OH | H | |
| 1154 | CO—NEt₂ | H | OAc | OH | OH | H | |
| 1155 | CO—NHNH₂ | H | OAc | OH | OH | H | |
| 1156 | CN | H | OAc | OH | OH | H | |
| 1157 | CO—OH | H | OH | OAc | OH | H | |
| 1158 | CO—OMe | H | OH | OAc | OH | H | |
| 1159 | CO—OEt | H | OH | OAc | OH | H | |
| 1160 | CO—O-n-Pr | H | OH | OAc | OH | H | |
| 1161 | CO—O-n-Bu | H | OH | OAc | OH | H | |
| 1162 | CO—O-i-Pen | H | OH | OAc | OH | H | |
| 1163 | CO—O-c-Pr | H | OH | OAc | OH | H | |
| 1164 | CO—O— | H | OH | OAc | OH | H | |
| | CH₂CH₂OH | | | | | | |
| 1165 | CO—O—C₈H₁₇ | H | OH | OAc | OH | H | |
| 1166 | CO—O—C₁₂H₂₅ | H | OH | OAc | OH | H | |
| 1167 | CO—O—C₁₆H₃₃ | H | OH | OAc | OH | H | |
| 1168 | CO—NH₂ | H | OH | OAc | OH | H | |
| 1169 | CO—NHMe | H | OH | OAc | OH | H | |
| 1170 | CO—NHEt | H | OH | OAc | OH | H | |
| 1171 | CO—NH-n-Pr | H | OH | OAc | OH | H | |
| 1172 | CO—NH-i-Pr | H | OH | OAc | OH | H | |
| 1173 | CO—NH-c-Pr | H | OH | OAc | OH | H | |
| 1174 | CO—NH-n-Pr | H | OH | OAc | OH | H | |
| 1175 | CO—NH-n-Bu | H | OH | OAc | OH | H | |
| 1176 | CO—NMe₂ | H | OH | OAc | OH | H | |
| 1177 | CO—NEt₂ | H | OH | OAc | OH | H | |
| 1178 | CO—NHNH₂ | H | OH | OAc | OH | H | |
| 1179 | CN | H | OH | OAc | OH | H | |
| 1180 | CO—OH | H | OAc | OAc | OH | H | |
| 1181 | CO—OMe | H | OAc | OAc | OH | H | |
| 1182 | CO—OEt | H | OAc | OAc | OH | H | |
| 1183 | CO—O-n-Pr | H | OAc | OAc | OH | H | |
| 1184 | CO—O-n-Bu | H | OAc | OAc | OH | H | |
| 1185 | CO—O-i-Pen | H | OAc | OAc | OH | H | |
| 1186 | CO—O-c-Pr | H | OAc | OAc | OH | H | |
| 1187 | CO—O— | H | OAc | OAc | OH | H | |
| | CH₂CH₂OH | | | | | | |
| 1188 | CO—O—C₈H₁₇ | H | OAc | OAc | OH | H | |
| 1189 | CO—O—C₁₂H₂₅ | H | OAc | OAc | OH | H | |
| 1190 | CO—O—C₁₆H₃₃ | H | OAc | OAc | OH | H | |
| 1191 | CO—NH₂ | H | OAc | OAc | OH | H | |
| 1192 | CO—NHMe | H | OAc | OAc | OH | H | |
| 1193 | CO—NHEt | H | OAc | OAc | OH | H | |
| 1194 | CO—NH-n-Pr | H | OAc | OAc | OH | H | |
| 1195 | CO—NH-i-Pr | H | OAc | OAc | OH | H | |
| 1196 | CO—NH-c-Pr | H | OAc | OAc | OH | H | |
| 1197 | CO—NH-n-Pr | H | OAc | OAc | OH | H | |
| 1198 | CO—NH-n-Bu | H | OAc | OAc | OH | H | |
| 1199 | CO—NMe₂ | H | OAc | OAc | OH | H | |
| 1200 | CO—NEt₂ | H | OAc | OAc | OH | H | |
| 1201 | CO—NHNH₂ | H | OAc | OAc | OH | H | |
| 1202 | CN | H | OAc | OAc | OH | H | |
| 1203 | CO—OH | H | OAc | OAc | OAc | H | |
| 1204 | CO—OMe | H | OAc | OAc | OAc | H | |
| 1205 | CO—OEt | H | OAc | OAc | OAc | H | |
| 1206 | CO—O-n-Pr | H | OAc | OAc | OAc | H | |
| 1207 | CO—O-n-Bu | H | OAc | OAc | OAc | H | |
| 1208 | CO—O-i-Pen | H | OAc | OAc | OAc | H | |
| 1209 | CO—O-c-Pr | H | OAc | OAc | OAc | H | |
| 1210 | CO—O— | H | OAc | OAc | OAc | H | |
| | CH₂CH₂OH | | | | | | |
| 1211 | CO—O—C₈H₁₇ | H | OAc | OAc | OAc | H | |
| 1212 | CO—O—C₁₂H₂₅ | H | OAc | OAc | OAc | H | |
| 1213 | CO—O—C₁₆H₃₃ | H | OAc | OAc | OAc | H | |
| 1214 | CO—NH₂ | H | OAc | OAc | OAc | H | |
| 1215 | CO—NHMe | H | OAc | OAc | OAc | H | |
| 1216 | CO—NHEt | H | OAc | OAc | OAc | H | |
| 1217 | CO—NH-n-Pr | H | OAc | OAc | OAc | H | |
| 1218 | CO—NH-i-Pr | H | OAc | OAc | OAc | H | |
| 1219 | CO—NH-c-Pr | H | OAc | OAc | OAc | H | |
| 1220 | CO—NH-n-Pr | H | OAc | OAc | OAc | H | |
| 1221 | CO—NH-n-Bu | H | OAc | OAc | OAc | H | |
| 1222 | CO—NMe₂ | H | OAc | OAc | OAc | H | |
| 1223 | CO—NEt₂ | H | OAc | OAc | OAc | H | |
| 1224 | CO—NHNH₂ | H | OAc | OAc | OAc | H | |
| 1225 | CN | H | OAc | OAc | OAc | H | |
| 1226 | CO—OH | H | OMe | OH | OH | H | |
| 1227 | CO—OMe | H | OMe | OH | OH | H | |
| 1228 | CO—OEt | H | OMe | OH | OH | H | |
| 1229 | CO—O-n-Pr | H | OMe | OH | OH | H | |
| 1230 | CO—O-n-Bu | H | OMe | OH | OH | H | |
| 1231 | CO—O-i-Pen | H | OMe | OH | OH | H | |
| 1232 | CO—O-c-Pr | H | OMe | OH | OH | H | |
| 1233 | CO—O— | H | OMe | OH | OH | H | |
| | CH₂CH₂OH | | | | | | |
| 1234 | CO—O—C₈H₁₇ | H | OMe | OH | OH | H | |
| 1235 | CO—O—C₁₂H₂₅ | H | OMe | OH | OH | H | |
| 1236 | CO—O—C₁₆H₃₃ | H | OMe | OH | OH | H | |
| 1237 | CO—NH₂ | H | OMe | OH | OH | H | |
| 1238 | CO—NHMe | H | OMe | OH | OH | H | |
| 1239 | CO—NHEt | H | OMe | OH | OH | H | |
| 1240 | CO—NH-n-Pr | H | OMe | OH | OH | H | |
| 1241 | CO—NH-i-Pr | H | OMe | OH | OH | H | |
| 1242 | CO—NH-c-Pr | H | OMe | OH | OH | H | |
| 1243 | CO—NH-n-Pr | H | OMe | OH | OH | H | |
| 1244 | CO—NH-n-Bu | H | OMe | OH | OH | H | |
| 1245 | CO—NMe₂ | H | OMe | OH | OH | H | |
| 1246 | CO—NEt₂ | H | OMe | OH | OH | H | |
| 1247 | CO—NHNH₂ | H | OMe | OH | OH | H | |
| 1248 | CN | H | OMe | OH | OH | H | |
| 1249 | CO—OH | H | OH | OMe | OH | H | |
| 1250 | CO—OMe | H | OH | OMe | OH | H | |
| 1251 | CO—OEt | H | OH | OMe | OH | H | |
| 1252 | CO—O-n-Pr | H | OH | OMe | OH | H | |
| 1253 | CO—O-n-Bu | H | OH | OMe | OH | H | |
| 1254 | CO—O-i-Pen | H | OH | OMe | OH | H | |
| 1255 | CO—O-c-Pr | H | OH | OMe | OH | H | |
| 1256 | CO—O— | H | OH | OMe | OH | H | |
| | CH₂CH₂OH | | | | | | |
| 1257 | CO—O—C₈H₁₇ | H | OH | OMe | OH | H | |
| 1258 | CO—O—C₁₂H₂₅ | H | OH | OMe | OH | H | |
| 1259 | CO—O—C₁₆H₃₃ | H | OH | OMe | OH | H | |
| 1260 | CO—NH₂ | H | OH | OMe | OH | H | |
| 1261 | CO—NHMe | H | OH | OMe | OH | H | |
| 1262 | CO—NHEt | H | OH | OMe | OH | H | |
| 1263 | CO—NH-n-Pr | H | OH | OMe | OH | H | |
| 1264 | CO—NH-i-Pr | H | OH | OMe | OH | H | |
| 1265 | CO—NH-c-Pr | H | OH | OMe | OH | H | |
| 1266 | CO—NH-n-Pr | H | OH | OMe | OH | H | |
| 1267 | CO—NH-n-Bu | H | OH | OMe | OH | H | |
| 1268 | CO—NMe₂ | H | OH | OMe | OH | H | |
| 1269 | CO—NEt₂ | H | OH | OMe | OH | H | |
| 1270 | CO—NHNH₂ | H | OH | OMe | OH | H | |
| 1271 | CN | H | OH | OMe | OH | H | |
| 1272 | CO—OH | H | OMe | OH | OMe | H | |
| 1273 | CO—OMe | H | OMe | OH | OMe | H | |
| 1274 | CO—OEt | H | OMe | OH | OMe | H | |
| 1275 | CO—O-n-Pr | H | OMe | OH | OMe | H | |
| 1276 | CO—O-n-Bu | H | OMe | OH | OMe | H | |
| 1277 | CO—O-i-Pen | H | OMe | OH | OMe | H | |
| 1278 | CO—O-c-Pr | H | OMe | OH | OMe | H | |
| 1279 | CO—O— | H | OMe | OH | OMe | H | |
| | CH₂CH₂OH | | | | | | |
| 1280 | CO—O—C₈H₁₇ | H | OMe | OH | OMe | H | |
| 1281 | CO—O—C₁₂H₂₅ | H | OMe | OH | OMe | H | |
| 1282 | CO—O—C₁₆H₃₃ | H | OMe | OH | OMe | H | |
| 1283 | CO—NH₂ | H | OMe | OH | OMe | H | |
| 1284 | CO—NHMe | H | OMe | OH | OMe | H | |
| 1285 | CO—NHEt | H | OMe | OH | OMe | H | |
| 1286 | CO—NH-n-Pr | H | OMe | OH | OMe | H | |
| 1287 | CO—NH-i-Pr | H | OMe | OH | OMe | H | |
| 1288 | CO—NH-c-Pr | H | OMe | OH | OMe | H | |
| 1289 | CO—NH-n-Pr | H | OMe | OH | OMe | H | |
| 1290 | CO—NH-n-Bu | H | OMe | OH | OMe | H | |
| 1291 | CO—NMe₂ | H | OMe | OH | OMe | H | |
| 1292 | CO—NEt₂ | H | OMe | OH | OMe | H | |
| 1293 | CO—NHNH₂ | H | OMe | OH | OMe | H | |
| 1294 | CN | H | OMe | OH | OMe | H | |
| 1295 | CO—OH | H | OH | OMe | OMe | H | |
| 1296 | CO—OMe | H | OH | OMe | OMe | H | |
| 1297 | CO—OEt | H | OH | OMe | OMe | H | |
| 1298 | CO—O-n-Pr | H | OH | OMe | OMe | H | |
| 1299 | CO—O-n-Bu | H | OH | OMe | OMe | H | |
| 1300 | CO—O-i-Pen | H | OH | OMe | OMe | H | |
| 1301 | CO—O-c-Pr | H | OH | OMe | OMe | H | |
| 1302 | CO—O— | H | OH | OMe | OMe | H | |
| | CH₂CH₂OH | | | | | | |
| 1303 | CO—O—C₈H₁₇ | H | OH | OMe | OMe | H | |
| 1304 | CO—O—C₁₂H₂₅ | H | OH | OMe | OMe | H | |
| 1305 | CO—O—C₁₆H₃₃ | H | OH | OMe | OMe | H | |
| 1306 | CO—NH₂ | H | OH | OMe | OMe | H | |
| 1307 | CO—NHMe | H | OH | OMe | OMe | H | |
| 1308 | CO—NHEt | H | OH | OMe | OMe | H | |
| 1309 | CO—NH-n-Pr | H | OH | OMe | OMe | H | |
| 1310 | CO—NH-i-Pr | H | OH | OMe | OMe | H | |
| 1311 | CO—NH-c-Pr | H | OH | OMe | OMe | H | |
| 1312 | CO—NH-n-Pr | H | OH | OMe | OMe | H | |
| 1313 | CO—NH-n-Bu | H | OH | OMe | OMe | H | |
| 1314 | CO—NMe₂ | H | OH | OMe | OMe | H | |
| 1315 | CO—NEt₂ | H | OH | OMe | OMe | H | |
| 1316 | CO—NHNH₂ | H | OH | OMe | OMe | H | |
| 1317 | CN | H | OH | OMe | OMe | H | |
| 1318 | CO—OH | H | OMe | OAc | OAc | H | |
| 1319 | CO—OMe | H | OMe | OAc | OAc | H | |
| 1320 | CO—OEt | H | OMe | OAc | OAc | H | |
| 1321 | CO—O-n-Pr | H | OMe | OAc | OAc | H | |
| 1322 | CO—O-n-Bu | H | OMe | OAc | OAc | H | |
| 1323 | CO—O-i-Pen | H | OMe | OAc | OAc | H | |
| 1324 | CO—O-c-Pr | H | OMe | OAc | OAc | H | |
| 1325 | CO—O— | H | OMe | OAc | OAc | H | |
| | CH₂CH₂OH | | | | | | |
| 1326 | CO—O—C₈H₁₇ | H | OMe | OAc | OAc | H | |
| 1327 | CO—O—C₁₂H₂₅ | H | OMe | OAc | OAc | H | |
| 1328 | CO—O—C₁₆H₃₃ | H | OMe | OAc | OAc | H | |
| 1329 | CO—NH₂ | H | OMe | OAc | OAc | H | |
| 1330 | CO—NHMe | H | OMe | OAc | OAc | H | |
| 1331 | CO—NHEt | H | OMe | OAc | OAc | H | |
| 1332 | CO—NH-n-Pr | H | OMe | OAc | OAc | H | |
| 1333 | CO—NH-i-Pr | H | OMe | OAc | OAc | H | |
| 1334 | CO—NH-c-Pr | H | OMe | OAc | OAc | H | |
| 1335 | CO—NH-n-Pr | H | OMe | OAc | OAc | H | |
| 1336 | CO—NH-n-Bu | H | OMe | OAc | OAc | H | |
| 1337 | CO—NMe₂ | H | OMe | OAc | OAc | H | |
| 1338 | CO—NEt₂ | H | OMe | OAc | OAc | H | |
| 1339 | CO—NHNH₂ | H | OMe | OAc | OAc | H | |
| 1340 | CN | H | OMe | OAc | OAc | H | |
| 1341 | CO—OH | H | OMe | OAc | OAc | H | |
| 1342 | CO—OMe | H | OMe | OAc | OAc | H | |
| 1343 | CO—OEt | H | OMe | OAc | OAc | H | |
| 1344 | CO—O-n-Pr | H | OMe | OAc | OAc | H | |
| 1345 | CO—O-n-Bu | H | OMe | OAc | OAc | H | |
| 1346 | CO—O-i-Pen | H | OMe | OAc | OAc | H | |
| 1347 | CO—O-c-Pr | H | OMe | OAc | OAc | H | |
| 1348 | CO—O— | H | OMe | OAc | OAc | H | |
| | CH₂CH₂OH | | | | | | |
| 1349 | CO—O—C₈H₁₇ | H | OMe | OAc | OAc | H | |
| 1350 | CO—O—C₁₂H₂₅ | H | OMe | OAc | OAc | H | |
| 1351 | CO—O—C₁₈H₃₃ | H | OMe | OAc | OAc | H | |
| 1352 | CO—NH₂ | H | OMe | OAc | OAc | H | |
| 1353 | CO—NHMe | H | OMe | OAc | OAc | H | |
| 1354 | CO—NHEt | H | OMe | OAc | OAc | H | |
| 1355 | CO—NH-n-Pr | H | OMe | OAc | OAc | H | |
| 1356 | CO—NH-i-Pr | H | OMe | OAc | OAc | H | |
| 1357 | CO—NH-c-Pr | H | OMe | OAc | OAc | H | |
| 1358 | CO—NH-n-Pr | H | OMe | OAc | OAc | H | |
| 1359 | CO—NH-n-Bu | H | OMe | OAc | OAc | H | |
| 1360 | CO—NMe₂ | H | OMe | OAc | OAc | H | |
| 1361 | CO—NEt₂ | H | OMe | OAc | OAc | H | |
| 1362 | CO—NHNH₂ | H | OMe | OAc | OAc | H | |
| 1363 | CO—OH | H | OAc | OMe | OH | H | |
| 1364 | CO—OMe | H | OAc | OMe | OH | H | |
| 1365 | CO—OEt | H | OAc | OMe | OH | H | |
| 1366 | CO—O-n-Pr | H | OAc | OMe | OH | H | |
| 1367 | CO—O-n-Bu | H | OAc | OMe | OH | H | |
| 1368 | CO—O-i-Pen | H | OAc | OMe | OH | H | |
| 1369 | CO—O-c-Pr | H | OAc | OMe | OH | H | |
| 1370 | CO—O— | H | OAc | OMe | OH | H | |
| | CH₂CH₂OH | | | | | | |
| 1371 | CO—O—C₈H₁₇ | H | OAc | OMe | OH | H | |
| 1372 | CO—O—C₁₂H₂₅ | H | OAc | OMe | OH | H | |
| 1373 | CO—O—C₁₆H₃₃ | H | OAc | OMe | OH | H | |
| 1374 | CO—NH₂ | H | OAc | OMe | OH | H | |
| 1375 | CO—NHMe | H | OAc | OMe | OH | H | |
| 1376 | CO—NHEt | H | OAc | OMe | OH | H | |
| 1377 | CO—NH-n-Pr | H | OAc | OMe | OH | H | |
| 1378 | CO—NH-i-Pr | H | OAc | OMe | OH | H | |
| 1379 | CO—NH-c-Pr | H | OAc | OMe | OH | H | |
| 1380 | CO—NH-n-Pr | H | OAc | OMe | OH | H | |
| 1381 | CO—NH-n-Bu | H | OAc | OMe | OH | H | |
| 1382 | CO—NMe₂ | H | OAc | OMe | OH | H | |
| 1383 | CO—NEt₂ | H | OAc | OMe | OH | H | |
| 1384 | CO—NHNH₂ | H | OAc | OMe | OH | H | |
| 1385 | CN | H | OAc | OMe | OH | H | |
| 1386 | CO—OH | H | OAc | OMe | OAc | H | |
| 1387 | CO—OMe | H | OAc | OMe | OAc | H | |
| 1388 | CO—OEt | H | OAc | OMe | OAc | H | |
| 1389 | CO—O-n-Pr | H | OAc | OMe | OAc | H | |
| 1390 | CO—O-n-Bu | H | OAc | OMe | OAc | H | |
| 1391 | CO—O-i-Pen | H | OAc | OMe | OAc | H | |
| 1392 | CO—O-c-Pr | H | OAc | OMe | OAc | H | |
| 1393 | CO—O— | H | OAc | OMe | OAc | H | |
| | CH₂CH₂OH | | | | | | |
| 1394 | CO—O—C₈H₁₇ | H | OAc | OMe | OAc | H | |
| 1395 | CO—O—C₁₂H₂₅ | H | OAc | OMe | OAc | H | |
| 1396 | CO—O—C₁₆H₃₃ | H | OAc | OMe | OAc | H | |
| 1397 | CO—NH₂ | H | OAc | OMe | OAc | H | |
| 1398 | CO—NHMe | H | OAc | OMe | OAc | H | |
| 1399 | CO—NHEt | H | OAc | OMe | OAc | H | |
| 1400 | CO—NH-n-Pr | H | OAc | OMe | OAc | H | |
| 1401 | CO—NH-i-Pr | H | OAc | OMe | OAc | H | |
| 1402 | CO—NH-c-Pr | H | OAc | OMe | OAc | H | |
| 1403 | CO—NH-n-Pr | H | OAc | OMe | OAc | H | |
| 1404 | CO—NH-n-Bu | H | OAc | OMe | OAc | H | |
| 1405 | CO—NMe₂ | H | OAc | OMe | OAc | H | |
| 1406 | CO—NEt₂ | H | OAc | OMe | OAc | H | |
| 1407 | CO—NHNH₂ | H | OAc | OMe | OAc | H | |
| 1408 | CN | H | OAc | OMe | OAc | H | |

In table 1:
Comp. = compound
c = cyclo
i = iso
n = normal (straight-chain)
s = secondary
t = tertiary
Ac = acetyl
Bu = n-butyl
n-Bu = n-butyl
Et = ethyl
Me = methyl
n-Pr = n-propyl
i-Pr = isopropyl
c-Pr = cyclopropyl
i-Pen = isopentyl

B) Biological examples

B1) Herbicide and safener in tank mix as spray application

B1.1) Herbicide and safener pre-emergence application by the tank mix method

Seeds of various crop plants and weed species were sown in sandy loam soil in plastic pots of a diameter of 13 cm and covered with a layer of sandy loam of a thickness of about 1 cm. Herbicides and safeners in the form of liquid (for example emulsion concentrates) or dry (for example water-dispersible powders) formulations were diluted with deionized water to the required concentration and applied to the surface of the soil with a spray bar using a water application rate of 300 liters per hectare. In the experiment shown below, the safeners were used as 20 percent strength water-dispersible powders and the herbicide isoxaflutole was used as an aqueous suspension concentrate (see table 1.1.1).

The pots were placed in a greenhouse under favorable growth conditions. Visual scoring of the herbicidal action was carried out four weeks after the herbicide application. Evaluation was carried out on a percentage basis by comparison with untreated control plants (0%=no noticeable effect compared with the untreated plant, 100%=treated plant dies).

TABLE 1.1.1
Pre-emergence application: herbicide and safener in the tank mix
method

| | Application | Herbicide | | Safener | | |
|---|---|---|---|---|---|---|
| | rate of | H1 pre- | % | action as | Herbicidal | Herbicidal |
| | safener | emergence | damage | % damage | action in | action in |
| | [g of | application | in | reduction | SETVI | CHEAL |
| Safener | a.i./ha] | [g of a.i./ha] | ZEAMA | in ZEAMA | (in %) | (in %) |
| — | — | 100 | 25 | — | 96 | 94 |
| Comp. 1272 | 250 | 100 | 12 | 52 | 98 | 94 |
| Comp. 1050 | 250 | 100 | 3 | 88 | 96 | 97 |

Abbreviations:
Herbicide H1 = isoxaflutole
Comp. 1272 = 3,5-dimethoxy-4-hydroxybenzoic acid (cf. tab. 1)
Comp. 1050 = 3,5-dihydroxybenzoic acid (cf. tab. 1)
ZEAMA = Zea mays (corn), cv. ‘Lorenzo’
SETVI = Setaria viridis
CHEAL = Chenopodium album

B1.2) Post-emergence application of herbicide and safener by the tank mix method

Seeds of various crop plants and weed species were sown in sandy loam soil in round plastic pots of a diameter of 13 cm and covered with a layer of sandy loam of a thickness of about 1 cm. The pots were placed in a greenhouse under favorable growth conditions for a period of about two to three weeks, allowing the plants to reach a growth stage of 2 to 4 leaves. The herbicides in the form of liquid (for example emulsion concentrates) or dry (for example water-dispersible powders) formulations were mixed with a standard additive (based on rapeseed oil methyl ester), diluted with deionized water to the required concentrations and applied to the green parts of the plants and the uncovered part of the soil surface with a spray bar using a water application rate of 300 liters per hectare. In the experiment shown below, safener and the herbicide foramsulfuron were in each case used as 20 percent strength water-dispersible powder (results see table 1.2.1).

The pots were placed in a greenhouse under favorable growth conditions. Visual scoring of the herbicidal action was carried out four weeks after the herbicide application. Evaluation was carried out on a percentage basis by comparison with untreated control plants (0%=no noticeable effect compared with the untreated plant, 100%=treated plant dies).

TABLE 1.2.1
Post-emergence application: Herbicide and safener in tank mix
method

| | | | | Safener | | |
|---|---|---|---|---|---|---|
| | Application | Herbicide | | action as | | |
| | rate of | H2 post- | % | % damage | Herbicidal | Herbicidal |
| | safener | emergence | damage | reduction | action as % | action as |
| | [g of | application | in | in crop | damage | % damage |
| Safener | a.i./ha] | [g of a.i./ha] | ZEAMA | plants | in SETVI | in AMARE |
| — | — | 40 | 32 | — | 93 | 90 |
| Comp. 1272 | 250 | 40 | 15 | 53 | 95 | 92 |
| Comp. 1050 | 250 | 40 | 10 | 69 | 97 | 90 |

Abbreviations:
Herbicide H2 = foramsulfuron
Comp. 1272 = 3,5-dimethoxy-4-hydroxybenzoic acid (cf. tab. 1)
Comp. 1050 = 3,5-dihydroxybenzoic acid (cf. tab. 1)
ZEAMA = Zea mays (corn), cv. ‘Lorenzo’
SETVI = Setaria viridis
AMARE = Amaranthus retroflexus

B2) Safener as seed dressing followed by a spray application of herbicide

B2.1) Seed dressing

The number of crop plant seeds required for each application rate of safener was calculated. Sufficient seeds were weighed out into glass bottles having a screw-on lid. The volume of the glass bottles was approximately twice that of the seeds weighed out.

The safeners were formulated as 20 percent strength water-dispersible powders. These formulations were weighed out to give the required application rates (g of a.i./kg of seed). The samples were added to the seeds in the glass containers, and sufficient water to form a suitable seed dressing was then added. The glass bottles were closed and then mounted in an overhead shaker (which turns the bottles at moderate speed for a period of up to one hour) so that the seeds were uniformly covered with the seed dressing. The bottles were opened and the seeds were ready for use in pre-emergence or post-emergence experiments, as described below.

B2.2) Pre-emergence application of herbicides after seed dressing with safener

The seeds which had been treated with safeners and untreated seeds as controls were sown in sandy loam soil in round plastic pots of a diameter of 13 cm and covered with a layer of sandy loam of a thickness of about 1 cm. The herbicides in the form of liquid (for example emulsion concentrates) or dry (for example water-dispersible powders) formulations were diluted with deionized water to the required concentrations and applied to the surface of the soil with a spray bar using a water application rate of 300 liters per hectare. In the two experiments shown below (results see tables 2.2.1 and 2.2.2), the herbicide isoxaflutole was used as an aqueous suspension concentrate.

The pots were placed in a greenhouse under favorable growth conditions. Visual scoring of the herbicidal action was carried out four weeks after the herbicide application. Evaluation was carried out on a percentage basis by comparison with untreated control plants (0%=no noticeable effect compared with the untreated plant, 100%=treated plant dies).

TABLE 2.2.1
Herbicide by the pre-emergence method after seed dressing with
safener

| Safener | Application rate | Herbicide H1 | | Safener action |
|---|---|---|---|---|
| for | of safener | pre-emergence | % damage | as % damage |
| seed | [g of a.i./kg of | application | in | reduction in |
| dressing | seed] | [g of a.i./ha] | ZEAMA | crop plants |
| — | — | 100 | 20 | — |
| Comp. | 1 | 100 | 10 | 50 |
| 1272 | | | | |
| Comp. | 1 | 100 | 5 | 75 |
| 1050 | | | | |

TABLE 2.2.2
Herbicide by the pre-emergence method after seed dressing with
safener

| | Application | | | Safener |
|---|---|---|---|---|
| Safener | rate of | Herbicide H1 | | action |
| for | safener | pre-emergence | % damage | as % damage |
| seed | [g of a.i./kg of | application | in | reduction in |
| dressing | seed] | [g of a.i./ha] | GLXMA | crop plants |
| — | — | 100 | 78 | — |
| Comp. 1272 | 1 | 100 | 35 | 55 |
| Comp. 1050 | 1 | 100 | 28 | 64 |

Abbreviations in tables 2.2.1 and 2.2.2:
Herbicide H1 = isoxaflutole
Comp. 1272 = 3,5-dimethoxy-4-hydroxybenzoic acid (cf. tab. 1)
Comp. 1050 = 3,5-dihydroxybenzoic acid (cf. tab. 1)
ZEAMA = Zea mays (corn), cv. ‘Lorenzo’
GLXMA = Glycine max (soybean), cv. ‘Lambert’

B2.3) Post-emergence application of herbicides after seed dressing with safener

The seeds treated with safener and untreated seeds were sown in sandy loam soil in round plastic pots of a diameter of 13 cm and covered with a layer of sandy loam of a thickness of about 1 cm. The pots were placed in a greenhouse under favorable growth conditions for a period of about two to three weeks, allowing the plants to reach a growth stage of 2 to 4 leaves. The herbicides in the form of liquid (for example emulsion concentrates) or dry (for example water-dispersible powders) formulations were mixed with a standard additive (based on rapeseed oil methyl ester), diluted with deionized water to the required concentrations and applied to the green parts of the plants and the uncovered part of the soil surface with a spray bar using a water application rate of 300 liters per hectare. In the experiment shown below, safener and the herbicide foramsulfuron were in each case used as 20 percent strength water-dispersible powder (results see table 2.3.1).

The pots were placed in a greenhouse under favorable growth conditions. Visual scoring of the herbicidal action was carried out four weeks after the herbicide application. Evaluation was carried out on a percentage base by comparison with untreated control plants (0%=no noticeable effect compared with the untreated plant, 100%=treated plant dies).

TABLE 2.3.1
Post-emergence application of herbicide after seed dressing with
safener

| | Application | Herbicide H2 | | Safener |
|---|---|---|---|---|
| | rate of | post- | | action |
| | safener | emergence | % damage | as % damage |
| Safener For | [g of a.i./kg of | application | in | reduction in |
| seed dressing | seed] | [g of a.i./ha] | ZEAMA | crop plants |
| — | — | 40 | 35 | — |
| Comp. 1272 | 1 | 40 | 7.5 | 79 |
| Comp. 1050 | 1 | 40 | 5 | 86 |

Abbreviations:
Herbicide H2 = foramsulfuron
Comp. 1272 = 3,5-dimethoxy-4-hydroxybenzoic acid (cf. tab. 1)
Comp. 1050 = 3,5-dihydroxybenzoic acid (cf. tab. 1)
ZEAMA = Zea mays (corn), cv. ‘Lorenzo’

1. A method for protecting useful plants or crop plants against phytotoxic side effects of agrochemicals, which comprises applying, as safeners or resistance inductors, an effective amount of one or more compounds of the formula (I) or salts thereof, before, after or simultaneously with the agrochemicals to the plants, parts of plants, plant seeds or propagation material, 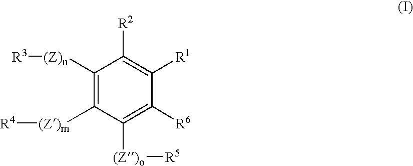
where
R¹ is carboxyl or a derivative of the carboxyl group,
R² and R⁶, in each case independently of one another, are hydrogen, halogen, SCN, CN or an unsubstituted or substituted hydrocarbon radical,
R³ (a) in the case that n=0 is a radical selected from the group consisting of hydrogen, halogen, SCN and CN or a radical of the formula A¹ or B¹ or
(b) in the case that n=1 is hydrogen or a radical of the formula A¹, B¹ or C¹ and
R⁴ (a) in the case that m=0 is a radical selected from the group consisting of hydrogen, halogen, SCN and CN or a radical of the formula A² or B² or
(b) in the case that m=1 is hydrogen or a radical of the formula A², B² or C² and R⁵ (a) in the case that o=0 is hydrogen or a radical of the formula A³ or B³ or (b) in the case that o=1 is hydrogen or a radical of the formula A³, B³ or C³, where each of the radicals A¹, A², A³, in each case independently of one another, is an unsubstituted or substituted hydrocarbon radical,
each of the radicals B¹, B², B³, in each case independently of one another, is an acyl radical and
each of the radicals C¹, C², C³, in each case independently of one another, is an unsubstituted or substituted heterocyclic radical,
Z, Z′, Z″, in each case independently of one another, are a group of the formula O, S(O)ₓ, or NR′,
where x=0, 1 or 2 and R′ is hydrogen or an unsubstituted or substituted hydrocarbon radical or an unsubstituted or substituted hydrocarbonoxy radical or acyl or acyloxy,
m is an integer 0 or 1,
n is an integer 0 or 1 and
o is an integer 0 or 1,
where the sum m+n+o is an integer 1, 2 or 3 and, in the case of the alternatives (b) defined above, at least one of the radicals R³, R⁴ and R⁵ is selected from radicals from the group consisting of hydrogen and B¹, B² and B³, respectively.

2. The method as claimed in claim 1, wherein
R¹ is a radical of the formula
—CN
—C(═X)-Y—R or
—C(═X)-Het,
in which
X is a divalent radical of the formula O, S or NR^{a} or N—NR^{a}R^{b}, where R^{a} and R^{b} are as defined below,
Y is a group of the formula O, S, NR^{c} or NR^{c}—NR^{d}R^{e}, where R^{C}, R^{d} and R^{e} are as defined below,
R is hydrogen or an unsubstituted or substituted hydrocarbon radical or an unsubstituted or substituted heterocyclic radical or acyl, and
Het is an aliphatic N-heterocycle having a total of 1 to 4 heterocyclic ring atoms which is attached via a heterocyclic ring N-atom to the group C(═X) and which optionally contains, as heterocyclic ring atoms, in addition to the N-atom in the yl-position, further heteroatoms selected from the group consisting of N, O and S, and which is unsubstituted or substituted,
where each of the radicals R^{a}, R^{b}, R^{C}, R^{d} and R^{e} in the radicals X and Y is, in each case independently of one another and independently of the radical R, as defined for R or is a radical of the formula —OR*, where R* is, independently of R, as defined for R.

3. The method as claimed in claim 1, wherein
R¹ is a radical of the formula —C(═X)-Y—R or —C(═X)-Het,
in which
X is a divalent radical of the formula O, S or NR^{a} or N—NR^{a}R^{b}, where R^{a} and R^{b} are as defined below,
Y is a group of the formula O, S, NR^{c} or NR^{c}—NR^{d}R^{e}, where R^{C}, R^{d} and R^{e} are as defined below,
R is hydrogen, (C₁-C₈)-alkyl, (C₂-C₁₈)-alkenyl, (C₂-C₁₈)-alkynyl, (C₃-C₉)-cycloalkyl, (C₅-C₉)-cycloalkenyl, (C₃-C₉)-cycloalkyl-(C₁-C₁₂)-alkyl, phenyl, phenyl-(C₁-C₁₂)-alkyl, heterocyclyl or heterocyclyl-(C₁-C₁₂)-alkyl,
where each of the 10 last-mentioned radicals is unsubstituted or substituted by one or more radicals selected from the group consisting of halogen, hydroxyl, amino, cyano, nitro, thiocyanato, (C₁-C₄)-alkoxy, (C₁-C₄)-haloalkoxy, (C₂-C₄)-alkenyloxy, (C₂-C₄)— haloalkenyloxy, (C₁-C₄)-alkylthio, (C₁-C₄)-alkylsulfinyl, (C₁-C₄)-alkylsulfonyl, (C₁-C₄)-haloalkylsulfinyl, (C₁-C₄)-haloalkylsulfonyl, mono-(C₁-C₄)-alkylamino, di-(C₁-C₄)-alkylamino, (C₁-C₄)-alkanoyl, (C₁—C₄)-haloalkanoyl, [(C₁-C₄)-alkoxy]carbonyl, [(C₁-C₄)-halo-alkoxy]carbonyl, aminocarbonyl, mono-[(C₁-C₄)-alkylamino]carbonyl, di-[(C₁-C₄)-alkylamino]carbonyl and, in the case of cyclic radicals, also (C₁-C₄)-alkyl and (C₁-C₄)-haloalkyl, or
(C₁-C₆)-alkanoyl, (C₁-C₄)-haloalkanoyl, [(C₁-C₄)-alkoxy]carbonyl, [(C₁-C₄)— haloalkoxy]carbonyl, phenylcarbonyl, phenoxycarbonyl, [phenyl-(C₁-C₄)-alkyl]carbonyl, [phenyl-(C₁-C₄)-alkoxy]carbonyl, where the phenyl ring of each of the 4 last-mentioned radicals is unsubstituted or substituted, aminocarbonyl, mono-[(C₁-C₄)-alkylamino]carbonyl, di-[(C₁-C₄)-alkylamino]carbonyl, (C₁-C₄)-alkylsulfinyl, (C₁-C₄)-alkylsulfonyl, (C₁-C₄)— haloalkylsulfinyl or (C₁-C₄)-haloalkylsulfonyl, and, including substituents, has 1 to 30 C-atoms, and
Het is an aliphatic N-heterocycle having a total of 1 to 3 heterocyclic ring atoms and a total of 5 or 6 ring atoms, which is attached via a heterocyclic ring N-atom to the group C(═X) and which optionally contains, as heterocyclic ring atoms, in addition to the N-atom in the yl-position, further heteroatoms selected from the group consisting of N, O and S and which is unsubstituted or substituted by one or more radicals selected from the group consisting of halogen, hydroxyl, amino, (C₁-C₄)-alkyl, (C₁-C₄)-alkoxy, (C₁-C₄)-!haloalkyl, (C₁-C₄)-haloalkoxy, (C₁-C₄)-alkylthio and oxo,
where each of the radicals R^{a}, R^{b}, R^{C}, R^{d} and R^{e} in the radicals X and Y, in each case independently of one another and independently of the radical R, is as defined for R or a radical of the formula —OR*, where R*, independently of R, is as defined for R, and
R² and R⁶, in each case independently of one another, are hydrogen, halogen, SCN, CN, (C₁-C₄)-alkyl, (C₂-C₄)-alkenyl, (C₂-C₄)-alkynyl or (C₃-C₆)-cycloalkyl,
where each of the 4 last mentioned radicals is unsubstituted or substituted by one or more radicals selected from the group consisting of halogen, hydroxyl, amino, cyano, nitro, thiocyanato, (C₁-C₄)-alkoxy, (C₁-C₄)-haloalkoxy, (C₁-C₄)-alkylthio, (C₁-C₄)-alkylsulfinyl, (C₁-C₄)-alkylsulfonyl, (C₁-C₄)-haloalkylsulfinyl, (C₁-C₄)-haloalkylsulfonyl, mono-(C₁-C₄)-alkylamino, di-(C₁-C₄)-alkylamino, (C₁-C₄)-alkanoyl, (C₁-C₄)-haloalkanoyl, [(C₁-C₄)-alkoxy]carbonyl, [(C₁-C₄)-haloalkoxy]carbonyl, aminocarbonyl, mono-[(C₁-C₄)-alkylamino]carbonyl, di-[(C₁-C₄)-alkylamino]carbonyl and, in the case of cyclic radicals, also (C₁-C₄)-alkyl and (C₁-C₄)-haloalkyl, and
R³ (a) in the case that n=0 is a radical selected from the group consisting of hydrogen, halogen, SCN and CN or a radical of the formula A¹ or B¹ or
(b) in the case that n 1 is hydrogen or a radical of the formula A¹, B¹ or C¹ and
R⁴ (a) in the case that m=0 is a radical selected from the group consisting of hydrogen, halogen, SCN and CN or a radical of the formula A² or B² or
(b) in the case that m=1 is hydrogen or a radical of the formula A², B² or c² and
R⁵ (a) in the case that o=0 is hydrogen or a radical of the formula A³ or B³ or
(b) in the case that o=1 is hydrogen or a radical of the formula A³, B³ or C³,
where each of the radicals A¹, A², A³, in each case independently of one another, is hydrogen, (C₁-C₈)-alkyl, (C₂-C₁₈)-alkenyl, (C₂-C₁₈)-alkynyl, (C₃-C₉)-cycloalkyl, (C₅-C₉)-cycloalkenyl, (C₃-C₉)-cycloalkyl-(C₁-C₁₂)-alkyl, phenyl, phenyl-(C₁-C₁₂)-alkyl, heterocyclyl or heterocyclyl-(C₁-C₁₂)-alkyl,
where each of the 10 last-mentioned radicals is unsubstituted or substituted by one or more radicals selected from the group consisting of halogen, hydroxyl, amino, cyano, nitro, thiocyanato, (C₁-C₄)-alkoxy, (C₁-C₄)— haloalkoxy, (C₂-C₄)-alkenyloxy, (C₂-C₄)-haloalkenyloxy, (C₁-C₄)-alkylthio, (C₁-C₄)-alkylsulfinyl, (C₁-C₄)-alkylsulfonyl, (C₁-C₄)-haloalkylsulfinyl, (C₁-C₄)-haloalkylsulfonyl, mono-(C₁-C₄)-alkylamino, di-(C₁-C₄)-alkylamino, (C₁-C₄)-alkanoyl, (C₁-C₄)-haloalkanoyl, [(C₁-C₄)-alkoxy]carbonyl, [(C₁-C₄)— haloalkoxy]carbonyl, aminocarbonyl, mono-[(C₁-C₄)-alkylamino]carbonyl, di-[(C₁-C₄)-alkylamino]carbonyl and, in the case of cyclic radicals, also (C₁-C₄)-alkyl and (C₁-C₄)-haloalkyl, and
where each of the radicals B¹, B², B³, in each case independently of one another, is (C₁-C₆)-alkanoyl, (C₁-C₄)-haloalkanoyl, [(C₁-C₄)-alkoxy]carbonyl, [(C₁-C₄)-haloalkoxy]carbonyl, phenylcarbonyl, phenoxycarbonyl, [phenyl-(C₁-C₄)-alkyl]carbonyl, [phenyl-(C₁-C₄)-alkoxy]carbonyl, where the phenyl ring of each of the 4 last-mentioned radicals is optionally unsubstituted or substituted, aminocarbonyl, mono-[(C₁-C₄)-alkylamino]carbonyl, di-[(C₁-C₄)-alkylamino]-carbonyl, (C₁-C₄)-alkylsulfinyl, (C₁-C₄)-alkylsulfonyl, (C₁-C₄)-haloalkylsulfinyl or (C₁-C₄)-haloalkylsulfonyl and
where each of the radicals C¹, C², C³, in each case independently of one another, is an aliphatic or aromatic heterocycle having a total of 1 to 3 heterocyclic ring atoms selected from the group consisting of N, O and S and a total of 5 or 6 ring atoms, which is unsubstituted or substituted by one or more radicals selected from the group consisting of halogen, hydroxyl, amino, (C₁-C₄)-alkyl, (C₁-C₄)-alkoxy, (C₁-C₄)-haloalkyl, (C₁-C₄)-haloalkoxy, (C₁-C₄)-alkylthio and oxo, and
Z, Z′, Z″, in each case independently of one another, are a group of the formula O, S(O)ₓ or NR′,
where x=0, 1 or 2 and R′ is hydrogen, (C₁-C₄)-alkyl, (C₂-C₄)-alkenyl, (C₂-C₄)-alkynyl, (C₃-C₆)-cycloalkyl, (C₁-C₄)-alkoxy, (C₂-C₄)-alkenyloxy, (C₂-C₄)-alkynyloxy or (C₃-C₆)-cycloalkyloxy,
where each of the 8 last-mentioned radicals is unsubstituted or substituted by one or more radicals selected from the group consisting of halogen, hydroxyl, amino, cyano, nitro, thiocyanato, (C₁-C₄)-alkoxy, (C₁-C₄)— haloalkoxy, (C₁-C₄)-alkylthio, (C₁-C₄)-alkylsulfinyl, (C₁-C₄)-alkylsulfonyl, (C—C₄)-haloalkylsulfinyl, (C₁-C₄)-haloalkylsulfonyl, mono-(C₁-C₄)-alkylamino, di-(C₁-C₄)-alkylamino, (C₁-C₄)-alkanoyl, (C₁-C₄)-haloalkanoyl, [(C₁-C₄)-alkoxy]carbonyl, [(C₁-C₄)-haloalkoxy]carbonyl, aminocarbonyl, mono-[(C₁-C₄)-alkylamino]carbonyl, di-[(C₁-C₄)-alkylamino]carbonyl and, in
the case of cyclic radicals, also (C₁-C₄)-alkyl and (C₁-C₄)-haloalkyl, or (C₁-C₆)-alkanoyl, (C₁-C₄)-haloalkanoyl, (C₁-C₆)-alkanoyloxy, (C₁-C₄)-halo-alkanoyloxy, [(C₁-C₄)-alkoxy]carbonyl, [(C₁-C₄)-haloalkoxy]carbonyl, [(C₁-C₄)alkoxy]carbonyloxy, [(C₁-C₄)-haloalkoxy]carbonyloxy, phenylcarbonyl, phenoxycarbonyl, [phenyl-(C₁-C₄)-alkyl]carbonyl, [phenyl-(C₁-C₄)-alkoxy]-carbonyl, phenylcarbonyloxy, phenoxycarbonyloxy, [phenyl-(C₁-C₄)-alkyl]-carbonyloxy or [phenyl-(C₁-C₄)-alkoxy]carbonyloxy, where the phenyl ring of each of the 8 last-mentioned radicals is unsubstituted or substituted, or aminocarbonyl, mono-[(C₁-C₄)-alkylamino]carbonyl, di-[(C₁-C₄)-alkylamino]carbonyl, (C₁-C₄)-alkylsulfinyl, (C₁-C₄)-alkylsulfonyl, (C₁-C₄)-haloalkylsulfinyl or (C₁-C₄)haloalkylsulfonyl,
m is an integer 0 or 1,
n is an integer 0 or 1 and
o is an integer 0 or 1,
where the sum m+n+o is an integer 1, 2 or 3 and, in the case of the alternatives (b) defined above, at least one of the radicals R³, R⁴ and R⁵ is selected from radicals from the group consisting of hydrogen and a radical of the formula B¹, B² and B³, respectively.

4. The method as claimed in claim 1, wherein
R³ (a) in the case that n=0 is a radical selected from the group consisting of hydrogen, halogen, SCN and CN or a radical of the formula A¹ or B¹ or
(b) in the case that n 1 is hydrogen or a radical of the formula A¹, B¹ or C¹ and
R⁴ (a) in the case that m=0 is a radical selected from the group consisting of hydrogen, halogen, SCN and CN or a radical of the formula A² or B² or
(b) in the case that m=1 is hydrogen or a radical of the formu!a A², B² or c² and
R⁵ (a) in the case that o=0 is hydrogen or a radical of the formula A³ or B³ or
(b) in the case that o=1 is hydrogen or a radical of the formula A³, B³ or C³, where each of the radicals A¹, A², A³, in each case independently of one another, is hydrogen, (C₁-C₁₂)-alkyl, (C₂-C₁₂)-alkenyl, (C₂-C₁₂)-alkynyl, (C₃-C₆)-cycloalkyl, (C₅-C₆)-cycloalkenyl, (C₃-C₆)-cycloalkyl-(C₁-C₄)-alkyl, phenyl, phenyl-(C₁-C₄)-alkyl, heterocyclyl or heterocyclyl-(C₁-C₄)-alkyl,
where each of the 10 last-mentioned radicals is unsubstituted or substituted by one or more radicals selected from the group consisting of halogen, hydroxyl, amino, (C₁-C₄)-alkoxy, (C₁-C₄)-haloalkoxy, (C₂-C₄)-alkenyloxy, (C₂-C₄)-haloalkenyloxy, (C₁-C₄)-alkylthio, (C₁-C₄)-alkylsulfinyl, (C₁-C₄)-alkylsulfonyl, (C₁-C₄)-haloalkylsulfinyl, (C₁-C₄)-haloalkylsulfonyl, mono-(C₁-C₄)-alkylamino, di-(C₁-C₄)-alkylamino, (C₁-C₄)-alkanoyl, (C₁-C₄)-haloalkanoyl, [(C₁-C₄)-alkoxy]carbonyl, [(C₁-C₄)-haloalkoxy]carbonyl, aminocarbonyl, mono-[(C₁-C₄)-alkylamino]carbonyl, di-[(C₁-C₄)-alkylamino]carbonyl and, in the case cyclic radicals, also (C₁-C₄)-alkyl and (C₁-C₄)-haloalkyl, and
where each of the radicals B¹, B², B³, in each case independently of one another, is (C₁-C₄)-alkanoyl, (C₁-C₄)-haloalkanoyl, [(C₁-C₄)-alkoxy]carbonyl, (C₁-C₄)-alkylsulfinyl, (C₁-C₄)-alkylsulfonyl, (C₁-C₄)-haloalkylsulfinyl or (C₁-C₄)-haloalkylsulfonyl and
where each of the radicals C¹, C², C³, in each case independently of one another, is an aliphatic or aromatic heterocycle having a total of 1 to 3 heterocyclic ring atoms selected from the group consisting of N, O and S and a total of 5 or 6 ring atoms, which is unsubstituted or substituted by one or more radicals selected from the group consisting of halogen, (C₁-C₄)-alkyl, (C₁-C₄)-alkoxy, (C₁-C₄)— haloalkyl, (C₁-C₄)-haloalkoxy, (C₁-C₄)-alkylthio and oxo, and
Z, Z′, Z″, in the case independently of one another, are a group of the formula O, S, SO, SO₂ or NR′,
where R′ is hydrogen, (C₁-C₄)-alkyl, (C₃-C₆)-cycloalkyl or (C₁-C₄)-alkoxy, where each of the 3 last-mentioned radicals is unsubstituted or substituted by one or more radicals selected from the group consisting of halogen, hydroxyl, (C₁-C₄)-alkoxy, (C₁-C₄)-haloalkoxy, (C₁-C₄)alkylthio and, in the case of cyclic radicals, also (C₁-C₄)-alkyl and (C₁-C₄)-haloalkyl, or
(C₁-C₆)-alkanoyl, (C₁-C₄)-haloalkanoyl, (C₁-C₆)-alkanoyloxy, (C₁-C₄)-halo-alkanoyloxy, [(C₁-C₄)-alkoxy]carbonyl, phenylcarbonyl, [phenyl-(C₁-C₄)-alkyl]-carbonyl or [phenyl-(C₁-C₄)-alkoxy]carbonyl, where the phenyl ring of each of the 3 last-mentioned radicals is unsubstituted or substituted, or (C₁-C₄)-alkylsulfinyl or (C₁-C₄)-alkylsulfonyl, and
m is an integer 0 or 1,
n is an integer 0 or 1 and
o is an integer 0 or 1,
where the sum m+n+o is an integer 1, 2 or 3 and, in the case of the alternatives (b) defined above, at least one of the radicals R³, R⁴ and R⁵ selected from radicals from the group consisting of hydrogen and a radical of the formula B¹, B² and B³, respectively.

5. The method as claimed in claim 1, wherein
R¹ is a radical of the formula
—CO—OR or
—C(═NR^{a})-OR or
—CO—NR^{C}R
where each of the radicals R, R^{a}, R^{b} and Rc is as defined.

6. The method as claimed in claim 1, wherein the compounds of the formula (I) are used as safeners against phytotoxic actions of agrochemicals in these plants.

7. The method as claimed in claim 6, wherein the compounds of the formula (I) are used as safeners against phytotoxic actions of pesticides from a group consisting of herbicides, insecticides, acaricides, nematicides and fungicides.

8. The method as claimed in claim 1, wherein the compounds of the formula (I) are used for protecting the plants against harmful environmental factors.

9. The method as claimed in claim 1, wherein the compounds of the formula (I) are used in the plants to induce resistance against infection by pathogens.

10. The method as claimed in claim 1, wherein the application is by a post-emergence method.

11. The method as claimed in claim 1, wherein the application is by treating the plant seeds or propagation material.

12. The method as claimed in claim 1, wherein the application is by a pre-emergence method.

13. A compound of the formula (I) or a salt thereof, 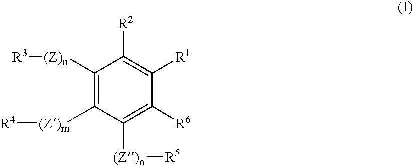
where
R¹ is a radical of the formula
—CO—OR or
—C(═NR^{a})-OR or
—CO—NR^{c}R,
R is hydrogen, (C₁-C₈)-alkyl, (C₂-C₁₈)-alkenyl, (C₂-C₁₈)-alkynyl, (C₃-C₉)-cycloalkyl, (C₅-C₉)-cycloalkenyl, (C₃-C₉)-cycloalkyl-(C₁-C₁₂)-alkyl, phenyl, phenyl-(C₁-C₁₂)-alkyl, heterocyclyl or heterocyclyl-(C₁-C₁₂)-alkyl,
where each of the 10 last-mentioned radicals is unsubstituted or substituted by one or more radicals selected from the group consisting of halogen, hydroxyl, amino, cyano, nitro, thiocyanato, (C₁-C₄)-alkoxy, (C₁-C₄)-haloalkoxy, (C₂-C₄)-alkenyloxy, (C₂-C₄)— haloalkenyloxy, (C₁-C₄)-alkylthio, (C₁-C₄)-alkylsulfinyl, (C₁-C₄)-alkylsulfonyl, (C₁-C₄)-haloalkylsulfinyl, (C₁-C₄)-haloalkylsulfonyl, mono-(C₁-C₄)-alkylamino, di(C₁-C₄)-alkylamino, (C₁-C₄)-alkanoyl, (C₁-C₄)-haloalkanoyl, [(C₁-C₄)-alkoxy]carbonyl, [(C₁-C₄)-halo-alkoxy]carbonyl, aminocarbonyl, mono-[(C₁-C₄)-alkylamino]-carbonyl, di-[(C₁-C₄)-alkylamino]carbonyl and, in the case of cyclic radicals, also (C₁-C₄)-alkyl and (C₁-C₄)-haloalkyl, or
(C₁-C₆)-alkanoyl, (C₁-C₄)-haloalkanoyl, [(C₁-C₄)-alkoxy]carbonyl, [(C₁-C₄)— haloalkoxy]carbonyl, phenylcarbonyl, phenoxycarbonyl, [phenyl-(C₁-C₄)-alkyl]carbonyl, [phenyl-(C₁-C₄)-alkoxy]carbonyl, where the phenyl ring of each of the 4 last-mentioned radicals is unsubstituted or substituted, aminocarbonyl, mono-[(C₁-C₄)-alkylamino]carbonyl, di-[(C₁-C₄)-alkylamino]carbonyl, (C₁-C₄)-alkylsulfinyl, (C₁-C₄)-alkylsulfonyl, (C₁-C₄)-haloalkylsulfinyl or (C₁-C₄)-haloalkylsulfonyl, where each of the radicals R^{a}, R^{b} and R^{C}, and Y, in each case independently of one another and independently of the radical R, is as defined for R or a radical of the formula —OR*, where R*, independently of R, is as defined for R, and,
R² and R⁶, in each case independently of one another, are hydrogen, halogen, SCN, CN, (C₁-C₄)-alkyl, (C₂-C₄)-alkenyl, (C₂-C₄)-alkynyl or (C₃-C₆)-cycloalkyl,
where each of the 4 last-mentioned radicals is unsubstituted or substituted by one or more radicals selected from the group consisting of halogen, hydroxyl, amino, cyano, nitro, thiocyanato, (C₁-C₄)-alkoxy, (C₁-C₄)-haloalkoxy, (C₁-C₄)-alkylthio, (C₁-C₄)-alkylsulfinyl, (C₁-C₄)-alkylsulfonyl, (C₁-C₄)-haloalkylsulfinyl, (C₁-C₄)-haloalkylsulfonyl, mono-(C₁-C₄)-alkylamino, di-(C₁-C₄)-alkylamino, (C₁-C₄)-alkanoyl, (C₁-C₄)-haloalkanoyl, [(C₁-C₄)-alkoxy]carbonyl, [(C₁-C₄)-haloalkoxy]carbonyl, aminocarbonyl, mono-[(C₁-C₄)-alkylamino]carbonyl, di-[(C₁-C₄)-alkylamino]carbonyl and, in the case of cyclic radicals, also (C₁-C₄)-alkyl and (C₁-C₄)-haloalkyl,
R³ (a) in the case that n=0 is a radical selected from the group consisting of hydrogen, halogen, SCN and CN or a radical of the formula A¹ or B¹ or
(b) in the case that n=1 is hydrogen or a radical of the formula A¹, B¹ or C¹ and
R⁴ (a) in the case that m=0 is a radical selected from the group consisting of hydrogen, halogen, SCN and CN or a radical of the formula A² or B² or
(b) in the case that m=1 is hydrogen or a radical of the formula A², B² or C² and
R⁵ (a) in the case that o=0 is hydrogen or a radical of the formula A³ or B³ or
(b) in the case that o=1 is hydrogen or a radical of the formula A³, B³ or C³,
where each of the radicals A¹, A², A³, in each case independently of one another, is hydrogen, (C₁-C₁₈)-alkyl, (C₂-C₁₈)-alkenyl, (C₂-C₁₈)-alkynyl, (C₃-C₉)-cycloalkyl, (C₅-C₉)-cycloalkenyl, (C₃-C₉)-cycloalkyl-(C₁-C₁₂)-alkyl, phenyl, phenyl-(C₁-C₁₂)-alkyl, heterocyclyl or heterocyclyl-(C₁-C₁₂)-alkyl,
where each of the 10 last-mentioned radicals is unsubstituted or substituted by one or more radicals selected from the group consisting of halogen, hydroxyl, amino, cyano, nitro, thiocyanato, (C₁-C₄)-alkoxy, (C₁-C₄)— haloalkoxy, (C₂-C₄)-alkenyloxy, (C₂-C₄)-haloalkenyloxy, (C₁-C₄)-alkylthio, (C₁-C₄)-alkylsulfinyl, (C₁-C₄)-alkylsulfonyl, (C₁-C₄)-haloalkylsulfinyl, (C₁-C₄)-haloalkylsulfonyl, mono-(C₁-C₄)-alkylamino, di-(C₁-C₄)-alkylamino, (C₁-C₄)-alkanoyl, (C₁-C₄)-haloalkanoyl, [(C₁-C₄)-alkoxy]carbonyl, [(C₁-C₄)— haloalkoxy]carbonyl, aminocarbonyl, mono-[(C₁-C₄)-alkylamino]carbonyl, di-[(C₁-C₄)-alkylamino]carbonyl and, in the case of cyclic radicals, also (C₁-C₄)-alkyl and (C₁-C₄)-haloalkyl,
and, including substituents, has 1 to 30 C-atoms,
where each of the radicals B¹, B², B³, in each case independently of one another, is (C₁-C₆)-alkanoyl, (C₁-C₄)-haloalkanoyl, [(C₁-C₄)-alkoxy]carbonyl, [(C₁-C₄)— haloalkoxy]carbonyl, phenylcarbonyl, phenoxycarbonyl, [phenyl-(C₁-C₄)-alkyl]carbonyl, [phenyl-(C₁-C₄)-alkoxy]carbonyl, where the phenyl ring of each of the 4 last-mentioned radicals is optionally unsubstituted or substituted, aminocarbonyl, mono-[(C₁-C₄)-alkylamino]carbonyl, di-[(C₁-C₄)-alkylamino]-carbonyl, (C₁-C₄)-alkylsulfinyl, (C₁-C₄)-alkylsulfonyl, (C₁-C₄)-haloalkylsulfinyl or (C₁-C₄)-haloalkylsulfonyl, and
where each of the radicals C¹, C², C³, in each case independently of one another, is an aliphatic or aromatic heterocycle having a total of 1 to 3 heterocyclic ring atoms selected from the group consisting of N, O and S and a total of 5 or 6 ring atoms, which is unsubstituted or substituted by one or more radicals selected from the group consisting of halogen, hydroxyl, amino, (C₁-C₄)-alkyl, (C₁-C₄)alkoxy, (C₁-C₄)-haloalkyl, (C₁-C₄)-haloalkoxy, (C₁-C₄)-alkylthio and oxo,
Z, Z′, Z″, in each case independently of one another, are a group of the formula O, S(O)ₓ or NR′,
where x=0, 1 or 2 and R′ is hydrogen, (C₁-C₄)-alkyl, (C₂-C₄)-alkenyl, (C₂-C₄)-alkynyl, (C₃-C₆)-cycloalkyl, (C₁-C₄)-alkoxy, (C₂-C₄)-alkenyloxy, (C₂-C₄)-alkynyloxy or (C₃-C₆)-cycloalkyloxy,
where each of the 8 last-mentioned radicals is unsubstituted or substituted by one or more radicals selected from the group consisting of halogen, hydroxyl, amino, cyano, nitro, thiocyanato, (C₁-C₄)-alkoxy, (C₁-C₄)haloalkoxy, (C₁-C₄)-alkylthio, (C₁-C₄)-alkylsulfinyl, (C₁-C₄)-alkylsulfonyl, (C₁-C₄)-haloalkylsulfinyl, (C₁-C₄)-haloalkylsulfonyl, mono-(C₁-C₄)-alkylamino, di-(C₁-C₄)-alkylamino, (C₁-C₄)-alkanoyl, (C₁-C₄)-haloalkanoyl, [(C₁-C₄)-alkoxy]carbonyl, [(C₁-C₄)-haloalkoxy]carbonyl, aminocarbonyl, mono-[(C₁-C₄)-alkylamino]carbonyl, di-[(C₁-C₄)-alkylamino]carbonyl and, in the case of cyclic radicals, also (C₁-C₄)-alkyl and (C₁-C₄)-haloalkyl, or
(C₁-C₆)-alkanoyl, (C₁-C₄)-haloalkanoyl, (C₁-C₆)-alkanoyloxy, (C₁-C₄)-halo-alkanoyloxy, [(C₁-C₄)-alkoxy]carbonyl, [(C₁-C₄)-haloalkoxy]carbonyl, [(C₁-C₄)alkoxy]carbonyloxy, [(C₁-C₄)-haloalkoxy]carbonyloxy, phenylcarbonyl, phenoxycarbonyl, [phenyl-(C₁-C₄)-alkyl]carbonyl, [phenyl-(C₁-C₄)-alkoxy]-carbonyl, phenylcarbonyloxy, phenoxycarbonyloxy, [phenyl-(C₁-C₄)-alkyl]-carbonyloxy or [phenyl-(C₁-C₄)-alkoxy]carbonyloxy, where the phenyl ring of each of the 8 last-mentioned radicals is unsubstituted or substituted, or aminocarbonyl, mono-[(C₁-C₄)-alkylamino]carbonyl, di-[(C₁-C₄)-alkylamino]carbonyl, (C₁-C₄)-alkylsulfinyl, (C₁-C₄)-alkylsulfonyl, (C₁-C₄)-haloalkylsulfinyl or (C₁-C₄)-haloalkylsulfonyl,
m is an integer 0 or 1,
n is an integer 0 or 1 and
o is an integer 0 or 1,
where the sum m+n+o is an integer 1, 2 or 3 and, in the case of the alternatives (b) defined above, at least one of the radicals R³, R⁴ and R⁵ is selected from radicals from the group consisting of hydrogen and a radical of the formula B¹, B² and B³, respectively.

14. A compound of the formula (I) or a salt thereof as claimed in claim 13, wherein
R¹ is a radical of the formula —CO—OR, in which
R is hydrogen, (C₁-C₈)-alkyl, (C₂-C₈)-alkenyl, (C₂-C₈)-alkynyl, (C₃-C₆)-cycloalkyl, (C₃-C₆)-cycloalkyl-(C₁-C₄)-alkyl, phenyl, phenyl-(C₁-C₄)-alkyl, heterocyclyl or heterocyclyl-(C₁-C₄)-alkyl,
where each of the 9 last-mentioned radicals is unsubstituted or substituted by halogen, hydroxyl, (C₁-C₄)-alkoxy, (C₁-C₄)-haloalkoxy, (C₁-C₄)-alkylthio, (C₁-C₄)-alkylsulfinyl, (C₁-C₄)-alkylsulfonyl, mono-(C₁-C₄)-alkylamino, di-(C₁-C₄)-alkylamino, (C₁-C₄)-alkanoyl, (C₁-C₄)-haloalkanoyl, [(C₁-C₄)-alkoxy]carbonyl and, in the case of cyclic radicals, also (C₁-C₄)-alkyl and (C₁-C₄)-haloalkyl.

15. A compound of the formula (I) or a salt thereof as claimed in claim 13, wherein
R¹ is a radical of the formula —C(═NR^{a})-OR, in which
R is (C₁-C₈)-alkyl, (C₂-C₈)-alkenyl, (C₂-C₈)-alkynyl, (C₃-C₆)-cycloalkyl, (C₃-C₆)-cycloalkyl-(C₁-C₄)-alkyl, phenyl, phenyl-(C₁-C₄)-alkyl, heterocyclyl or heterocyclyl-(C₁-C₄)-alkyl,
where each of the 9 last-mentioned radicals is unsubstituted or substituted by one or more radicals selected from the group consisting of halogen, hydroxyl, (C₁-C₄)-alkoxy, (C₁-C₄)-haloalkoxy, (C₁-C₄)-alkylthio, (C₁-C₄)-alkylsulfinyl, (C₁-C₄)-alkylsulfonyl, mono-(C₁-C₄)-alkylamino, di-(C₁-C₄)-alkylamino, (C₁-C₄)-alkanoyl, (C₁-C₄)-haloalkanoyl, [(C₁-C₄)-alkoxy]carbonyl and, in the case of cyclic radicals, also (C₁-C₄)-alkyl and (C₁-C₄)-haloalkyl, or
(C₁-C₄)-alkanoyl, (C₁-C₄)-haloalkanoyl, [(C₁-C₄)-alkoxy]carbonyl, [(C₁-C₄)-haloalkoxy]carbonyl, phenylcarbonyl, phenoxycarbonyl, [phenyl-(C₁-C₄)-alkyl]-carbonyl, [phenyl-(C₁-C₄)-alkoxy]carbonyl, aminocarbonyl, mono-[(C₁-C₄)-alkylamino]carbonyl, di-[(C₁-C₄)-alkylamino]carbonyl, (C₁-C₄)-alkylsulfinyl,
(C₁-C₄)-alkylsulfonyl, (C₁-C₄)-haloalkylsulfinyl or (C₁-C₄)-haloalkylsulfonyl and
R^{a}is hydrogen, (C₁-C₄)-alkanoyl, (C₁-C₄)-haloalkanoyl, [(C₁-C₄)-alkoxy]carbonyl, [(C₁-C₄)-haloalkoxy]carbonyl, phenylcarbonyl, phenoxycarbonyl, [phenyl-(C₁-C₄)-alkyl]carbonyl, [phenyl-(C₁-C₄)-alkoxy]carbonyl, aminocarbonyl, mono-[(C₁-C₄)-alkylamino]carbonyl, di-[(C₁-C₄)-alkylamino]carbonyl, (C₁-C₄)-alkylsulfinyl, (C₁—C₄)-alkylsulfonyl, (C₁-C₄)-haloalkylsulfinyl or (C₁-C₄)-haloalkylsulfonyl.

16. A compound of the formula (I) or a salt thereof as claimed in claim 13, wherein
R¹ is a radical of the formula —CO—NR^{c}R, in which
R is hydrogen, (C₁-C₈)-alkyl, (C₂-C₈)-alkenyl, (C₂-C₈)-alkynyl, (C₃-C₆)-cycloalkyl, (C₃-C₆)-cycloalkyl-(C₁-C₄)-alkyl, phenyl, phenyl-(C₁-C₄)-alkyl, heterocyclyl or heterocyclyl-(C₁-C₄)-alkyl,
where each of the 9 last-mentioned radicals is unsubstituted or substituted by one or more radicals selected from the group consisting of halogen, hydroxyl, (C₁-C₄)-alkoxy, (C₁-C₄)-haloalkoxy, (C₁-C₄)-alkylthio, (C₁-C₄)-alkylsulfinyl, (C₁-C₄)-alkylsulfonyl, mono-(C₁-C₄)-alkylamino, di-(C₁-C₄)-alkylamino, (C₁-C₄)-alkanoyl, (C₁-C₄)-haloalkanoyl, [(C₁-C₄)-alkoxy]carbonyl and, in the case of cyclic radicals, also (C₁-C₄)-alkyl and (C₁-C₄)-haloalkyl, or
(C₁-C₄)-alkanoyl, (C₁-C₄)-haloalkanoyl, [(C₁-C₄)-alkoxy]carbonyl, [(C₁-C₄)- haloalkoxy]carbonyl, phenylcarbonyl, phenoxycarbonyl, [phenyl-(C₁-C₄)-alkyl]-carbonyl, [phenyl-(C₁-C₄)-alkoxy]carbonyl, aminocarbonyl, mono-[(C₁-C₄)-alkylamino]carbonyl, di-[(C₁-C₄)-alkylamino]carbonyl, (C₁-C₄)-alkylsulfinyl, (C₁-C₄)-alkylsulfonyl, (C₁-C₄)-haloalkylsulfinyl or (C₁-C₄)-haloalkylsulfonyl and
R^{c} is hydrogen, (C₁-C₄)-alkyl, which is unsubstituted or substituted by one or more radicals selected from the group consisting of halogen, hydroxyl, (C₁-C₄)-alkoxy and (C₁-C₄)-alkylthio, or
(C₁-C₄)-alkanoyl, (C₁-C₄)-haloalkanoyl, [(C₁-C₄)-alkoxy]carbonyl, [(C₁-C₄)haloalkoxy]carbonyl, (C₁-C₄)-alkylsulfinyl and (C₁-C₄)-alkylsulfonyl.

17. A crop protection composition, which comprises compounds of the formula (I) as defined in claim 1 and formulation auxiliaries.

18. A crop protection composition, which comprises compounds of the formula (I) as defined in claim 1 and one or more pesticides and optionally formulation auxiliaries.

19. A compound of the formula (I) or a salt thereof as claimed in claim 13, wherein R⁵ has 1 to 20 C atoms.

20. A compound of the formula (I) or a salt thereof as claimed in claim 13, wherein R⁵ has 1 to 16 C atoms.
